(19) United States
(12) Patent Application Publication
(10) Pub. No.: US 2025/0056538 A1
(43) Pub. Date: Feb. 13, 2025

(54) METHOD AND APPARATUS FOR MULTI-USER SPATIAL MULTIPLEXING SCHEDULING IN WIRELESS COMMUNICATION SYSTEM

(71) Applicant: SAMSUNG ELECTRONICS CO., LTD., Suwon-si (KR)

(72) Inventors: Youngrok JANG, Suwon-si (KR); Seongmok LIM, Suwon-si (KR); Hyoungju JI, Suwon-si (KR); Kyungjun CHOI, Suwon-si (KR)

(21) Appl. No.: 18/790,971

(22) Filed: Jul. 31, 2024

(30) Foreign Application Priority Data
Jul. 31, 2023 (KR) 10-2023-0099820
Nov. 30, 2023 (KR) 10-2023-0171674
Feb. 21, 2024 (KR) 10-2024-0024914

(51) Int. Cl. H04W 72/1273; H04B 7/0413; H04W 72/232

(52) U.S. Cl. CPC H04W 72/1273; H04W 72/232; H04B 7/0413

(57) ABSTRACT

The disclosure relates to a 5G or 6G communication system for supporting higher data transmission rates. The disclosure relates to the operation of a terminal and a base station in a wireless communication system. Specifically, the disclosure relates to a method for transmission and reception using spatial multiplexing in a wireless communication system and an apparatus capable of performing the same. The disclosure provides an apparatus and a method that can effectively provide services in a mobile communication system.

### CROSS-REFERENCE TO RELATED APPLICATIONS

This application is based on and claims priority under 35 U.S.C. § 119 to Korean Patent Application No. 10-2023-0099820, filed on Jul. 31, 2023, Korean Patent Application No. 10-2023-0171674, filed on Nov. 30, 2023, and Korean Patent Application No. 10-2024-0024914, filed on Feb. 21, 2024, in the Korean Intellectual Property Office, the disclosures of which are herein incorporated by reference in their entirety.

### BACKGROUND

### 1. Field

The disclosure relates to the operation of a terminal and a base station in a wireless communication system. Specifically, the disclosure relates to a method for multi-user spatial multiplexing scheduling in a wireless communication system and an apparatus capable of performing the same.

### 2. Description of Related Art

5^{th} generation (5G) mobile communication technologies define broad frequency bands to provide higher transmission rates and new services, and can be implemented in “Sub 6 GHz” bands such as 3.5 GHz, and also in “above 6 GHz” bands, which may be referred to as mm Wave bands including 28 GHz and 39 GHz. In addition, the implementation of 6^{th} generation 6G mobile communication technologies (e.g., beyond 5G systems) in terahertz bands (e.g., 95 GHz to 3 THz bands) has been proposed in order to achieve transmission rates fifty times faster than 5G mobile communication technologies and ultra-low latencies one-tenth of 5G mobile communication technologies.

Since the beginning of the development of 5G mobile communication technologies, in order to support various services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings (SCSs)) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio (NR)-Unlicensed (U) aimed at system operations conforming to various regulation-related requirements in unlicensed bands, NR UE power saving, non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also full-duplex technologies for increasing frequency efficiency of 6G mobile communication technologies and improving system networks, AI-based communication technologies for implementing system optimization by utilizing satellites and AI from the design stage and internalizing end-to-end AI support functions, and next-generation distributed computing technologies for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Disclosed embodiments are to provide an apparatus and a method that can effectively provide services through spatial multiplexing in a mobile communication system.

The present disclosure has been made to address the above-mentioned problems and disadvantages, and to provide at least the advantages described below.

In accordance with an aspect of the present disclosure, a method performed by a terminal in a communication system is provided. The method includes receiving, from a base station, configuration information indicating information on multi-user multi-input and multi-output (MU-MIMO) that is included in downlink control information (DCI) via higher layer signaling; receiving, from the base station, the DCI that schedules downlink data, wherein the DCI includes the information on the MU-MIMO; and receiving, from the base station, the downlink data based on the information on the MU-MIMO, wherein a value 0 of the information on the MU-MIMO indicates that no other terminal that is scheduled with the terminal exists or another terminal that is scheduled with the terminal using a different demodulation reference signal (DMRS) sequence exists.

In accordance with another aspect of the present disclosure, a method performed by a base station in a communication system is provided. The method includes transmitting, to a terminal, configuration information indicating information on MU-MIMO that is included in downlink control information (DCI) via higher layer signaling; transmitting, to the terminal, the DCI that scheduled downlink data, wherein the DCI includes the information on the MU-MIMO; and transmitting, to the terminal, the downlink data, wherein a value 0 of the information on the MU-MIMO indicates that no other terminal that is scheduled with the terminal exists or another terminal that is scheduled with the terminal using a different DMRS sequence exists.

In accordance with another aspect of the present disclosure, a terminal in a communication system is provided. The terminal includes a transceiver and a controller coupled with the transceiver and configured to receive, from a base station, configuration information indicating information on MU-MIMO that is included in downlink control information (DCI) via higher layer signaling, receive, from the base station, the DCI that schedules downlink data, wherein the DCI includes the information on the MU-MIMO, and receive, from the base station, the downlink data based on the information on the MU-MIMO, wherein a value 0 of the information on the MU-MIMO indicates that no other terminal that is scheduled with the terminal exists or another terminal that is scheduled with the terminal using a different DMRS sequence exists.

In accordance with another aspect of the present disclosure, a base station in a communication system is provided. The base station configured to transmit, to a terminal, configuration information indicating information on MU-MIMO that is included in downlink control information (DCI) via higher layer signaling, transmit, to the terminal, the DCI that schedules downlink data, wherein the DCI includes the information on the MU-MIMO, and transmit, to the terminal, the downlink data, wherein a value 0 of the information on the MU-MIMO indicates that no other terminal that is scheduled with the terminal exists or another terminal that is scheduled with the terminal using a different DMRS sequence exists.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of bandwidth part configuration in a wireless communication system according to an embodiment of the disclosure;

FIG. 4 illustrates an example of control resource set configuration of a downlink control channel in a wireless communication system according to an embodiment of the disclosure;

FIG. 5 illustrates a structure of a downlink control channel in a wireless communication system according to an embodiment of the disclosure;

FIG. 6 illustrates an example of frequency domain resource allocation with regard to a PDSCH or PUSCH in a wireless communication system according to an embodiment of the disclosure;

FIG. 7 illustrates a VRB-PRB interleaving scheme of a PDSCH during FDRA type-1 resource allocation according to an embodiment of the disclosure;

FIG. 8 illustrates an example of time domain resource allocation with regard to a PDSCH in a wireless communication system according to an embodiment of the disclosure;

FIG. 9 illustrates a process for beam configuration and activation with regard to a PDSCH;

FIG. 10 illustrates a configuration of antenna ports and an example of resource allocation for cooperative communication in a wireless communication system according to an embodiment of the disclosure;

FIG. 11 illustrates an example for a configuration of downlink control information (DCI) for cooperative communication in a wireless communication system according to an embodiment of the disclosure;

FIG. 12 illustrates an enhanced PDSCH TCI state activation/deactivation MAC-CE structure;

FIG. 13 illustrates an example of MC-DCI including a plurality of FDRA fields according to an embodiment of the disclosure;

FIG. 14 illustrates an example of MC-DCI including at least one of a cell set indicator field, a scheduling cell indicator field, and a plurality of FDRA fields, according to an embodiment of the disclosure;

FIG. 15 illustrates an example of a field indicating frequency domain resource assignment information based on a subcarrier spacing of a cell according to an embodiment of the disclosure;

FIG. 16 illustrates an operation of a UE according to an embodiment of the disclosure;

FIG. 17 illustrates an operation of a base station according to an embodiment of the disclosure;

FIG. 18 illustrates a structure of a UE in a wireless communication system according to an embodiment of the disclosure; and

FIG. 19 illustrates a structure of a base station in a wireless communication system according to an embodiment of the disclosure.

### DETAILED DESCRIPTION

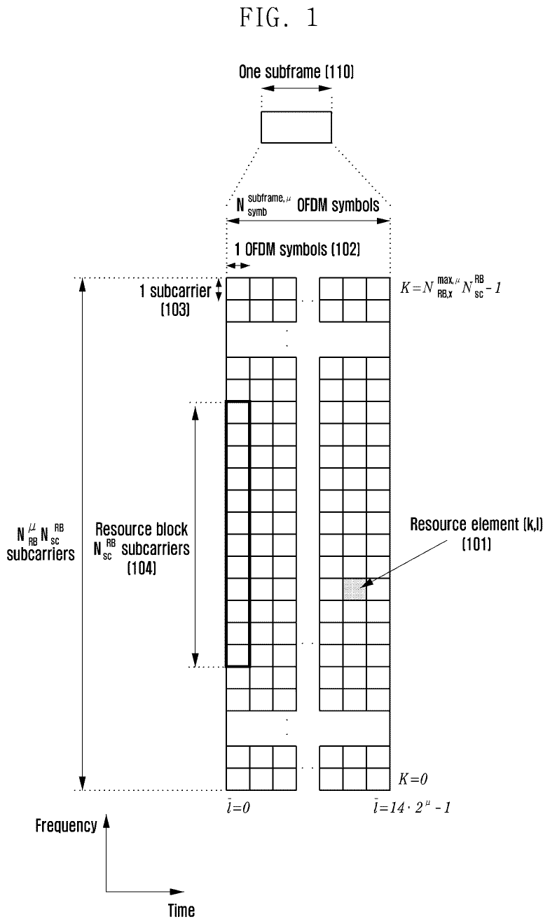

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. Also, the disclosure may be applied to both frequency division duplex (FDD) and time division duplex (TDD) systems. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate Array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

Hereinafter, a frame structure of a 5G system will be described in more detail with reference to the accompanying drawings.

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, NR (for example, 12) consecutive REs may constitute one resource block (RB) 104. In the time domain, one subframe 110 may include multiple OFDM symbols 102. For example, the length of one subframe may be 1 ms.

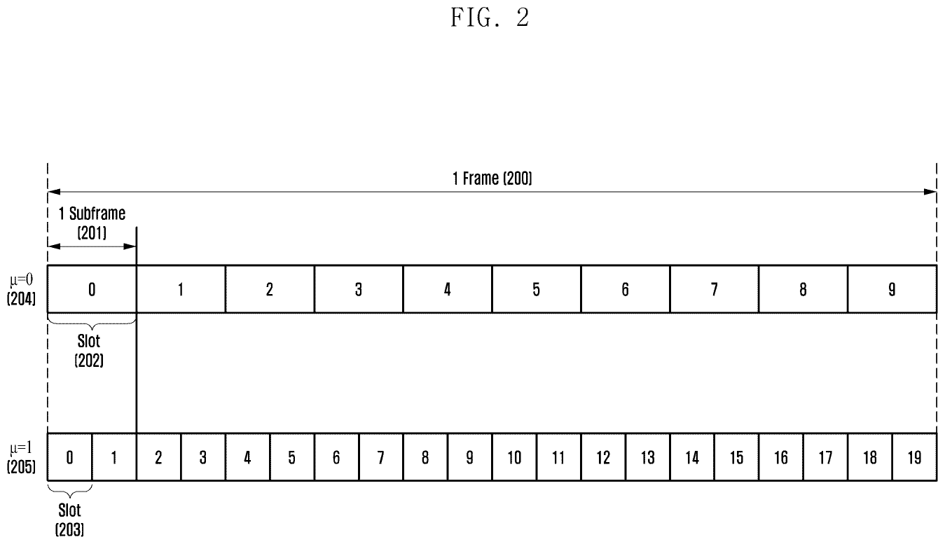

FIG. 2 illustrates a structure of a frame, a subframe, and a slot in a 5G system.

An example of a structure of a frame 200, a subframe 201, and a slot 202 is illustrated in FIG. 2. One frame 200 may be defined as 10 ms. One subframe 201 may be defined as 1 millisecond (ms), and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{sunframe,μ} slot may differ depending on the subcarrier spacing configuration value u, and the number of slots per one frame Nₛₗₒₜ^{frame,μ} may differ accordingly. Nₛₗₒₜ^{sunframe,μ} and Nₛₗₒₜ^{frame,μ} slot may be defined according to each subcarrier spacing configuration u as in Table 1 below.

TABLE 1

| μ | N_{symb}^{slot} | Nₛₗₒₜ^{frame, μ} | Nₛₗₒₜ^{sunframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, bandwidth part (BWP) configuration in a 5G communication system will be described in detail with reference to the accompanying drawings.

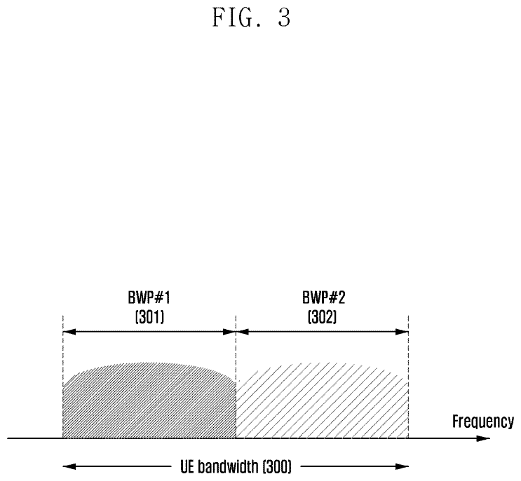

FIG. 3 illustrates an example of bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

```
TABLE 2
BWP ::= SEQUENCE {
  bwp-Id  BWP-Id,
  (bandwidth part identifier)
  locationAndBandwidth INTEGER (1..65536),
  (bandwidth part location)
  subcarrierSpacing ENUMERATED {n0, n1, n2, n3, n4, n5},
  (subcarrier spacing)
  cyclicPrefix ENUMERATED { extended }
  (cyclic prefix)
}
```

Of course, the above example is not limiting, and in addition to the configuration information given above, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to some embodiments, before a radio resource control (RRC) connection, an initial bandwidth part (BWP) for initial access may be configured for the UE by the base station through a master information block (MIB). More specifically, the UE may receive configuration information regarding a control resource set (CORESET) and a search space, which may be used to transmit a PDCCH for receiving system information (which may correspond to remaining system information (RMSI) or system information block 1 (SIB1)) necessary for initial access, through the MIB on a PBCH in the initial access step. Each of the control resource set and the search space configured through the MIB may be considered identity (ID) 0. The base station may notify the UE of configuration information, such as frequency allocation information, time allocation information, and numerology, regarding control region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0. The initial bandwidth part may be used not only for the purpose of receiving the SIB, but also for other system information (OSI), paging, random access, or the like.

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

TABLE 4
- Identifier for DCI formats - [1] bit
- Frequency domain resource assignment - [┌log₂(N_{RB}^{UL,BWP}(N_{RB}^{UL,BWP}
+ 1)/2) ┐] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH - [2]
bits
- Uplink/ supplementary uplink (UL/SUL) indicator - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

```
TABLE 5
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    * For resource allocation type 0, ┌N_{RB}^{UR,BWP}/P┐ bits
    * For resource allocation type 1, ┌log₂(N_{RB}^{UL,BWP}
    (N_{RB}^{UL,BWP} + 1)/2)┐ bits
  Time domain resource assignment -1, 2, 3, or 4 bits
  Virtual resource block (VRB)-to-physical resource block (PRB)
mapping - 0 or 1 bit, only for resource allocation type 1.
    * 0 bit if only resource allocation type 0 is configured;
    * 1 bit otherwise.
  Frequency hopping flag - 0 or 1 bit, only for resource allocation
  type 1.
    * 0 bit if only resource allocation type 0 is configured;
    * 1 bit otherwise.
  Modulation and coding scheme - 5 bits
  New data indicator - 1 bit
  Redundancy version - 2 bits
  HARQ process number - 4 bits
  1st downlink assignment index- 1 or 2 bits
    * 1 bit for semi-static HARQ-ACK codebook;
    * 2 bits for dynamic HARQ-ACK codebook with single
    HARQ-ACK codebook.
  2nd downlink assignment index - 0 or 2 bits
    * 2 bits for dynamic HARQ-ACK codebook with two
    HARQ-ACK sub-codebooks;
    * 0 bit otherwise.
  TPC command for scheduled PUSCH - 2 bits
  $SRS resource indicator - ⌈ {log}_{2} ( {Σ}_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    $* ⌈ {log}_{2} ( {Σ}_{k = 1}^{{L}_{max}} ( \begin{matrix}{N}_{SRS} \\ k\end{matrix} ) ) ⌉ bits for non - codebook based$
    PUSCH transmission;
    ┌log₂(N_{SRS}))┐ bits for codebook based PUSCH transmission.
  Precoding information and number of layers - up to 6 bits
  Antenna ports - up to 5 bits
  SRS request - 2 bits
  Channel state information (CSI) request - 0, 1, 2, 3, 4, 5, or 6 bits
  Code block group (CBG) transmission information -
  0, 2, 4, 6, or 8 bits
  Phase tracking reference signal (PTRS)-demodulation reference
signal (DDMRS) association - 0 or 2 bits.
  beta_offset indicator - 0 or 2 bits
  DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

TABLE 6
- Identifier for DCI formats - [1] bit
- Frequency domain resource assignment - [┌log₂(N_{RB}^{DL,BWP}(N_{RB}^{DL,BWP}
+ 1)/2) ┐] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Pysical uplink control channel (PUCCH) resource indicator - 3 bits
- PDSCH-to-HARQ feedback timing indicator - [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |
| | * For resource allocation type 0, ┌N_{RB}^{DL,BWP}/P┐ bits |
| | * For resource allocation type 1, ┌log₂(N_{RB}^{DL,BWP}(N_{RB}^{DL,BWP} |
| | + 1)/2) ┐ bits |
| - | Time domain resource assignment -1, 2, 3, or 4 bits |
| - | VRB-to-PRB mapping - 0 or 1 bit, only for resource allocation |
| | type 1. |
| | * 0 bit if only resource allocation type 0 is configured; |
| | * 1 bit otherwise. |
| - | Physical resource block (PRB) bundling size indicator - 0 or 1 bit |
| - | Rate matching indicator - 0, 1, or 2 bits |
| - | Zero power (ZP) channel state information (CSI)-reference signal |

(RS) trigger - 0, 1, or 2 bits
For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

Hereinafter, a downlink control channel in a 5G communication system will be described in more detail with reference to the accompanying drawings.

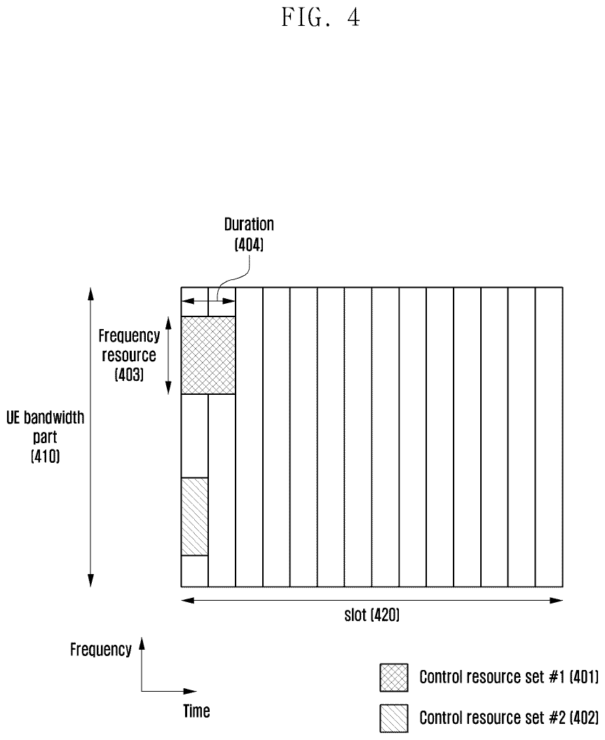

FIG. 4 illustrates an example of a control resource set (CORESET) used to transmit a downlink control channel in a 5G wireless communication system. FIG. 4 illustrates an example in which a UE bandwidth part 4 10 is configured along the frequency axis, and two CORESETs (CORESET #1 420 and CORESET #2 401) are configured within one slot 402 along the time axis. The control resource sets 401 and 402 may be configured in a specific frequency resource 410 within the entire UE bandwidth part 403 along the frequency axis. One or multiple OFDM symbols may be configured along the time axis, and this may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the control resource set may include the following pieces of information: given in Table 8 below.

TABLE 8

```
  ConControlResourceSet ::= SEQUENCE {
  -- Corresponds to L1 parameter ‘CORESET-ID’
  controlResourceSetId ControlResourceSetId,
    (control resource set identity)
  frequencyDomainResources BIT STRING (SIZE (45)),
    (frequency domain resource assignment information)
  duration INTEGER (1..maxCoReSetDuration),
    (time domain resource assignment information)
  cce-REG-MappingType CHOICE {
    (CCE-to-REG mapping type)
    interleaved SEQUENCE {
      reg-BundleSize ENUMERATED {n2, n3, n6},
    (REG bundle size)
      precoderGranularity ENUMERATED {sameAsREG-
bundle, allContiguousRBs},
      interleaverSize ENUMERATED {n2, n3, n6}
      (interleaver size)
      shiftIndex
  INTEGER(0..maxNrofPhysicalResourceBlocks-1)
  OPTIONAL
      (interleaver shift)
    },
    nonInterleaved NULL
    },
    tci-StatesPDCCH SEQUENCE(SIZE (1..maxNrof TCI-
StatesPDCCH)) OF TCI-StateId OPTIONAL,
    (QCL configuration information)
    tci-PresentInDCI ENUMERATED {enabled}
                                    OPTIONAL, - Need S
    }
```

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding CORESET.

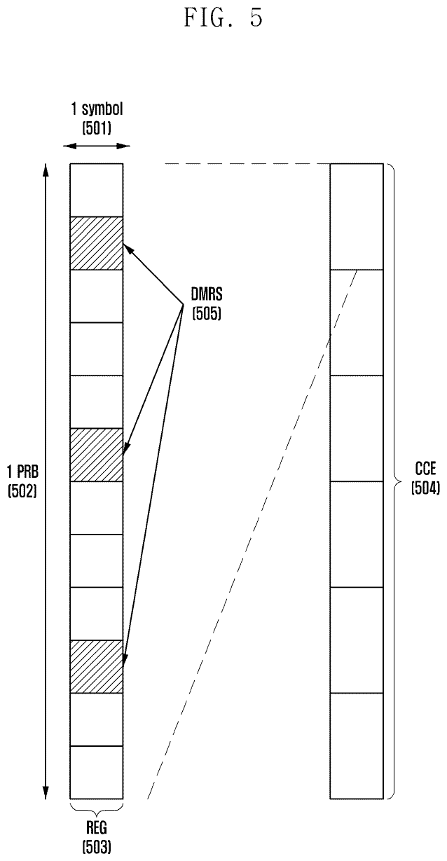

FIG. 5 illustrates an example of a basic unit of time and frequency resources constituting a downlink control channel available in a 5G system. According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation is a control channel element 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5A, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

Parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the control resource set may include the following pieces of information given in Table 8 below.

TABLE 9

```
SearchSpace ::= SEQUENCE {
    -- Identity of the search space. SearchSpaceId = 0 identifies the SearchSpace configured via
PBCH (MIB) or ServingCellConfigCommon.
    searchSpaceId SearchSpaceId,
  (search space identity)
    controlResourceSetId ControlResourceSetId,
  (control resource set identity)
    monitoringSlotPeriodicity AndOffset CHOICE {
  (monitoring slot level periodicity)
        sl1 NULL, NULL,
        sl2 INTEGER (0..1), INTEGER (0..1)
        sl4 INTEGER (0..3), INTEGER (0..3)
        sl5 INTEGER (0..4), INTEGER (0..4)
        sl8 INTEGER (0..7), INTEGER (0..7)
        sl10 INTEGER (0..9), INTEGER (0..9)
        sl16 INTEGER (0..15), INTEGER (0..15)
        sl20 INTEGER (0..19) INTEGER (0..19)
    }
                      OPTIONAL,
  duration (monitoring duration) INTEGER (2..2559)
    monitoringSymbolsWithinSlot BIT STRING (SIZE (14))
                              OPTIONAL,
  (monitoring symbols within slot)
    nrofCandidates SEQUENCE {
  (number of PDCCH candidates for each aggregation level)
      aggregationLevel1 ENUMERATED {n0, n1, n2, n3, n4, n5, n6,
n8},
      aggregationLevel2 ENUMERATED {n0, n1, n2, n3, n4, n5, n6,
n8},
      aggregationLevel4 ENUMERATED {n0, n1, n2, n3, n4, n5, n6,
n8},
      aggregationLevel8 ENUMERATED {n0, n1, n2, n3, n4, n5, n6,
n8},
      aggregationLevel16 ENUMERATED {n0, n1, n2, n3, n4, n5, n6,
n8}
    },
    searchSpaceType CHOICE {
    (search space type)
        -- Configures this search space as common search space (CSS) and DCI formats to
monitor.
      common SEQUENCE {
    (common search space)
    }
      ue-Specific SEQUENCE {
    (UE-specific search space)
          -- Indicates whether the UE monitors in this USS for DCI formats 0-0 and 1-0 or for
formats 0-1 and 1-1.
          formats ENUMERATED {formats0-0-And-1-0,
formats0-1-And-1-1},
    ...
}
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which

system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI): used to indicate a power control command regarding a PUCCH

Transmit power control for SRS RNTI (TPC-SRS-RNTI): used to indicate a power control command regarding an SRS

The DCI formats enumerated above may follow the definitions given in Table 10 below, for example.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In a 5G system, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad [ Equation 1 ]$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=N_{RNTI}≠0, Aₚ=39827 for pmod3=0, Aₚ=39829 for pmod3=1, Aₚ=39839 for pmod3=2, D=65537
n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

Next, frequency domain resource assignment (FDRA) for a physical downlink shared channel (PDSCH) and a physical uplink shared channel (PUSCH) in NR will be described.

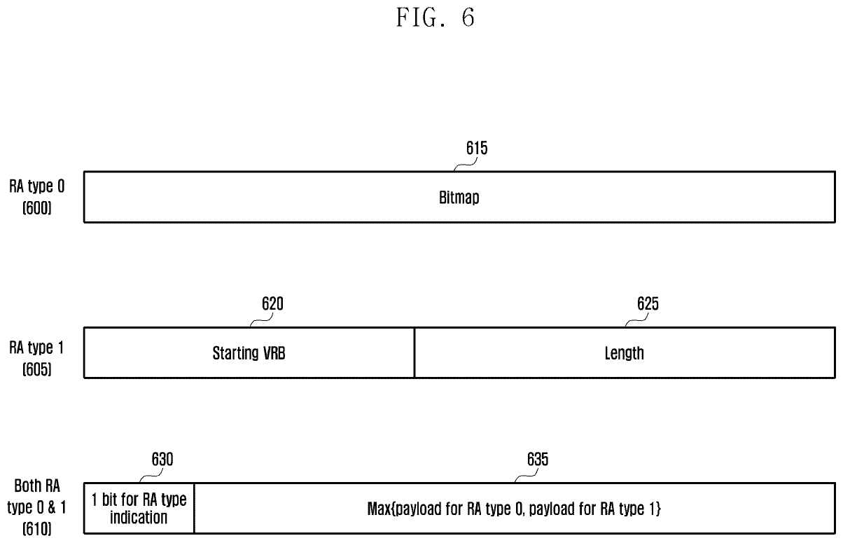

FIG. 6 illustrates an example of frequency domain resource assignment of a PDSCH or PUSCH in a wireless communication system according to an embodiment of the disclosure.

FIG. 6 illustrates three frequency domain resource assignment methods of FDRA type 0 600, FDRA type 1 605, and dynamic switch 610, which are configurable through a higher layer in an NR wireless communication system.

Referring to FIG. 6, in case that a UE is configured to use only FDRA type 0 through higher layer signaling (indicated by reference numeral 600), a part of downlink control information (DCI) for scheduling a PDSCH or PUSCH for the UE includes a bitmap configured by N_{RBG} bits. The conditions for this will be described later. In this case, N_{RBG} indicates the number of resource block groups (RBGs) determined, as shown in Table 11 below, according to the size of a BWP allocated by a BWP indicator and the higher layer parameter “rbg-Size,” and data is transmitted in the RBG represented as “1” using a bitmap.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The size of the frequency resource of a bandwidth part may be defined as the number of RBs that the bandwidth part includes. More specifically, if the UE is indicated to allocate FDRA type-0 resources, the length of the FDRA field of the DCI received by the UE is equal to the number of RBGs in the bandwidth part (N_{RBG}), in which N_{RBG}=┌N_{BWP}^{size}+(N_{BWP}^{size} mod P))/P┐. Here, the first RBG in the bandwidth part includes RBG₀^{size}=P−N_{BWP}^{size} mod P RBs, and if (N_{BWP}^{start}+N_{BWP}^{size})mod P>0, the last RBG in the bandwidth part includes RBGₗₐₛₜ^{size}=(N_{BWP}^{start}+N_{BWP}^{size})mod P RBs and otherwise, the last RBG includes RBGₗₐₛₜ^{size}=P RBs. The remaining RBGs in the bandwidth part include P RBs. Here, P is the number of nominal RBGs determined according to [Table 11] above.

If the UE is configured to use only FDRA type 1 via higher layer signaling (indicated by reference numeral 605), the DCI assigning PDSCH or PUSCH to the UE includes frequency domain resource assignment information (FDRA) configured by ┌log₂(N_{RB}^{BWP}(N_{RB}^{BWP}+1)/2)┐ bits. Here, N_{RB}^{BWP} is the number of RBs included in the bandwidth part. This allows the base station to configure a starting VRB 620 and a frequency-domain resource length 625 which is successively allocated therefrom.

If the UE is not configured with the higher layer signaling vrb-ToPRB-Interleaver, the UE may associate the resources allocated to the VRBs to the PRBs without interleaving. If the UE is configured with the higher layer signaling vrb-ToPRB-Interleaver, the higher layer signaling has a value of 2 or 4, which may be multiple units of RBs performing interleaving. That is, a bundle of RBs of 2 or 4 units may be used for interleaving.

If the UE is configured with an i-th BWP that starts at a location N_{BWP,i}^{start} and has a length of N_{BWP,i}^{size} RBs, and is configured with Lᵢ of vrb-ToPRB-Interleaver, the UE may split the i-th BWP into N_{bundle}=┌(N_{BWP,i}^{size}+(N_{BWP,i}^{start} mod Lᵢ))/Lᵢ┐ RB bundles, each of which may be configured by Lᵢ RBs.
In the i-th BWP, the first RB bundle may be configured by Lᵢ−(N_{BWP,i}^{size} mod Lᵢ) RBs.
In the i-th BWP, the last RB bundle may be configured by (N_{BWP,i}^{start}+N_{BWP,i}^{size}) mod Lᵢ RBs if a value of (N_{BWP,i}^{start}+N_{BWP,i}^{size})mod Lᵢ is greater than zero, otherwise the last RB bundle may be configured by Lᵢ RBs.
In the i-th BWP, the remaining RB bundle may be configured by Lᵢ RBs.

Here, the VRBs may be connected to the PRBs according to the following method.
The last VRB bundle may be connected to the last PRB bundle.
The j-th (j=0, 1, . . . , N_{bundle}−2) VRB bundle may be connected to the f(j) PRB bundle, and f(j) may be expressed as Equation 2 below.

$$f ( j ) = rC + c \qquad [ Equation 2 ]$$

j=cR+r
r=0, 1, . . . , R−1
c=0, 1, . . . , C−1
R=2
C=└N_{bundle}/R┘

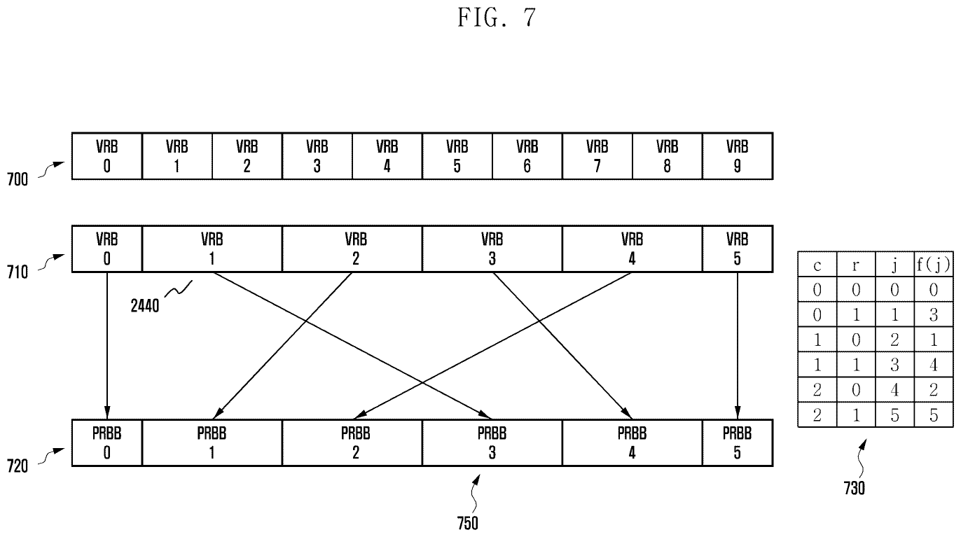

FIG. 7 illustrates a VRB-PRB interleaving scheme of a PDSCH during FDRA type-1 resource allocation according to an embodiment of the disclosure. In FIG. 7, the case 710 in which the first and last VRB bundles are configured by 1 VRB in a BWP configured by 10 RBs (indicated by reference numeral 700) are shown. Therefore, N_{bundle}, which is the number of VRB bundles, may be 6, and may be calculated as C=[N_{bundle}/R]=3 by Equation 2. Therefore, since the j-th VRB bundle may be connected to the f(j)th PRB bundle according to the above Equation 2, the connection from the VRB bundle to the PRB bundle via the result (indicated by reference numeral 730) calculated by the above Equation 2 may be performed as shown in reference numeral 720. For example, VRB bundle 1 740 may be connected to PRB bundle 3 750.

In case that a UE is configured to use both FDRA type-0 resource allocation and FDRA type-1 resource allocation through layer signaling (indicated by reference numeral 610), some DCI for allocating the PDSCH/PUSCH to the corresponding UE may include frequency domain resource assignment information including bits of a larger value 635 among the payload 615 for configuring FDRA type-0 resource allocation and payloads 620 and 625 for configuring FDRA type-1 resource allocation. The conditions for this will be described again later. In this case, one bit may be added to the foremost part (MSB) of the frequency domain resource assignment information in the DCI, and the corresponding bit having a value of ‘0’ indicates that FDRA type-0 resource allocation is to be used, and a value of ‘1’ indicates that FDRA type-1 resource allocation is to be used.

In case that the UE is configured with the FDRA type-2 resource allocation method through higher layer signaling, the UE may receive instructions from the base station with respect to the FDRA type-2 resource allocation method according to the following method.

The UE may receive M interlace index sets of RB allocation information from the base station.

The interlace index m∈{0, 1, . . . , M−1} may be configured by the common RB {m, M+m, 2M+m, 3M+m, . . . }, in which M is defined as in Table 12.

TABLE 12

| μ | M |
|---|---|
| 0 | 10 |
| 1 | 5 |

The relationship of RB n_{IRB,m}^{μ}∈{0, 1, . . . } in interlace m and bandwidth part i and the common RB n_{CRB}^{μ} may be defined as follows.
n_{CRB}^{μ}=Mn_{IRB,m}^{μ}+N_{BWP,i}^{start,μ}+((m−N_{BWP,i}^{start,μ})mod M)
in where N_{BWP,i}^{start,μ} is the common resource block where bandwidth part starts relative to common resource block 0. u is subcarrier spacing index

When the subcarrier spacing is 15 kHz (u=0), the RB allocation information for the interlace set with (m0+1) indices may be notified of from the base station to the UE. Further, the resource allocation field may be configured by a resource indication value (RIV). When the resource indicator value is 0≤RIV<M (M+1)/2, l=0, 1, . . . , L−1, the RIV may be configured by a starting interlace m0 and a number of consecutive interlaces L (L≥1), and the value of RIV is as follows:

if (L − 1) ≤ └M/2┘ then
RIV= M(L − 1) + m_0
else
RIV = M(M − L + 1) + (M − 1 − m₀)

When the resource indicator value is RIV≥M (M+1)/2, the resource indicator value is configured by the values of the starting interlace index m0 and l, and may be configured as shown in Table 13.

TABLE 13

| RIV − M(M + 1)/2 | m₀ | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

When the subcarrier spacing is 30 kHz (u=1), the RB allocation information may be notified of from the base station to the UE in the form of a bitmap indicating the interlacing assigned to the UE. The size of the bitmap is M, and each 1 bit of the bitmap corresponds to an interlacing. The interlace bitmap order may be such that interlace indices 0 to M−1 are mapped from MSB to LSB of the bitmap.

In addition, for 15 kHz and 30 kHz, the least significant bit

$$( LSB ) Y = ⌈ log 2 \frac{{N}_{RB - set}^{BWP} ( {N}_{RB - set}^{BWP} + 1 )}{2} ⌉$$

of the FDRA field may represent a set of consecutive RBs of PUSCH scheduled by DCI format 0_1. Y bit may be configured by a resource indication value (RIV_{RBset}). In 0≤RIV_{RBset}<N_{RB-set}^{BWP}(N_{RB-set}^{BWP}+1)/2, l=0, 1, . . . . L_{RBset}−1, the RIV_{RBset} value may be determined by the starting RB set (RBset_{START}) and the number of consecutive RB sets (L_{RBset}(L_{RBset}≥1)). The RIV_{RBset} value may be defined as follows.

if (L_{RBset} − 1) ≤ └N_{RB-set}^{BWP}/2┘ then
RIV_{RBSet} = N_{RB-set}^{BWP}(L_{RBset} − 1) + RBset_{START}
else
RIV_{RBset} = N_{RB-set}^{BWP}(N_{RB-set}^{BWP} − L_{RBset} + 1) +
(N_{RB-set}^{BWP} − 1 − RBset_{START})

N_{RB-set}^{BWP} refers to the number of RB sets included in the bandwidth part, which may be determined by the number of guard gaps (or bands) within a carrier configured (or preconfigured) via higher layer signaling.

Hereinafter, a time domain resource allocation method regarding a data channel in a 5G system will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 14 or Table 15 below may be transmitted from the base station to the UE.

TABLE 14

```
  PDSCH-TimeDomainResourceAllocationList := SEQUENCE (SIZE(1..maxNrofDL-
Allocations)) OF
  PDSCH-TimeDomainResourceAllocation
  PDSCH-TimeDomainResourceAllocation ::= SEQUENCE {
      k0 INTEGER(0..32)
  OPTIONAL, -- Need S
    (PDCCH-to-PDSCH timing, slot unit)
    mappingType ENUMERATED {typeA, typeB},
    (PDSCH mapping type)
    startSymbolAndLength INTEGER (0..127)
    (start symbol and length of PDSCH)
}
```

TABLE 15

```
PUSCH-TimeDomainResourceAllocationList ::= SEQUENCE (SIZE(1..maxNrofUL-Allocations)) OF
PUSCH-TimeDomainResourceAllocation
PUSCH-TimeDomainResourceAllocation ::= SEQUENCE {
  k2 INTEGER(0..32) OPTIONAL, -- Need S
    (PDCCH-to-PUSCH timing, slot unit)
    mappingType ENUMERATED {typeA, typeB},
    (PUSCH mapping type)
    startSymbolAndLength INTEGER (0..127)
    (start symbol and length of PUSCH)
}
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

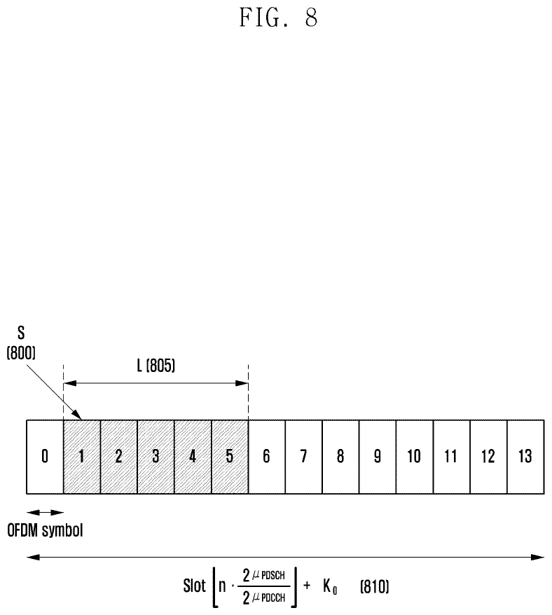

FIG. 8 illustrates an example of time domain resource allocation with regard to a PDSCH in a wireless communication system according to an embodiment of the disclosure.

Referring to FIG. 8, the base station may indicate the time domain location of a PDSCH resource according to the subcarrier spacing (SCS) (μ_{PDSCH}, μ_{PDCCH}) of a data channel and a control channel configured by using an upper layer, the scheduling offset (K0) value, and the OFDM symbol start location 800 and length 805 within one slot dynamically indicated through DCI.

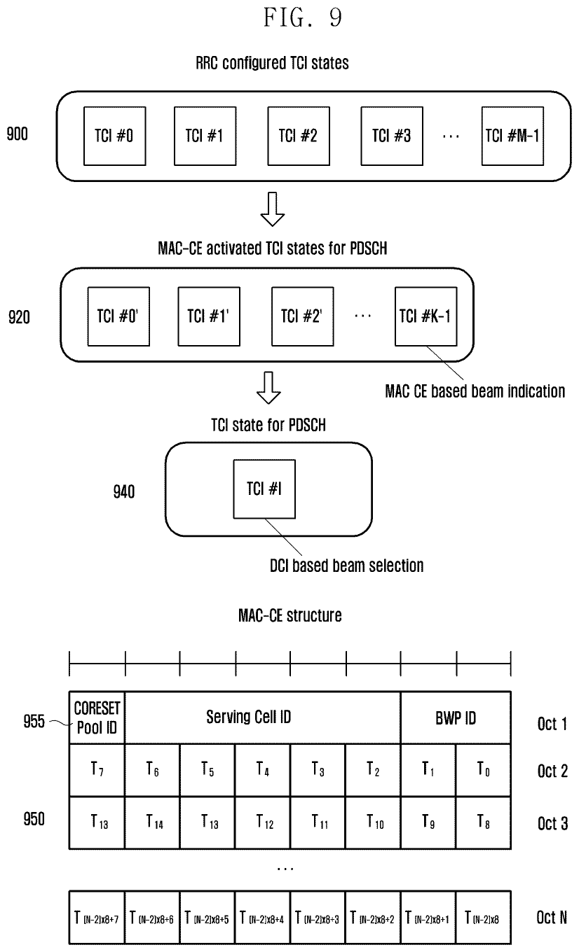

Next, a method for beam configuration with regard to a PDSCH will be described. FIG. 9 illustrates a process for beam configuration and activation with regard to a PDSCH; A list of TCI states regarding a PDSCH may be indicated through an upper layer list such as RRC (900). The list of TCI states may be indicated by tci-StatesToAddModList and/or tci-StatesToReleaseList inside a BWP-specific PDSCH-Config IE, for example. Next, a part of the list of TCI states may be activated through a MAC-CE (940). The maximum number of activated TCI states may be determined by the capability reported by the UE. “950” illustrates an example of an MAC-CE structure for PDSCH TCI state activation/deactivation.

The meaning of respective fields inside the MAC CE and values configurable for respective fields are as follows.
Serving Cell ID (serving cell identity): This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID (bandwidth part identity): This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Ti (TCI state identity): If there is a TCI state with TCI-StateId i as specified in TS 38.331 [5], this field indicates the activation/deactivation status of the TCI state with TCI-StateId i, otherwise MAC entity shall ignore the Ti field. The Ti field is set to 1 to indicate that the TCI state with TCI-StateId i shall be activated and mapped to the codepoint of the DCI Transmission Configuration Indication field, as specified in TS 38.214 [7]. The Ti field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Ti field set to 1, i.e. the first TCI State with Ti field set to 1 shall be mapped to the codepoint value 0, second TCI State with Ti field set to 1 shall be mapped to the codepoint value 1 and so on. The maximum number of activated TCI states is 8;
CORESET Pool ID (CORESET pool identity): This field indicates that mapping between the activated TCI states and the codepoint of the DCI Transmission Configuration Indication set by field Ti is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORESET Pool ID field shall be ignored when receiving the MAC CE.

Next, a PDSCH processing time (PDSCH processing procedure time) will be described. If the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), demodulation reference signal-related information, time and frequency resource allocation information, and the like) indicated through DCI. The PUSCH preparation procedure time is defined in NR in consideration thereof. The PUSCH preparation procedure time of the UE may follow Equation 3 given below.

$${T}_{proc , 1} = ( {N}_{1} + {d}_{1 , 1} + {d}_{2} ) ( 2048 + 1 \; 44 ) {κ2}^{- μ} {T}_{c} + {T}_{ext} \qquad [ Equation 3 ]$$

Each parameter in T_{proc,1} described above in Equation 3 may have the following meaning
N₁: the number of symbols determined according to UE processing capability 1 or 2 based on the UE's capability and numerology μ. N₁ may have a value in [Table 16] if UE processing capability 1 is reported according to the UE's capability report, and may have a value in [Table 17] if UE processing capability 2 is reported, and if availability of UE processing capability 2 is configured through upper layer signaling. The numerology μ may correspond to the minimum value among μ_{PDCCH}, μ_{PDSCH}, μ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an uplink channel in which a HARQ-ACK is to be transmitted.

TABLE 16

| | PDSCH decoding time N₁ [symbols] | |
|---|---|---|
| | | If PDSCH mapping type A and |
| | | B both do not correspond to |
| | If PDSCH mapping type A and | dmrs-AdditionalPosition = pos0 |
| | B both correspond to | inside DMRS-DownlinkConfig |
| | dmrs-AdditionalPosition = pos0 | which is upper layer signaling, |
| | inside DMRS-DownlinkConfig | or if no upper layer parameter |
| μ | which is upper layer signaling | is configured |
| 0 | 8 | N_{1, 0} |
| 1 | 10 | 13 |
| 2 | 17 | 20 |
| 3 | 20 | 24 |

TABLE 17

| | PDSCH decoding time N₁ [symbols] |
|---|---|
| | If PDSCH mapping type A and B both correspond to |
| | dmrs-AdditionalPosition = pos0 inside |
| μ | DMRS-DownlinkConfig which is upper layer signaling |
| 0 | 3 |
| 1 | 4.5 |
| 2 | 9 for frequency range 1 |

κ: 64
Tₑₓₜ: if the UE uses a shared spectrum channel access scheme, the UE may calculate Text and apply the same to the PDSCH processing time. Otherwise, Tₑₓₜ is assumed to be 0.
If 11 which represents the PDSCH DMRS location value is 12, N_{1,0} in [table 16] above has the value of 14, and otherwise has the value of 13.
With regard to PDSCH mapping type A, if the last symbol of the PDSCH is the ith symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.
If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If L≥4 and L≤6, then d_{1,1}=7−L.
If L=3, then d_{1,1}=min (d, 1).
If L=2, then d_{1,1}=3+d.
If PDSCH mapping type B is used with regard to UE processing capability 2, the d1, 1 value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If L>4 and L≤6, then d_{1,1}=7−L.
If L=2,
If the scheduling PDCCH exists inside a CORESET including three symbols, and if the CORESET and the scheduled PDSCH have the same start symbol, then d_{1,1}=3.
Otherwise, d_{1,1}=d.
In the case of a UE supporting capability 2 inside a given serving cell, the PDSCH processing time based on UE processing capability 2 may be applied by the UE if processingType2Enabled (upper layer signaling) is configured as “enable” with regard to the corresponding cell.

If the location of the first uplink transmission symbol of a PUCCH including HARQ-ACK information (in connection with the corresponding location, K₁ defined as the HARQ-ACK transmission timepoint, a PUCCH resource used to transmit the HARQ-ACK, and the timing advance effect may be considered) does not start earlier than the first uplink transmission symbol that comes after the last symbol of the PDSCH over a time of T_{proc,1}, the UE needs to transmit a valid HARQ-ACK message. That is, the UE needs to transmit a PUCCH including a HARQ-ACK only if the PDSCH processing time is sufficient. The UE cannot otherwise provide the base station with valid HARQ-ACK information corresponding to the scheduled PDSCH. The T_{proc,1} may be used in the case of either a normal or an expanded CP. In the case of a PDSCH having two PDSCH transmission locations configured inside one slot, d_{1,1} is calculated with reference to the first PDSCH transmission location inside the corresponding slot.

Next, indications of antenna port fields included within DCI format 1_1 and DCI format 1_2 are described. The antenna port fields within DCI formats 1_1 and 1_2 may be represented by 4, 5, or 6 bits, and may be indicated by the following Table 18 to Table 25. Table 18 shows the antenna port indications in the case of antenna port(s) (1000+DMRS port), dmrs-Type=1, maxLength=1.

TABLE 18
One Codeword:
Codeword 0 enabled,
Codeword 1 disabled

| | Number of DMRS CDM | DMRS |
|---|---|---|
| Value | group(s) without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

Table 19 shows the antenna port indications in the case of antenna port(s) (1000+DMRS port), dmrs-Type=1, maxLength=1.

TABLE 19
One Codeword:
Codeword 0 enabled,
Codeword 1 disabled

| | Number of DMRS CDM | DMRS |
|---|---|---|
| Value | group(s) without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12 | 2 | 0, 2, 3 |
| 13-15 | Reserved | Reserved |

Table 20 shows the antenna port indications in the case of antenna port(s) (1000+DMRS port), dmrs-Type=1, maxLength=2.

TABLE 20

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | | | DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, | 2 |
| | | | | | | 3, 4, 6 | |
| 2 | 1 | 0, 1 | 1 | 2 | 2 | 0, 1, 2, | 2 |
| | | | | | | 3, 4, 5, 6 | |
| 3 | 2 | 0 | 1 | 3 | 2 | 0, 1, 2, 3, | 2 |
| | | | | | | 4, 5, 6, 7 | |
| 4 | 2 | 1 | 1 | 4-31 | re- | re- | re- |
| | | | | | served | served | served |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | re- | re- | re- | | | | |
| | served | served | served | | | | |

Table 21 shows the antenna port indications in the case of antenna port(s) (1000+DMRS port), dmrs-Type=1, maxLength=2.

TABLE 21

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | Num- | | of | | |
| | DMRS | | ber | | DMRS | | |
| | CDM | | of f | | CDM | | Number |
| | group(s) | | ront- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, | 2 |
| | | | | | | 3, 4, 6 | |
| 2 | 1 | 0, 1 | 1 | 2 | 2 | 0, 1, 2, 3, | 2 |
| | | | | | | 4, 5, 6 | |
| 3 | 2 | 0 | 1 | 3 | 2 | 0, 1, 2, 3, | 2 |
| | | | | | | 4, 5, 6, 7 | |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |

Table 22 shows the antenna port indications in the case of antenna port(s) (1000+DMRS port), dmrs-Type=2, maxLength=1.

TABLE 22

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS CDM | | | DMRS CDM | |
| | group(s) | | | group(s) | |
| | without | DMRS | | without | DMRS |
| Value | data | port(s) | Value | data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

Table 23 shows the antenna port indications in the case of antenna port(s) (1000+DMRS port), dmrs-Type=2, maxLength=1.

TABLE 23

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS CDM | | | DMRS CDM | |
| | group(s) | | | group(s) | |
| | without | DMRS | | without | DMRS |
| Value | data | port(s) | Value | data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 2 | 0, 2, 3 | | | |
| 25-31 | Reserved | Reserved | | | |

Table 24 shows the antenna port indications in the case of antenna port(s) (1000+DMRS port), dmrs-Type=2, maxLength=2.

TABLE 24

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | Number | | DMRS | | |
| | CDM | | of | | CDM | | Number |
| | group(s) | | front- | | group(s) | | of front- |
| | without | DMRS | load | | without | DMRS | load |
| Value | data | port(s) | symbols | Value | data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, | 2 |
| | | | | | | 3, 6 | |
| 3 | 2 | 0 | 1 | 3 | 2 | 0, 1, 2, | 2 |
| | | | | | | 3, 6, 8 | |
| 4 | 2 | 1 | 1 | 4 | 2 | 0, 1, 2, | 2 |
| | | | | | | 3, 6, | |
| | | | | | | 7, 8 | |
| 5 | 2 | 2 | 1 | 5 | 2 | 0, 1, | 2 |
| | | | | | | 2, 3, | |
| | | | | | | 6, 7, | |
| | | | | | | 8, 9 | |
| 6 | 2 | 3 | 1 | 6-63 | Re- | Re- | Re- |
| | | | | | served | served | served |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, | 2 | | | | |
| | | 6, 7 | | | | | |
| 46 | 3 | 2, 3, | 2 | | | | |
| | | 8, 9 | | | | | |
| 47 | 3 | 4, 5, | 2 | | | | |
| | | 10, 11 | | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58- | re- | re- | re- | | | | |
| 63 | served | served | served | | | | |

Table 25 shows the antenna port indications in the case of antenna port(s) (1000+DMRS port), dmrs-Type=2, maxLength=2.

TABLE 25

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | | | DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, | 2 |
| | | | | | | 2, 3, 6 | |
| 3 | 2 | 0 | 1 | 3 | 2 | 0, 1, 2, | 2 |
| | | | | | | 3, 6, 8 | |
| 4 | 2 | 1 | 1 | 4 | 2 | 0, 1, 2, | 2 |
| | | | | | | 3, 6, 7, 8 | |
| 5 | 2 | 2 | 1 | 5 | 2 | 0, 1, 2, 3, | 2 |
| | | | | | | 6, 7, 8, 9 | |
| 6 | 2 | 3 | 1 | 6-63 | Re- | Re- | Re- |
| | | | | | served | served | served |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, | 2 | | | | |
| | | 6, 7 | | | | | |
| 46 | 3 | 2, 3, | 2 | | | | |
| | | 8, 9 | | | | | |
| 47 | 3 | 4, 5, | 2 | | | | |
| | | 10, 11 | | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 2 | 0, 2, 3 | 1 | | | | |
| 59- | re- | re- | re- | | | | |
| 63 | served | served | served | | | | |

Table 18 and Table 19 are used when dmrs-type is specified as 1 and maxLength is specified as 1, Table 20 and Table 21 are used when dmrs-Type=1 and maxLength=2, Table 22 and Table 23 are used when dmrs-type-2 and maxLength=1, and Table 24 and Table 25 are used when drms-type is 2 and maxLength is 2.

If the UE has received a MAC-CE that activates codepoints indicating two TCI states for at least one codepoint in the TCI state field in the DCI, the UE may receive an indication of the DMRS port by using Table 19, Table 21, Table 23, and Table 25 and otherwise, the UE may receive an indication of the DMRS port by using Table 18, Table 20, Table 22, and Table 24. If the UE has received an indication of a codepoint indicating two TCI states via the TCI state field, the UE may receive an indication of entries indicating DMRS ports 1000, 1002, and 1003 for NC-JT scheduling purposes in Table 19, Table 21, Table 23, or Table 25, and the corresponding entries may be entry #12 in Table 19, entry #31 in Table 21, entry #24 in Table 23, or entry #58 in Table 25.

For DCI format 1_1, if the UE has been configured with both the higher layer signaling dmrs-DownlinkForPDSCH-Mapping TypeA and dmrs-DownlinkForPDSCH-Mapping TypeB, the bit length of the antenna port field in DCI format 1_1 may be determined as max {x-_{A}, x_{B}}, where x_{A} and x_{B} may signify the bit lengths of the antenna port field determined by dmrs-DownlinkForPDSCH-MappingTypeA and dmrs-DownlinkForPDSCH-Mapping Type B, respectively. If a PDSCH mapping type corresponding to the smaller one of x_{A} and x_{B} is scheduled, as many MSB bits as |x_{A}-x_{B}| may be allocated as 0 bits and transmitted.

For DCI format 1_2, if the UE has not been configured with the higher layer signaling antennaPortsFieldPresenceDCI-1-2, the corresponding DCI format 1_2 may not have an antenna port field. In other words, the length of the antenna port field may be 0 bits in this case, and the UE may determine a DMRS port assuming the 0th entry of the above Table 18, Table 20, Table 22, and Table 24. If the UE has been configured with the higher layer signaling antennaPortsFieldPresenceDCI-1-2, the bit length of the antenna port field in DCI format 1_2 may be determined similarly to the case of DCI format 1_1 described above. If the UE has been configured with both the higher layer signaling dmrs-DownlinkForPDSCH-Mapping Type A-DCI-1-2 and dmrs-DownlinkForPDSCH-MappingTypeB-DCI-1-2, the bit length of the antenna port field in DCI format 1_2 may be determined as max {x-_{A}, x_{B}}, where x_{A} and x_{B} may denote the bit lengths of the antenna port field determined by dmrs-DownlinkForPDSCH-Mapping Type A-DCI-1-2 and dmrs-DownlinkForPDSCH-MappingTypeB-DCI-1-2, respectively. When a PDSCH mapping type corresponding to the smaller one of x_{A} and x_{B} is scheduled, as many MSB bits as |x_{A}-x_{B}| may be allocated as 0 bits and transmitted.

In Table 18 to Table 25, the numbers 1, 2, and 3 indicated by the number of DMRS CDM group(s) without data refer to CDMR groups {0}, {0, 1}, and {0, 1, 2}, respectively. In the Tables, in the “DMRS port(s)” column, indexes of ports being used are arranged according to the sequence of the indexes, and the antenna port is indicated by (DMRS port+1000). The DMRS CDM group is associated with a method of generating the DMRS sequence and the antenna port, as shown in Table 26 and Table 27. Table 26 shows parameters in the case of using dmrs-type=1 and Table 27 shows parameters in the case of using dmrs-type=2.

TABLE 26

| | CDM | | | | | |
|---|---|---|---|---|---|---|
| | group | | w_{f}(k′) | | wₜ(1′) | |
| p | λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 27

| | CDM | | | | | |
|---|---|---|---|---|---|---|
| | group | | w_{f}(k′) | | wₜ(1′) | |
| p | λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

The sequence of DMRS according to each parameter is determined as follows. p denotes a DMRS port, k denotes a subcarrier index, l denotes an OFDM symbol index, u denotes a subcarrier spacing, and wᵣ(k′) and wᵢ(l′) denote a frequency domain orthogonal cover code (FD-OCC) coefficient and a time domain orthogonal cover code (TD-OCC) coefficient according to the values of k′ and l′, respectively, and Δ is a value representing a spacing between CDM groups in terms of the number of subcarriers. β_{PDSCH}^{DMRS} is a scaling factor, which refers to a ratio between the energy per RE (EPRE) of PDSCH and the EPRE of DMRS, and may be calculated as

$${β}_{PDSCH}^{DMRS} = {10}^{- \frac{{β}_{DMRS}}{20}} ,$$

where β_{DMRS} may have a value of 0 dB, −3 dB, and −4.77 dB according to the number 1, 2, and 3 of CDM groups.

$${a}_{k , l}^{( p , u )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

For PDSCH DMRS sequence generation: The UE shall assume the sequence r(n) is defined by

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) ,$$

where the pseudo-random sequence c(i) is defined in clause 5.2.1. The pseudo-random sequence generator shall be initialized with cᵢₙᵢₜ=(2¹⁷(N_{symb}^{slot}n_{s,f}^{μ}+l+1)(2N_{ID}ⁿ^{_{SCID}}+n_{SCID})mod 2³¹, where l is the OFDM symbol number within the slot, n_{s,f}^{μ} is the slot number within a frame, and
N_{ID}⁰, N_{ID}¹∈{0, 1, . . . , 65535} are given by the higher-layer parameters scramblingID0 and scramblingID1, respectively, in the DMRS-DownlinkConfig IE if provided and the PDSCH is scheduled by PDCCH using DCI format 1_1 with the CRC scrambled by C-RNTI, MCS-C-RNTI, or CS-RNTI
N_{ID}⁰∈{0, 1, . . . , 65535} is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI;
N_{ID}ⁿ^{_{SCID}}=N_{ID}^{cell} otherwise;
   The quantity n_{SCID}∈{0, 1} is given by the DM-RS sequence initialization field, in the DCI associated with the PDSCH transmission if DCI format 1_1 in [4, TS 38.212] is used, otherwise n_{SCID}=0.

When DMRS type 1 is used, if a single codeword is scheduled and entries #2, #9, #10, #11, and #30 are indicated to a UE by using Table 18 and Table 20, if a single codeword is scheduled and entries #2, #9, #10, #11, and #12 are indicated thereto by using Table 19, or a single codeword is scheduled and entries #2, #9, #10, #11, #30, and #31 are indicated thereto by using Table 21, or two codewords are scheduled, the UE may consider that the scheduling is single-user MIMO scheduling. In other words, the UE may assume that no other UE is scheduled on all remaining orthogonal DMRS ports other than the DMRS port assigned to a PDSCH scheduled for the UE, and may not expect multi-user MIMO (MU-MIMO) scheduling. In this case, the UE may not assume that other UEs are co-scheduled and may not perform a multi-user MIMO reception operation such as canceling, nulling, or whitening multi-user interference.

When DMRS type 2 is used, if a single codeword is scheduled and entries #2, #10, and #23 are indicated to a UE by using Table 22 and Table 24, if a single codeword is scheduled entries #2, #10, #23, and #24 are indicated thereto by using Table 23, or if a single codeword is scheduled and entries #2, #10, #23, and #58 are indicated thereto by using Table 25, or if two codewords are scheduled, the UE may consider that the scheduling is single-user MIMO scheduling. In other words, the UE may assume that no other UE is scheduled on all remaining orthogonal DMRS ports other than the DMRS port assigned to a PDSCH scheduled for the UE, and may not expect multi-user MIMO (MU-MIMO) scheduling. In this case, the UE may not assume that other UEs are co-scheduled and may not perform a multi-user MIMO reception operation such as canceling, nulling, or whitening multi-user interference.

The UE may not expect that while the maximum number of front-loaded DMRS symbols is configured to be len2 via maxLength, which is higher layer signaling, one or more additional DMRS symbol are configured via dmrs-AdditionalPosition, which is higher layer signaling.

The UE may not expect that the number of actual front-loaded DMRS symbols, the number of actual additional DMRS symbols, a DMRS symbol position, and a DMRS type configuration are different for all UEs subject to multi-user MIMO scheduling.

In the case of a UE having PRG sizes of 2 or 4 may not expect that frequency resource allocation does not match in a PRG unit grid for other UEs co-scheduled using other orthogonal DMRS ports in the same CDM group as that of a DMRS port indicated to the UE.

In a case of PDSCH scheduled by DCI formats 1_1 and 1_2, the UE may assume that the CDM groups indicated by the column “Number of DMRS CDM group(s) without data” in Table 18 to Table 25 above may include DMRS ports assigned to other UEs that may be co-scheduled via a multi-user MIMO scheme and may not be used for data transmission by the corresponding UE. Further, in Table 18 to Table 25, a value of 1, 2, and 3 indicated by the column “Number of DMRS CDM group(s) without data” may be understood as meaning that the indexes of the CDM groups corresponding to the values correspond to CDM groups 0, {0, 1}, and {0, 1, 2}, respectively.

If the UE has been configured with dmrs-FD-OCC-disableForRank1PDSCH, which is higher layer signaling, and the UE has been assigned one DMRS port for PDSCH scheduling, the UE may not expect that other orthogonal DMRS ports belonging to the same CDM group as the assigned one DMRS port are assigned to other UEs with different FD-OCCs.

In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE configures UE capability according to band information and RAT type requested by the base station. The method in which the UE configures UE capability in an NR system is summarized below.

1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.

4. The UE may select BCs appropriate for the requested RAT type from the final “candidate BC list” and select BCs to report. In this step, the UE configures supportedBandCombinationList in a determined order. That is, the UE may configure BCs and UE capability to report according to a preconfigured rat-Type order. (nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

According to an embodiment of the disclosure, in order to receive a PDSCH from a plurality of TRPs, the UE may use non-coherent joint transmission (NC-JT).

A 5G wireless communication system may support all of the service having very short transmission latency and the service requiring a high connectivity density as well as the service requiring a high transmission rate unlike the conventional system. In a wireless communication network including a plurality of cells, transmission and reception points (TRPs), or beams, coordinated transmission between respective cells, TRPs, and/or beams may satisfy various service requirements by increasing the strength of a signal received by the UE or efficiently controlling interference between the cells, TRPs, and/or beams.

Joint transmission (JT) is a representative transmission technology for the coordinated communication and may increase the strength of a signal received by the UE or throughput by transmitting signals to one UE through different cells, TRPs, and/or beams. Here, a channel between respective cells, TRPs, and/or beam and the UE may have different characteristics, and particularly, non-coherent joint transmission (NC-JT) supporting non-coherent precoding between respective cells, TRPs, and/or beams may need individual precoding, MCS, resource allocation, and TCI indication according to the channel characteristics for each link between respective cells, TRPs, and/or beam and the UE.

The above-described NC-JT transmission may be applied to at least one of a downlink data channel (PDSCH), a downlink control channel (PDCCH), an uplink data channel (PUSCH), and an uplink control channel (PUCCH). In PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which may have a bad influence on reception performance of a PDCCH for transmitting the DCI. Accordingly, in order to support JT of the PDSCH, carefully designing a tradeoff between an amount of DCI information and reception performance of control information is required.

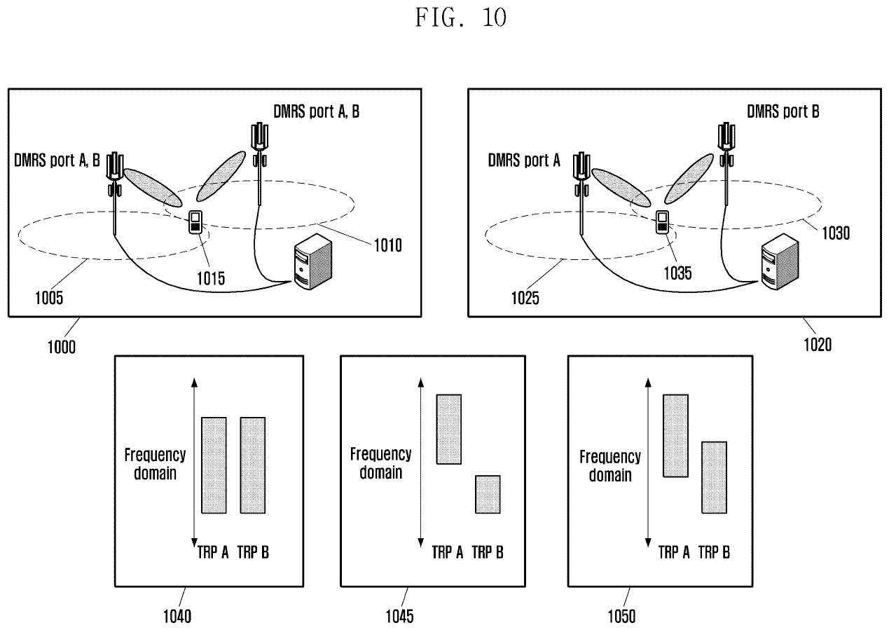

FIG. 10 illustrates a configuration of antenna ports and an example of resource allocation for transmitting a PDSCH using cooperative communication in a wireless communication system according to an embodiment of the disclosure.

Referring to FIG. 10, the example for PDSCH transmission is described for each scheme of joint transmission (JT), and examples for allocating radio resources for each TRP are described.

Referring to FIG. 10, an example 1000 of coherent joint transmission (C-JT) supporting coherent precoding between respective cells, TRPs, and/or beams is illustrated.

In the case of C-JT, a TRP A 1005 and a TRP B 1010 transmit single data (PDSCH) to a UE 1015, and multiple TRPs may perform joint precoding. This may signify that the TRP A 1005 and a TRP B 1010 transmit DMRSs through the same DMRS ports in order to transmit the same PDSCH. For example, the TRP A 1005 and a TRP B 1010 may transmit DMRSs to the UE through a DMRS port A and a DMRS port B, respectively. In this case, the UE may receive one piece of DCI information for receiving one PDSCH demodulated based on the DMRSs transmitted through the DMRS port A and the DMRS port B.

FIG. 10 shows an example 1020 of non-coherent joint transmission (NC-JT) that supports non-coherent precoding between each cell, TRP or/and beam for PDSCH transmission.

In the case of NC-JT, the PDSCH is transmitted to a UE 1035 per cell, per TPR, and/or per beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Further, respective cells, TRPs, and/or beams may repeatedly transmit the same PDSCH to the UE, thereby improving reliability compared to single cell, TRP, and/or beam transmission. For convenience of description, the cell, TRP, and/or beam are commonly called a TRP.

In this case, various wireless resource allocations such as the case 1040 in which frequency and time resources used by a plurality of TRPs for PDSCH transmission are all the same, the case 1045 in which frequency and time resources used by a plurality of TRPs do not overlap at all, and the case 1050 in which some of the frequency and time resources used by a plurality of TRPs overlap each other may be considered.

In order to support NC-JT, DCIs in various forms, structures, and relations may be considered to simultaneously allocate a plurality of PDSCHs to one UE.

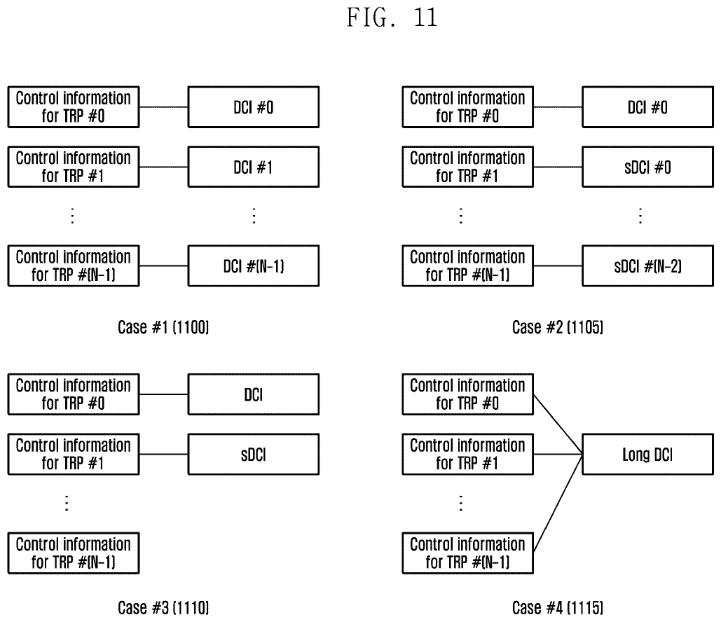

FIG. 11 illustrates an example for a configuration of downlink control information (DCI) for NC-JT in which respective TRPs transmit different PDSCHs or different PDSCH layers to the UE in a wireless communication system according to an embodiment of the disclosure.

Referring to FIG. 11, case #1 1100 is an example in which control information for PDSCHs transmitted from (N−1) additional TRPs is transmitted independently from control information for a PDSCH transmitted from a serving TRP in a situation in which (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCIs (DC1 #0 to DCI #(N−1)). Formats between the independent DCIs may be the same as or different from each other, and payload between the DCIs may also be the same as or different from each other. In case #1 described above, a degree of freedom of PDSCH control or allocation may be completely guaranteed, but when respective pieces of the DCI are transmitted by different TRPs, a difference between DCI coverages may be generated and reception performance may deteriorate.

Case #2 1105 is an example in which pieces of control information (DCI) for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCIs (hereinafter, referred to as sDCIs) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus can include reserved bits compared to the nDCI.

In case #2 described above, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 1110 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information such as frequency domain resource assignment and time domain resource assignment of the cooperative TRPs and the MCS. In addition, information that is not included in the sDCI such as a bandwidth part (BWP) indicator and a carrier indicator may follow the DCI (DCI #0, normal DCI, or nDCI) of the serving TRP.

In case #3 1110, a degree of freedom of PDSCH control or allocation may be limited according to content of the information elements included in the sDCI but reception performance of the sDCI can be controlled, and case #3 1130 may have smaller complexity of DCI blind decoding of the UE compared to case #1 1100 or case #2 1105.

Case #4 1115 is an example in which control information for PDSCHs transmitted from (N−1) additional TRPs is transmitted in the DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 1115, complexity of DCI blind decoding of the UE may not be increased, but a degree of freedom of PDSCH control or allocation may be low since the number of cooperative TRPs is limited according to long DCI payload restriction.

In the following description and embodiments, sDCI may refer to various pieces of supplementary DCI such as shortened DCI, secondary DCI, or normal DCI (DCI formats 1_0 and 1_1 described above) including PDSCH control information transmitted in the cooperative TRP, and unless specific restriction is mentioned, the corresponding description may be similarly applied to the various pieces of supplementary DCI.

In the following description and embodiments, Case #1 1100, case #2 1105, and case #3 1110 in which one or more pieces of DCI (or PDCCHs) are used to support NC-JT may be classified as multiple PDCCH-based NC-JT, and case #4 1115 in which single DCI (or PDCCH) is used to support NC-JT may be classified as single PDCCH-based NC-JT. In multiple PDCCH-based PDSCH transmission, a CORESET for scheduling the DCI of the serving TRP (TRP #0) is separated from CORESETs for scheduling the DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Further, in single PDCCH-based NC-JT, single DCI schedules a single PDSCH having a plurality of layers instead of scheduling a plurality of PDSCHs, and the plurality of layers may be transmitted from a plurality of TRPs. In this case, association between a layer and a TRP transmitting the corresponding layer may be indicated through a transmission configuration indicator (TCI) indication for the layer.

According to embodiments of the disclosure, the “cooperative TRP” may be replaced by various terms such as a “cooperative panel” or a “cooperative beam” when actually applied.

According to embodiments of the disclosure, “the case in which NC-JT is applied” may be variously interpreted as “the case in which the UE simultaneously receives one or more PDSCHs in one BWP”, “the case in which the UE simultaneously receives PDSCHs based on two or more transmission configuration indicator (TCI) indications in one BWP”, and “the case in which the PDSCHs received by the UE are associated with one or more DMRS port groups” according to circumstances, but is used by one expression for convenience of description.

In the disclosure, a wireless protocol structure for NC-JT may be variously used according to a TRP development scenario. For example, when there is no backhaul delay between cooperative TRPs or there is a small backhaul delay, a method (a CA-like method) using a structure based on MAC layer multiplexing can be used. On the other hand, when the backhaul delay between cooperative TRPs is too large to be ignored (for example, when a time of 2 ms or longer is needed to exchange information such as CSI, scheduling, and HARQ-ACK between cooperative TRPs), a method (a DC-like method) of securing a characteristic robust to a delay can be used through an independent structure for each TRP from an RLC layer.

The UE supporting C-JT/NC-JT may receive a C-JT/NC-JT-related parameter or a setting value from a higher-layer configuration and set an RRC parameter of the UE based on the same. For the higher-layer configuration, the UE may use a UE capability parameter, for example, tci-StatePDSCH. Here, the UE capability parameter, for example, tci-StatePDSCH may define TCI states for PDSCH transmission, the number of TCI states may be configured as 4, 8, 16, 32, 64, and 128 in FRI and as 64 and 128 in FR2, and a maximum of 8 states which can be indicated by 3 bits of a TCI field of the DCI may be configured through a MAC CE message among the configured numbers. A maximum value 128 refers to a value indicated by maxNumberConfiguredTCIstatesPerCC within the parameter tci-StatePDSCH which is included in capability signaling of the UE. As described above, a series of configuration processes from the higher-layer configuration to the MAC CE configuration may be applied to a beamforming indication or a beamforming change command for at least one PDSCH in one TRP.

As an embodiment of the disclosure, a multi-DCI-based multi-TRP transmission method will be described. According to multi-DCI based multi-TRP transmission method, a downlink control channel for NC-JT may be configured based on multi-PDCCHs.

In NC-JT based on multiple PDCCHs, there may be a CORESET or a search space separated for each TRP when the DCI for scheduling the PDSCH of each TRP is transmitted. The CORESET or the search space for each TRP can be configured according to at least one of the following configuration cases.
A configuration of a higher-layer index for each CORESET: CORESET configuration information configured by a higher layer may include an index value, and a TRP for transmitting a PDCCH in the corresponding CORESET may be distinguished by the configured index value for each CORESET. That is, in a set of CORESETs having the same higher-layer index value, it may be considered that the same TRP transmits the PDCCH or that the PDCCH for scheduling the PDSCH of the same TRP is transmitted. The index for each CORESET may be named CORESETPoolIndex, and it may be considered that the PDCCH is transmitted from the same TRP in CORESETs in which the same CORESETPoolIndex value is configured. In the CORESET in which the same CORESETPoolIndex value is not configured, it may be considered that a default value of CORESETPoolIndex is configured, and the default value may be 0.
   In the disclosure, when the number of types of CORESETPoolIndex of each of a plurality of CORESETs included in higher-layer signaling PDCCH-Config is larger than 1, that is, when respective CORESETs have different CORESETPoolIndex, the UE may consider that the base station can use a multi-DCI-based multi-TRP transmission method.
   Unlike this, in the disclosure, when the number of types of CORESETPoolIndex of each of a plurality of CORESETs included in higher-layer signaling PDCCH-Config is 1, that is, when all CORESETs have the same CORESETPoolIndex of 0 or 1, the UE may consider that the base station performs transmission using a single-TRP instead of using the multi-DCI-based multi-TRP transmission method.
A configuration of multiple PDCCH-Config: a plurality of PDCCH-Config are configured in one BWP, and each PDCCH-Config may include a PDCCH configuration for each TRP. That is, a list of CORESETs for each TRP and/or a list of search spaces for each TRP may be included in one PDCCH-Config, and it may be considered that one or more CORESETs and one or more search spaces included in one PDCCH-Config correspond to a specific TRP.
A configuration of a CORESET beam/beam group: a TRP that corresponds to the corresponding CORESET may be distinguished through a beam or a beam group configured for each CORESET. For example, when the same TCI state is configured in a plurality of CORESETs, it may be considered that the corresponding CORESETs are transmitted through the same TRP or that a PDCCH for scheduling a PDSCH of the same TRP is transmitted in the corresponding CORESET.
A configuration of a search space beam/beam group: a beam or a beam group is configured for each search space, and a TRP for each search space may be distinguished therethrough. For example, when the same beam/beam group or TCI state is configured in a plurality of search spaces, the same TRP may transmit the PDCCH in the corresponding search space or a PDCCH for scheduling a PDSCH of the same TRP may be transmitted in the corresponding search space.

As described above, by separating the CORESETs or search spaces for each TRP, it is possible to divide PDSCHs and HARQ-ACK for each TRP and accordingly to generate an independent HARQ-ACK codebook for each TRP and use an independent PUCCH resource.

The configuration may be independent for each cell or BWP. For example, while two different CORESETPoolIndex values may be configured in PCell, no CORESETPoolIndex value may be configured in a specific SCell. In this case, NC-JT may be configured in the PCell, but NC-JT may not be configured in the SCell in which no CORESETPoolIndex value is configured.

A PDSCH TCI state activation/deactivation MAC-CE which can be applied to the multi-DCI-based multi-TRP transmission method may follow FIG. 9. When the UE does not receive a configuration of CORESETPoolIndex for each of all CORESETs within higher-layer signaling PDCCH-Config, the UE may ignore a CORESET Pool ID field 955 within a corresponding MAC-CE 950. When the UE can support the multi-DCI-based multi-TRP transmission method, that is, when respective CORESETs within higher-layer signaling PDCCH-Config have different CORESETPoolIndex, the UE may activate a TCI state within the DCI included in PDCCHs transmitted in CORESETs having a CORESETPoolIndex value which is the same as a value of a CORESET Pool ID field 955 within the corresponding MAC-CE 950. For example, when the CORESET Pool ID field 955 within the corresponding MAC-CE 950 has a value of 0, a TCI state within the DCI included in PDCCHs transmitted by the CORESETs having CORSETPoolIndex of 0 may follow activation information of the corresponding MAC-CE.

When the UE receives, from the base station, a configuration such that the multi-DCI-based multi-TRP transmission method can be used, that is, the number of types of CORESETPoolIndex of a plurality of CORESETs included in higher-layer signaling PDCCH-Config is larger than 1 or respective CORESETs have different CORESETPoolIndex, the UE is able to know that there are the following restrictions on PDSCHs scheduled by PDCCHs within respective CORESETs having different two CORESETPoolIndex.

1) When PDSCH indicated by PDCCHs within respective CORESETs having different two CORESETPoolIndex completely or partially overlap, the UE may apply TCI states indicated by the respective PDCCHs to different CDM groups. That is, two or more TCI states may not be applied to one CDM group.

2) When PDSCH indicated by PDCCHs within respective CORESETs having different two CORESETPoolIndex completely or partially overlap, the UE may expect that the numbers of actual front loaded DMRS symbols of respective PDSCHs, the numbers of actual additional DMRS symbols, locations of actual DMRS symbols, and DMRS types are not different.

3) The UE may expect that bandwidth parts indicated by PDCCHs within respective CORESETs having different two CORESETPoolIndexs are the same and subcarrier spacings are also the same.

4) The UE may expect that information on PDSCH scheduled by PDCCHs within respective CORESETs having different two CORESETPoolIndex are completely included in respective PDCCHs.

As an embodiment of the disclosure, a single-DCI-based multi-TRP transmission method is described. The single-DCI-based multi-TRP transmission method may configure a downlink control channel for NC-JT based on a single-PDCCH.

In a single-DCI-based multi-TRP transmission method, a PDSCH transmitted from a plurality of TRPs may be scheduled by one piece of the DCI. Here, as a method of indicating the number of TRPs transmitting the corresponding PDSCHs, the number of TCI states may be used. That is, when the number of TCI states indicated by the DCI for scheduling the PDSCHs is 2, single PDCCH-based NC-JT transmission may be considered, and when the number of TCI states is 1, single-TRP transmission may be considered. The TCI states indicated by the DCI may correspond to one or two TCI states among TCI states activated by the MAC CE. When the TCI states of the DCI correspond to two TCI states activated by the MAC CE, a TCI codepoint indicated by the DCI is associated with the TCI states activated by the MAC CE, and this may correspond to a case in which the number of TCI states activated by the MAC CE, corresponding to the TCI codepoint, is 2.

In another example, when at least one of all codepoints of the TCI state field within the DCI indicate two TCI states, the UE may consider that the base station can perform transmission based on the single-DCI-based multi-TRP method. In this case, at least one codepoint indicating two TCI states within the TCI state field may be activated through an enhanced PDSCH TCI state activation/deactivation MAC-CE.

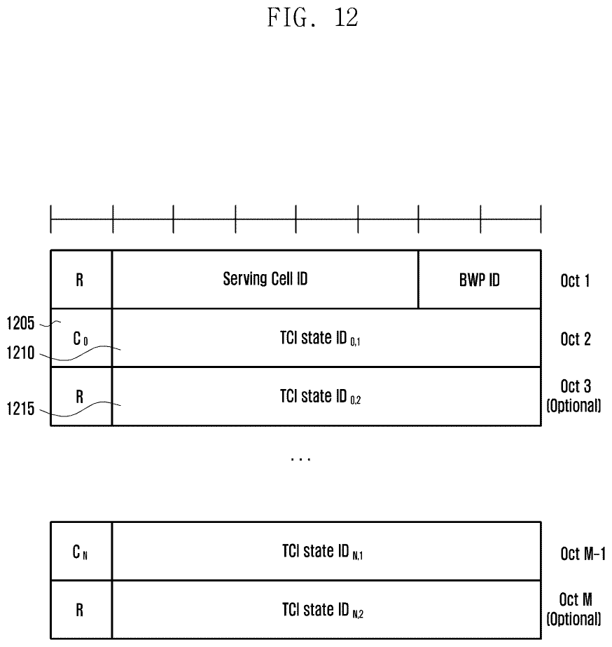

FIG. 12 illustrates an enhanced PDSCH TCI state activation/deactivation MAC-CE structure. The meaning of each field within the MAC CE and a value configurable in each field are as described in Table 28 below.

TABLE 28
- Serving Cell ID: This field indicates the identity of the Serving Cell
for which the MAC CE applies. The length of the field is 5 bits. If the
indicated Serving Cell is configured as part of a
simultaneousTCI-UpdateList1 or simultaneousTCI-UpdateList2 as
specified in TS 38.331 [5], this MAC CE applies to all the Serving Cells
configured in the set simultaneousTCI-UpdateList1 or
simultaneousTCI-UpdateList2, respectively;
- BWP ID: This field indicates a DL BWP for which the MAC CE
applies as the codepoint of the DCI bandwidth part indicator field as
specified in TS 38.212 [9]. The length of the BWP ID field is 2 bits;
- Cᵢ: This field indicates whether the octet containing TCI state ID_{i,2} is
present. If this field is set to “1”, the octet containing TCI state ID_{i,2} is
present. If this field is set to “0”, the octet containing TCI state ID_{i,2} is
not present;
- TCI state ID_{i,j}: This field indicates the TCI state identified by
TCI-StateId as specified in TS 38.331 [5], where i is the index of the
codepoint of the DCI Transmission configuration indication field as
specified in TS 38.212 [9] and TCI state ID_{i,j} denotes the j-th TCI state
indicated for the i-th codepoint in the DCI Transmission Configuration
Indication field. The TCI codepoint to which the TCI States are mapped
is determined by its ordinal position among all the TCI codepoints with
sets of TCI state ID_{i,j} fields, i.e. the first TCI codepoint with TCI state
ID_{0,1} and TCI state ID_{0,2} shall be mapped to the codepoint value 0, the
second TCI codepoint with TCI state ID_{1,1} and TCI state ID_{1,2} shall be
mapped to the codepoint value 1 and so on. The TCI state ID_{i,2} is optional
based on the indication of the Ci field. The maximum number of activated
TCI codepoint is 8 and the maximum number of TCI states mapped to a
TCI codepoint is 2.
R: Reserved bit, set to “0”.

In FIG. 12, when a Co field 1205 has a value of 1, the corresponding MAC-CE may include a TCI state ID_{0,2} field 1215 in addition to a TCI state ID_{0,1} field 1210. This signifies that a TCI state ID_{0, 1} and a TCI state ID_{0,2} are activated for a zeroth codepoint of the TCI state field included within the DCI, and when the base station indicates the corresponding codepoint to the UE, the UE may receive an indication of two TCI states. When the Co field 1205 has a value of 0, the corresponding MAC-CE is unable to include the TCI state ID_{0,2} field 1215, and this signifies that one TCI state corresponding to the TCI state ID_{0, 1} is activated for the zeroth codepoint of the TCI state field included in the DCI.

The configuration may be independent for each cell or BWP. For example, while a maximum number of activated TCI states corresponding to one TCI codepoint is 2 in the PCell, a maximum number of activated TCI states corresponding to one TCI codepoint may be 1 in a specific SCell. In this case, it may be considered that NC-JT may be configured in the PCell but NC-JT may not be configured in the SCell.

Next, a method of distinguishing single-DCI-based multi-TRP PDSCH repeated transmission schemes is described. The UE may receive an indication of different single-DCI-based multi-TRP PDSCH repeated transmission schemes (for example, TDM, FDM, and SDM) from the base station according to a value indicated by a DCI field and a higher-layer signaling configuration. Table 29 below shows a method of distinguishing single or multi-TRP-based schemes indicated to a UE according to a specific DCI field value and a higher-layer signaling configuration.

TABLE 29

| | Number | Number | repetitionNumber | Related to | Transmission |
|---|---|---|---|---|---|
| | of TCI | of CDM | configuration and | repetitionScheme | scheme indicated |
| Combination | states | groups | indication condition | configuration | to UE |
| 1 | 1 | ≥1 | condition 2 | Not configured | Single-TRP |
| 2 | 1 | ≥1 | condition 2 | Configured | Single-TRP |
| 3 | 1 | ≥1 | condition 3 | Configured | Single-TRP |
| 4 | 1 | 1 | condition 1 | Configured or | Single-TRP |
| | | | | not configured | TDM scheme B |
| 5 | 2 | 2 | condition 2 | Not configured | Multi-TRP SDM |
| 6 | 2 | 2 | condition 3 | Not configured | Multi-TRP SDM |
| 7 | 2 | 2 | condition 3 | Configured | Multi-TRP SDM |
| 8 | 2 | 1 | condition 3 | Configured | Multi-TRP FDM |
| | | | | | scheme A/FDM |
| | | | | | scheme B/TDM |
| | | | | | scheme A |
| 9 | 2 | 1 | condition 1 | Not configured | Multi-TRP TDM |
| | | | | | scheme |

Each column in Table 29 above may be described as follows.
Number of TCI states (second column): refers to the number of TCI states indicated by a TCI state field within the DCI, and may be 1 or 2.
Number of CDM groups (third column): refers to the number of different CDM groups of DRMS ports indicated by an antenna port field within the DCI. The number of CDM groups may be 1, 2, or 3.
RepetitionNumber configuration and indication condition (fourth column): has three conditions according to whether repetitionNumber for all TDRA entries which can be indicated by a time domain resource allocation field within the DCI is configured and whether an actually indicated TDRA entry has a repetitionNumber configuration.
Condition 1: case in which at least one of all TDRA entries which can be indicated by the time domain resource allocation field includes the configuration for repetitionNumber and the TDRA entry indicated by the time domain resource allocation field within the DCI includes the configuration of repetitionNumber larger than 1.
Condition 2: case in which at least one of all TDRA entries which can be indicated by the time domain resource allocation field includes the configuration for repetitionNumber and the TDRA entry indicated by the time domain resource allocation field within the DCI does not include the configuration for repetitionNumber.
Condition 3: case in which all TDRA entries which can be indicated by the time domain resource allocation field do not include the configuration for repetitionNumber.
Related to a repetitionScheme configuration (fifth column): refers to whether repetitionScheme which is higher-layer signaling is configured. RepetitionScheme which is higher-layer signaling may receive a configuration of one of ‘tdmSchemeA’, and ‘fdmSchemeA’, ‘fdmSchemeB’.
Transmission scheme indicated to UE (sixth column): refers to single or multiple-TRP schemes indicated according to each combination (first column) expressed by Table 29 above.
Single-TRP: refers to single-TRP-based PDSCH transmission. When the UE receives a configuration of pdsch-AggegationFactor within higher-layer signaling PDSCH-config, the UE may receive scheduling of single TRP-based PDSCH repeated transmission a number of times received through the configuration. Otherwise, the UE may receive scheduling of single TRP-based PDSCH single transmission.
Single-TRP TDM scheme B: refers to time resource division-based PDSCH repeated transmission between single TRP-based slots. The UE repeatedly transmits a PDSCH on a time dimension a number of times corresponding to the number of slots of repetitionNumber larger than 1 configured in the TDRA entry indicated by the time domain resource allocation field according to the above-described condition 1 related to repetitionNumber. In this case, a start symbol and a symbol length of the PDSCH indicated by the TDRA entry is equally applied to every slot corresponding to repetitionNumber and the same TCI state is applied to each PDSCH repeated transmission. The corresponding scheme is similar to a slot aggregation scheme in that the PDSCH repeated transmission between slots is performed in time resources but is different therefrom in that a repeated transmission indication is dynamically determined based on the time domain resource allocation field within the DCI.
Multi-TRP SDM: refers to a multi-TRP-based space resource division PDSCH transmission scheme. This is a method of dividing a layer and performing reception from each TRP and may increase reliability of PDSCH transmission in that transmission can be performed at a lowered coding rate through an increase in the number of layers even though it is not the repeated transmission scheme. The UE may receive a PDSCH by applying each of two TCI states indicated through the TCI state field within the DCI to two CDM groups indicated by the base station.
Multi-TRP FDM scheme A: refers to a multi-TRP-based frequency resource division PDSCH transmission scheme and is a scheme having one PDSCH transmission occasion and capable of performing transmission with higher reliability by increasing frequency resources and lowering a coding rate even though it is not the repeated transmission such as multi-TRP SDM. Multi-TRP FDM scheme A may apply two TCI states indicated through the TCI state field within the DCI to frequency resources which do not overlap each other. When the PRB bundling size is determined as a wideband and the number of RBs indicated by the frequency domain resource assignment field is N, the UE may receive first ceil(N/2) RBs by applying a first TCI state and receive the remaining floor(N/2) RBs by applying a second TCI state. Here, ceil(.) and floor(.) are operators indicating rounding up and rounding down at the first decimal place. When the PRB bundling size is determined as 2 or 4, even-numbered PRGs are received by applying a first TCI state and odd-numbered PRGs are received by applying a second TCI state.
Multi-TRP FDM scheme B: refers to a multi-TRP-based frequency resource division PDSCH repeated transmission scheme and has two PDSCH transmission occasions to repeatedly transmit a PDSCH on each occasion. In the same manner as the multi-TRP FDM scheme A, multi-TRP FDM scheme B may also apply two TCI states indicated through the TCI state field within the DCI to frequency resources which do not overlap each other. When the PRB bundling size is determined as a wideband and the number of RBs indicated by the frequency domain resource assignment field is N, the UE may receive first ceil(N/2) RBs by applying a first TCI state and receive the remaining floor(N/2) RBs by applying a second TCI state. Here, ceil(.) and floor(.) are operators indicating rounding up and rounding down at the first decimal place. When the PRB bundling size is determined as 2 or 4, even-numbered PRGs are received by applying a first TCI state and odd-numbered PRGs are received by applying a second TCI state.
Multi-TRP TDM scheme A: refers to a PDSCH repeated transmission scheme within a multi-TRP-based time resource division slot. The UE has two PDSCH transmission occasion within one slot, and a first reception occasion may be determined based on a start symbol and a symbol length of the PDSCH indicated through the time domain resource allocation field within the DCI. A start symbol of a second reception occasion of the PDSCH may be an occasion to which a symbol offset is applied by higher-layer signaling StartingSymbolOffsetK from the last symbol of the first transmission occasion, and the transmission occasion corresponding to the symbol length indicated therefrom may be determined. When higher-layer signaling StartingSymbolOffsetK is not configured, the symbol offset may be considered as 0.
Multi-TRP TDM scheme B: refers to a PDSCH repeated transmission scheme between multi-TRP-based time resource division slots. The UE has one PDSCH transmission occasion within one slot and may receive repeated transmission based on a start symbol and a symbol length of the same PDSCH during slots corresponding to repetitionNumber indicated by the time domain resource allocation field within the DCI. When repetitionNumber is 2, the UE may receive PDSCH repeated transmission of first and second slots by applying first and second TCI states, respectively. When repetitionNumber is larger than 2, the UE may use different TCI state application schemes according to configured higher-layer signaling tciMapping. When tciMapping is configured as cyclicMapping, first and second TCI states may be applied to first and second PDSCH transmission occasions, respectively, and the same TCI state application method is equally applied to the remaining PDSCH transmission occasions. When tciMapping is configured as sequenticalMapping, a first TCI state may be applied to first and second PDSCH transmission occasions, a second TCI state may be applied to third and fourth PDSCH transmission occasions, and the same TCI state application method may be equally applied to the remaining PDSCH transmission occasions.

Next, a scheduling method through multi-cell scheduling DCI (MC-DCI) is described.

In the disclosure, one piece of DCI may be single-DCI or one piece of DCI format, and multiple pieces of DCI may be multi-DCI or multiple DCI formats. In the disclosure, one piece of DCI may be a single PDCCH and/or may be transmitted or received through a single PDCCH, and multiple pieces of DCI may be multiple PDCCHs and/or may be transmitted or received through multiple PDCCHs.

Generally, a UE receives one piece of DCI, and the one piece of DCI may include scheduling information for one cell. For example, in the case of DCI format 0_0/0_1/0_2, a PUSCH may be scheduled for one uplink cell. In addition, in the case of DCI format 1_0/1_1/1/1_2, a PDSCH may be scheduled for one downlink cell. A cell subject to scheduling may be indicated by a carrier indication field (CIF) of the DCI format.

However, this approach requires multiple pieces of DCI to be transmitted and received when a PDSCH or PUSCH is scheduled in each of multiple cells. Accordingly, this may result in high DCI overhead. In order to reduce the DCI overhead, one piece of DCI may schedule PDSCHs and PUSCHs in each of multiple cells. For convenience, this may be referred to via MC-DCI. In the disclosure, the MC-DCI may be one piece of DCI that schedules PDSCH and/or PUSCH in each of the multiple cells. In this case, the DCI format of the MC-DCI may be DCI format 1_X or 1_3 in the case of PDSCH scheduling and DCI format 0_X or 0_3 in the case of PUSCH scheduling.

Within a specific cell, the UE may report, to a base station through UE capabilities, the number of candidate cell sets that can be scheduled via MC-DCI. In this case, a cell set signifies a set that includes multiple cells, for example, cell set 1 may include cell 1, cell 2, cell 3, and cell 4, and cell set 2 may include cell 5, cell 6, cell 7, and cell 8. The number of cells that may be included in a cell set may be up to four, and the cells included in each cell set may not overlap. In this case, the number of candidate cell sets that the UE may report through UE capabilities may be one, or two or more.

In case that the UE reports the number of candidate cell sets within a specific cell that can be scheduled via MC-DCI as one, the UE may expect that there is no cell set indicator field in the MC-DCI and the UE may expect scheduling for cells within the one cell set when receiving the MC-DCI from the base station.

In case that the UE reports that the number of candidate cell sets that can be scheduled via MC-DCI within a specific cell as two or more, the UE may expect that there is a cell set indicator field in the MC-DCI, and the UE may receive, from the base station, an indication of one cell set index through the corresponding field. The UE may receive scheduling information for one or more cells within one cell set of multiple cell sets via the MC-DCI. The following discussion assumes that the number of candidate cell sets reported by the UE is one, but a case in which the number of candidate cell sets may be two or more is not excluded.

The cells that may be scheduled by the MC-DCI may be configured via higher layer. For example, it is assumed that the MC-DCI is capable of scheduling (co-scheduling) cell 0, cell 1, cell 2, and cell 3. Upon receiving the MC-DCI, the UE may receive scheduling information for the cell 0, cell 1, cell 2, and cell 3. That is, the UE may receive scheduling information for cell 0, cell 1, cell 2, and cell 3 from the MC-DCI. For example, the MC-DCI being capable of scheduling cell 0, cell 1, cell 2, and cell 3 may be configured from the higher layer. Here, the scheduling information may include time domain resource assignment (TDRA) information and/or frequency domain resource assignment (FDRA) information by which data channels (PDSCH for downlink and PUSCH for uplink) are transmitted and received in each cell. Thus, the UE may obtain the scheduling information of each cell through the MC-DCI and transmit and receive data channels to and from each cell.

A base station may not be able to schedule for all cells configured for the UE in a specific situation. There may be a case in which scheduling is not possible for at least some of the multiple cells that the base station has configured for the UE. For example, although the base station configures, for the UE, four cells (e.g., cell 0, cell 1, cell 2, and cell 3) for scheduling via the MC-DCI, scheduling for some of the cells may not possible because they are subject to scheduling for other UEs, because of poor channel conditions, or for other reasons. In this case, the base station should be able to indicate to the UE which of the preconfigured cells subject to scheduling via MC-DCI are cells subject to scheduling. In other words, the base station should be able to indicate, to the UE, one or more cells (actually) subject to scheduling among the multiple cells subject to scheduling via MC-DCI.

This may be done based on one of the following two methods. Alternatively, this may be indicated based on a combination of at least one of the following two methods.

In a first method, the UE may obtain, from the MC-DCI, information indicating co-scheduled cells via the MC-DCI among the preconfigured cells (e.g., cell 0, cell 1, cell 2, cell 3). In other words, among the multiple cells configured to be scheduled via the MC-DCI, one or more cells that are (actually) co-scheduled via the MC-DCI may be identified based on the corresponding MC-DCI. More specifically, the base station may configure a table including the co-scheduled cells for the UE. For example, the rows in this table may have unique indices. The index of each row (and/or each row) may include the indices of the co-scheduled cells. For example, row 0 may be configured with {cell 0, cell 1}, row 1 may be configured with {cell 2, cell 3}, and row 2 may be configured with {cell 0, cell 1, cell 2, cell 3}. An example of a table configured in the UE may be shown in Table 30.

TABLE 30

| index | Co-scheduled cell |
|---|---|
| 0 | {0, 1} |
| 1 | {2, 3} |
| 2 | {0, 1, 2, 3} |

The UE may obtain, from the MC-DCI, a value indicating the index of the row. Accordingly, the UE may determine a cell subject to scheduling based on the value. For example, the MC-DCI may include information about the index of the row, and the UE may identify a cell subject to scheduling based on the table and the index of the row obtained from the MC-DCI. For example, when row 0 is indicated by the MC-DCI, the UE may identify that cell 0 and cell 1 are cells subject to scheduling. For example, when row 1 is specified by the MC-DCI, the UE may identify that cell 2 and cell 3 are the cells subject to scheduling. For example, when row 2 is indicated by the MC-DCI, the UE may identify that cell 0, cell 1, cell 2, and cell 3 are cells subject to scheduling.

In the disclosure, a table of mapping relationships between a cell subject to scheduling (or an index of a cell subject to scheduling) and an index indicated by DCI may be configured, and a cell subject to scheduling may be identified based on the table and the index indicated by the DCI.

Although the disclosure describes embodiments in which co-scheduled cells are identified based on indices of rows of a table, the disclosure is not limited thereto and may, for example, identify cells that are scheduled based on indices of columns of a table, and in this case, rows may be substituted for columns in the embodiments described above.

In the disclosure, when there are two or more candidate cell sets subject to scheduling via the MC-DCI that the UE receives within a specific cell, the UE may receive a configuration of the table as described above for each cell set, and the UE may determine which table to use for a cell set via the cell set indicator field in the MC-DCI.

In a second method, the UE may determine the presence or absence of scheduling information for one or more cells based on the FDRA field of the MC-DCI.

In case that the UE reports the number of candidate cell sets within a specific cell that can be scheduled via the MC-DCI as one, the UE may expect that there are as many FDRA fields in the MC-DCI as cells included in the one cell set. In this case, when the UE has not received a higher layer signaling configuration such as the table mentioned in the first method above, the UE may determine whether scheduling information exists for each cell based on one or more FDRA fields in the MC-DCI.

In case that the UE has reported the number of candidate cell sets within a specific cell that can be scheduled via MC-DCI, as two or more via UE capability reporting, the UE may expect as many FDRA fields to exist as those corresponding to the maximum of the number of cells included in each of the two or more cell sets. For example, when the UE has reported the number of candidate cell sets as two, the first cell set includes three cells, and the second cell set includes four cells, the UE may expect four FDRA fields to exist in the MC-DCI, which is the maximum of the number of cells included in each of the first and second cell sets.
In case that the UE has not received the higher layer signaling configuration, such as the table referred to in the first method above, for all cell sets, the UE may determine whether scheduling information exists for each cell based on the FDRA fields in the MC-DCI, when the number of cells in the cell set indicated by the UE via the cell set indicator field is less than the number of FDRA fields, the UE may consider the FDRA fields corresponding to the number of cells in the indicated cell set as the ascending index of the FDRA fields and may ignore the FDRA fields corresponding to indices greater than the number of cells.
If the UE has received higher layer signaling configuration, such as the table referred to in the first method above, for a specific set of cells and has not received for the remaining cell sets, the UE may expect the MC-DCI to include a scheduling cell indicator field that may indicate the index of a specific row within the table configured by the higher layer signaling as described in the first method above. Further, when determining the presence or absence of scheduling information for one or more cells to indicate which cell set is indicated via the cell set indicator field in the MC-DCI, the UE may use a method of interpreting the scheduling cell indicator field or interpreting the FDRA field. In this case, the scheduling cell indicator field that may be included in the MC-DCI may be a separate field distinct from the carrier indication field (CIF), or the CIF may replace the scheduling cell indicator field in the MC-DCI. In case that the UE has received, via the cell set indicator field in the MC-DCI, an indication of the set of cells that have received higher layer signaling such as the table above, the UE may receive, via the scheduling cell indicator field, an indication of the presence or absence of scheduling information for one or more cells. If the UE has received, via the cell set indicator field in the MC-DCI, an indication of a set of cells for which no higher layer signaling such as the table above has been configured, the UE may receive, via the FDRA field, an indication of the presence or absence of scheduling information for one or more cells.

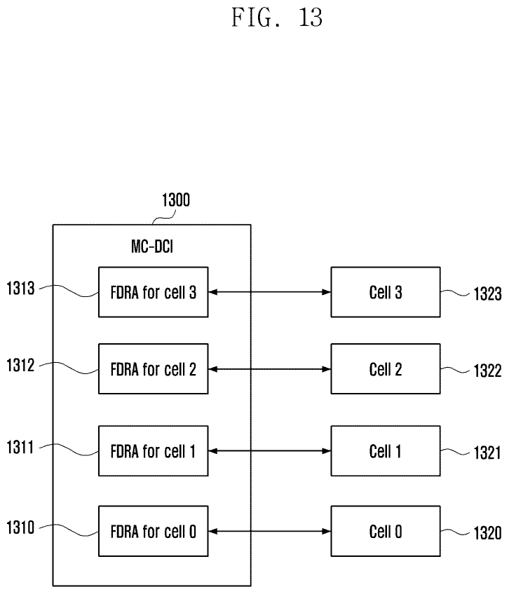

FIG. 13 illustrates an example of MC-DCI including multiple FDRA fields according to an embodiment of the disclosure.

Referring to FIG. 13, MC-DCI 1300 may include multiple FDRA fields. In addition, each FDRA field may have a corresponding cell. In other words, when cells that may be co-scheduled via the MC-DCI 1300 are configured as cell 0 1320, cell 1 1321, cell 2 1322, and cell 3 1323, the MC-DCI may include an FDRA field 1310 for cell 0, an FDRA field 1311 for cell 1, an FDRA field 1312 for cell 2, and an FDRA field 1313 for cell 3. Whether each cell is scheduled may be determined based on a value of the FDRA field. Cells that are subject to scheduling based on the value of the FDRA field may actually be referred to as co-scheduled cells.

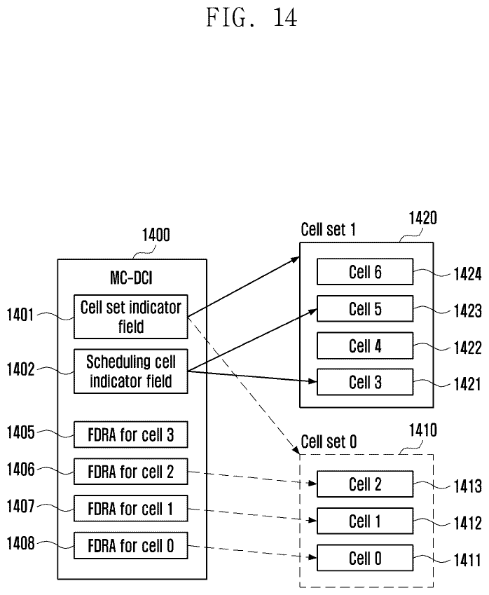

FIG. 14 illustrates an example of MC-DCI including at least one of a cell set indicator field, a scheduling cell indicator field, and multiple FDRA fields according to an embodiment of the disclosure.

Referring to FIG. 14, MC-DCI 1400 may include at least one of a cell set indicator field 1401, a scheduling cell indicator field 1402, and multiple FDRA fields 1405, 1406, 1407, and 1408. As described above, when a UE has reported, to a base station, a value indicating that there are two or more candidate cell sets, scheduling of which the UE can receive by receiving the MC-DCI within a specific cell, the UE may expect that the cell set indicator field 1401 exists in the MC-DCI. Further, when the UE reports one candidate cell set to the base station, the corresponding field may not exist. FIG. 14 illustrates a case in which the UE reports the number of candidate cell sets as two, and in which, cell set 0 1410 may include three cells of cell 0 1411, cell 1 1412, and cell 2 1413, and cell set 1 1420 may include cell 3 1421, cell 4 1422, cell 5 1423, and cell 6 1424. Thus, the UE may expect to have as many as four FDRA fields in the MC-DCI, which is the maximum number of cells included in each of cell set 0 1410 and cell set 1 1420.

Furthermore, in FIG. 14, the UE has assumed a situation in which the higher layer signaling as shown in the table above is not configured for the cell set 0 1410. Therefore, as in the second method above, the presence or absence of scheduling information for the cells within cell set 0 1410 may be indicated by the FDRA fields 1405, 1406, 1407, and 1408 in the MC-DCI. In this case, since there are three cells within cell set 0 1410, the UE may receive scheduling information for cell 0 1411, cell 1 1412, and cell 2 1413 indicated via the first, second, and third FDRA fields 1408, 1407, and 1406.

Further, in FIG. 14, the UE may assume a situation in which the higher layer signaling as shown in the table above is configured for the cell set 1 1420. Thus, as in the first method above, the presence or absence of scheduling information for the cells in the cell set 1 1420 may be indicated by the scheduling cell indicator field 1402 in the MC-DCI. For example, the UE may receive, from the scheduling cell indicator field 1402 in the MC-DCI, an indication of a specific row among all rows in the table configured via higher layer signaling, and the corresponding row may indicate scheduling information for, for example, cell 3 1421 and cell 5 1423 in the cell set 1 1420.

FDRA fields may be divided into fields having valid and invalid values. A valid value may signify that there is a frequency domain assignment corresponding to the value of the FDRA field. Conversely, an invalid value may signify that there is no frequency domain assignment corresponding to the value of the FDRA field.

For example, valid and invalid values are explained based on FDRA type-0. FDRA type-0 relates to a method of indicating RBs (or RBGs) scheduled based on a bitmap. Here, each bit may include corresponding RBs (or RBG). When a bit has a value of ‘1’, the corresponding RBs (or RBG) may be scheduled, and when a bit has a value of ‘0’, the corresponding RBs (or RBG) may not be scheduled. Accordingly, when at least one bit has a value of ‘1’, the FDRA field may be determined as a field having a valid value, and when all bits have a value of ‘0’, the FDRA field may be determined as a field having an invalid value.

For example, valid and invalid values are explained based on FDRA type-1. FDRA type-1 relates to a method of indicating RBs that are scheduled based on resource indication values (RIVs). Here, FDRA Type-1 may schedule consecutive RBs in the frequency domain. FDRA type-1 may indicate the index of the starting RB and the number of consecutive RBs. A value of RIV may be one of values of 0, 1, . . . , N*(N+1)/2−1, where N is the number of RBs in the frequency domain. Accordingly, an RIV value having a value of one of 0, 1, . . . , N*(N+1)/2−1 may be determined as a valid value, and an RIV value having a value equal to or greater than N*(N+1)/2 may be determined as an invalid value.

Some of the cells scheduled by MC-DCI may be cells in the licensed band, and other cells may be cells in the unlicensed band (or shared spectrum). For example, in the case of cells in unlicensed bands, FDRA type-2 may need to be used during uplink scheduling. Specific information of FDRA type-2 or an embodiment in which FDRA type-2 is used will be described later.

The disclosure provides a method of determining a cell scheduled by one piece of DCI when a UE supports multiple cell scheduling with one piece of DCI.

The UE may receive multiple frequency domain resource assignment (FDRA) fields via one piece of DCI, and may determine a cell corresponding to each FDRA field. The UE may determine whether to schedule to the cell based on the FDRA type of the cell and the value of the FDRA field. The UE may identify whether a cell is scheduled and/or identify a scheduled cell and/or a non-scheduled cell based on one or more of the FDRA type or the FDRA field. For example, a method of interpretating the FDRA field may differ according to a subcarrier spacing of the corresponding cell.

When the UE is configured with FDRA type-2 in a cell, whether to schedule the cell may be determined based on at least one or a combination of one or more of the followings.

When the one cell has a 15 kHz subcarrier spacing, the UE may determine that the cell is not subject to scheduling if the FDRA field has a value as follows.

In the first case, all bits of the FDRA field have a value of ‘1’.

In the second case, all of the first 6 bits in the FDRA field have a value of ‘1’. In other words, the second case corresponds to a case in which all of the 6 most significant bits (MSBs) among the bits in the FDRA field have a value of ‘1’.

In the third case, all the last Y bits in the FDRA field have a value of ‘1’. In other words, the third case corresponds to a case in which all of the Y least significant bits (LSBs) among bits in the FDRA field have a value of ‘1’.

If the one cell has a 30 kHz subcarrier spacing cell, the UE may determine that the cell is not subject to scheduling if the FDRA field has a value as follows.

In the first case, all of the first 5 bits of the FDRA field have a value of ‘0’ and all the last Y bits have a value of ‘1’. In other words, the first case corresponds to a case in which all of the 5 MSBs of the bits in the FDRA field have a value of ‘0’, and all of the Y LSBs have a value of ‘1’.

In the second case, all the bits in the FDRA field have a value of ‘0’.

In the third case, all of the first 5 bits of the FDRA field have a value of ‘0’. In other words, the third case corresponds to a case in which all of 5 MSBs of the bits in the FDRA field have a value of ‘0’.

In the fourth case, all the last Y bits in the FDRA field have a value of ‘1’. In other words, all of Y LSBs of the bits in the FDRA field have a value of ‘1’.

Each situation is described in more detail below.

Situation 1. A Case in which One Cell has a 15 kHz Subcarriers Spacing

The UE may identify the subcarrier spacing and FDRA type information of each cell included in the set of candidate cells scheduled via the MC-DCI. If one of the cells included in the set of candidate cells scheduled by the MC-DCI is configured with FDRA type-2, the UE may identify whether the subcarrier spacing of the cell is 15 kHz (μ=0) or 30 kHz (μ=1). In this embodiment, the UE may identify that the subcarrier spacing of the cell is 15 kHz (μ=0).

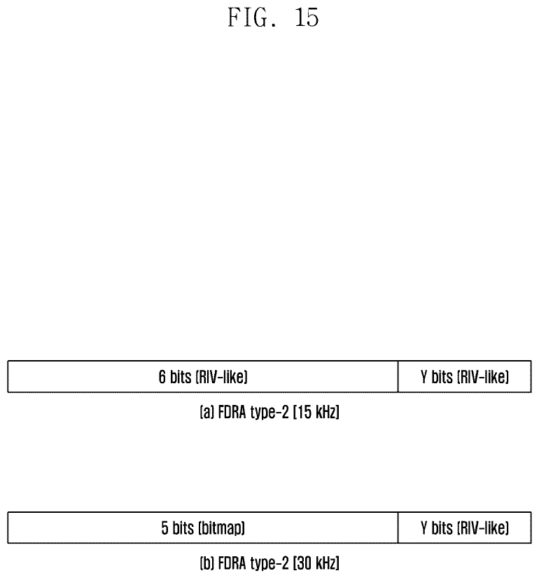

FIG. 15 illustrates an example of a field indicating frequency domain resource assignment information based on the subcarrier spacing of a cell, according to an embodiment of the disclosure.

Referring to (a) in FIG. 15, when the subcarrier spacing of a cell is 15 kHz, the field indicating the frequency domain resource assignment information of the cell within the MC-DCI may have a length of (6+Y bits). Here, the 6 bits may indicate the start index (m₀) and the length (L) of M (M=10) interlaces included within one RB set, and the Y bits indicate the scheduled RB-set and are expressed by

$$Y = ⌈ log 2 \frac{{N}_{RB - set , UL}^{BWP} ( {N}_{RB - set , UL}^{BWP} + 1 )}{2} ⌉ .$$

Here, the Y bits may indicate the index and length of the starting RB set among the RB sets included in the UL BWP. In the disclosure, N_{RB-set,UL}^{BWP} may be the number of RB-sets configured for the indicated active UL BWP. In the disclosure, the 6 bits and Y bits may be referred to as RIV-scheme (or RIV-like) for convenience.

More specifically, the 6 bits are as follows. Referring to the RIV equation or Table 13 above, a value of 0, 1, . . . , M*(M+1)/2−1=54 among the RIV values may indicate the starting interlace index and the number of consecutive interlace indices according to the RIV equation, and thereafter, RIV=M*(M+1)/2=55, M*(M+1)/2+1=56, . . . . M*(M+1)/2+7=62 may receive an indication of the start interlace index (m₀) and a value of/according to Table 13. The 6 bits of the RIV value may represent one of a value of 0, 1, . . . , 63, where 0, 1, . . . , 62 is a value used to schedule the interface. However, RIV=63 (6 bits are ‘111111’ in binary) may be an unused value. In other words, there may be no interlace subject to scheduling corresponding to the above value (RIV=63). Therefore, non-scheduled cells may be indicated using the value (RIV=63 (where 6 bits are ‘111111’ in binary)).

More specifically, the Y bits are as follows. Referring to the description of the least significant bit (LSB) Y of the FDRA field for 15 kHz and 30 kHz described above, the following may be observed.
When one RB-set is included in the UL BWP, (N_{RB-set,UL}^{BWP}=1), Y=0 bits (Y=0). Therefore, when Y=0 bits, cells that are not scheduled with the above Y bits may not be indicated.
When two RB-sets are included in the UL BWP, (N_{RB-set,UL}^{BWP}=2), Y=2 bits (Y=2). Here, RIV_{RB-set}=0, 1, 2 may be used to indicate the starting RB set index and the number of consecutive RB sets. The Y bits may have a value of 0, 1, . . . , 3. Accordingly, there may be no RB-set subject to scheduling corresponding to Y bits of 3 (all 2 bits are ‘11’, where 2 bits are ‘11’ in binary). Therefore, a non-scheduled cell may be indicated using the above value (3 (2 bits are ‘11’ in binary)).
When three RB-sets are included in the UL BWP, (N_{RB-set,UL}^{BWP}=3), Y=3 bits (Y=3). Here, RIV_{RB-set}=0, 1, 2, 3, 4, 5 may be used to indicate the starting RB set index and the number of consecutive RB sets. The Y bits may have a value of 0, 1, . . . , 7. Thus, there may be no RB-set subject to scheduling corresponding to Y bits of 7 (all 3 bits are ‘111’, where 3 bits are ‘111’ in binary). Therefore, a non-scheduled cell may be indicated using the above value (7 (where 3 bits are ‘111’ in binary)).
When four RB-sets are included in the UL BWP, (N_{RB-set,UL}^{BWP}=4), Y=4 bits (Y=4). Here, RIV_{RB-set}=0, 1, . . . , 9 is used to indicate the starting RB set index and the number of consecutive RB sets. The Y bits may have a value of 0, 1, . . . , 15. Therefore, there may be no scheduled RB-set subject to scheduling corresponding to Y bits of 15 (all of 4 bits are ‘1111’, where 4 bits are ‘1111’ in binary). Therefore, non-scheduled cells may be indicated using the above value (15 (4 bits are ‘1111’ in binary))
When five RB-sets are included in the UL BWP, (N_{RB-set,UL}^{BWP}=5), Y=4 bits (Y=4). Here, RIV_{RB-set}=0, 1, . . . , 14 is used to indicate the starting RB set index and the number of consecutive RB sets. The Y bits may have a value of 0, 1, . . . , 15. Therefore, there may be no scheduled RB-set subject to scheduling corresponding to Y bits of 15 (all 4 bits are ‘1111’, where 4 bits are ‘1111’ in binary). Therefore, non-scheduled cells may be indicated using the above value (15 (4 bits are ‘1111’ in binary)).

In summary, for the remaining of the Y-bit size, except for the case where Y=0, if all of Y bits have a value of ‘1’, a non-scheduled cell may be indicated. That is, if all of bits included in the Y LSB of FDRA have a value of ‘1’, a non-scheduled cell may be indicated.

In the disclosure, a method of indicating a cell of 15 kHz subcarrier spacing that is not subject to scheduling may be obtained by one or a combination of at least one of the following. In the description of the method, an FDRA field is a field corresponding to a cell having 15 kHz subcarrier spacing cell. In addition, the FDRA type may be FDRA type-2.
In the first method, the UE may determine whether a cell is scheduled based on all bits (6+Y bits) of the FDRA field. For example, when all bits of the FDRA field have a value of ‘1’, the UE may determine that the cell is a non-scheduled cell. Here, the FDRA field may include 6 bits MSB and Y bits LSB. Accordingly, the UE may determine that the cell having 15 kHz subcarrier spacing corresponding to the FDRA field is not subject to scheduling in case that all of bits based on a total of (6+Y bits) have a value of ‘1’ (if the bit value of the bits included in the (6+Y bits) are all 1). For example, when all of the 6 bits MSB have a value of 1 and not all of the remaining Y bits LSB have a value of 1 (if all of the bits included in the 6 MSB have a bit value of 1 and at least some of the bits included in the Y LSB have a value of 0, or if all of the bits included in the 6 MSB have a bit value of 1 and all of the bits included in the Y LSB have a bit value of 0), the UE may determine that the DCI format including the above information corresponds to an error case. Alternatively, when all of the Y bits LSB have a value of 1 and not all of the remaining 6 bits MSB have a value of 1 (if all of the bits included in the Y LSB have a bit value of 1 and at least some of the bits included in the 6 MSB have a value of 0, or if all of the bits included in the Y LSB have a bit value of 1 and all of the bits included in the 6 MSB have a bit value of 0), the UE may determine that the DCI format including the above information is an error case. When the UE determines that the DCI format corresponds to an error case, the UE may discard (or ignore) the information indicated by the DCI format without applying the same. In case that the UE determines that the DCI format corresponds to an error case, the UE may discard, among the information indicated by the DCI format, the information about the cell (the cell corresponding to the FDRA field determined to be an error case) without applying the same, and apply the information about the remaining cells (the remaining cells except the cell corresponding to the FDRA field determined to be an error case).
In a second method, the UE may determine whether a cell is scheduled based on the 6 bits MSB only of the FDRA field. The UE may identify whether a cell is scheduled or not based on the 6 MSBs of the FDRA field. For example, when all of bits in the 6 bits MSB of the FDRA field have a value of ‘1’ (all bits included in the 6 MSB have a bit value of 1), the UE may determine that the cell (the cell corresponding to the FDRA field) is a non-scheduled cell. Thus, the UE may determine that the cell having 15 kHz subcarrier spacing corresponding to the FDRA field is not subject to scheduling, based on that all of 6 bits MSB have a value of ‘1’. In this case, for example, the bits in the Y bits LSB may not provide information. In other words, whether a cell is scheduled or not may be determined based on the 6 bits MSB regardless of the value of Y bits LSB. For example, the Y bits LSB may be discarded, ignored, or not included in the FDRA field (e.g., Y=0).
In a third method, the UE may determine whether a cell is scheduled based on the Y bits LSB only of the FDRA field. The UE may identify whether a cell is scheduled or not based on the Y LSB of the FDRA field. For example, when all of bits in the Y bits LSB of the FDRA field have a value of ‘1’ (all bits included in the Y LSB have a bit value of 1), the UE may determine that a cell (a cell corresponding to the FDRA field) is a non-scheduled cell. Thus, the UE may determine that the cell having 15 kHz subcarrier spacing corresponding to the FDRA field is not subject to scheduling, based on that all of bits in the Y LSB bits have a value of ‘1’. In this case, for example, the bits in the 6 bits MSB may not provide information. In other words, whether a cell is scheduled or not may be determined based on the Y bits LSB regardless of the value of 6 bits MSB. For example, the 6 bits MSB may be discarded, ignored, or not included in the FDRA field.

According to an embodiment, the third method may be used in the case of Y>0. If Y=0, the second method may be used. In other words, based on the value of Y, the second method or the third method may be used selectively. In other words, based on the value of Y (the bit size of the Y LSB of the FDRA field), the UE may determine a method to be used.

### Situation 2: One Cell has 30 kHz Subcarrier Spacing

The UE may identify the subcarrier spacing and FDRA type information of each cell included in the set of candidate cells scheduled by the MC-DCI. If one of the cells included in the set of candidate cells scheduled by the MC-DCI is configured with FDRA type-2, the UE may identify whether the subcarrier spacing of the cell is 15 kHz (μ=0) or 30 kHz (μ=1). In this embodiment, the UE may identify that the subcarrier spacing of the cell is 30 kHz (μ=1).

Referring to (b) in FIG. 15, when the subcarrier spacing of a cell is 30 kHz, the field indicating the frequency domain resource assignment information of the cell within the MC-DCI may have a length of (5+Y bits). Here, the 5 bits may be a bitmap indicating whether M (M=5) interlaces included in an RB set are scheduled. In other words, each of the 5 bits may be used to indicate whether one interlace is subject to scheduling. Here, an interlace corresponding to a bit with a value of ‘1’ among the 5 bits may be determined as scheduled. An interlace corresponding to a bit with a value of ‘0’ among the 5 bits may be determined as not scheduled. The Y bits indicate the scheduled RB-set and is expressed by

$$Y = ⌈ log 2 \frac{{N}_{RB - set , UL}^{BWP} ( {N}_{RB - set , UL}^{BWP} + 1 )}{2} ⌉ .$$

The Y bits may indicate an index and length of the starting RB set among the RB sets included in the UL BWP. In the disclosure, N_{RB-set,UL}^{BWP} may indicated the number of RB-sets configured for the indicated active UL BWP. In the disclosure, for convenience, 5 bits are referred to as the bitmap method and Y bits is referred to as the RIV (or RIV-like) method.

The 5 bits may indicate an interlace subject to scheduling based on the bitmap. The UE may determine that if each bit of the 5 bits has a value of ‘1’, an interlace corresponding to ‘1’ is subject to scheduling. In other words, an interlace corresponding to the bit with a value of ‘1’ among the 5 bits may be determined as scheduled. If all 5 bits have a value of ‘0’, no interlacing may be subject to scheduling. Therefore, the case in which all 5 bits have a value of ‘O’ may be used to determine that a cell is not subject to scheduling.

Since the Y bits in Situation 2 are the same as those in Embodiment 1, description thereof will be omitted, and reference may be made to the description of the Y bits in Situation 1.

The FDRA field of a cell with 30 kHz subcarrier spacing includes (5+Y bits), where the 5 bits MSB indicate the interlaces scheduled in a bitmap method within the RB set, and the Y bits LSB indicate the RB sets scheduled in an RIV method. Therefore, the value of the 5 bits MSB and the Y bits LSB may determine whether the cell is scheduled or not.

In the disclosure, the method for indicating that a cell with a 30 kHz subcarrier spacing is not subject to scheduling may be one or a combination of at least one of the following. In the description of the method, the FDRA field is the field corresponding to the 30 kHz subcarrier spacing cell. Further, the FDRA type may be FDRA type-2.
In the first method, the UE may determine whether the cell is scheduled or not based on all bits (5+Y bits) of the FDRA field. For example, when all bits of the FDRA field have a value of ‘0’, the UE may determine that the cell with 30 kHz subcarrier spacing is a non-scheduled cell. Here the FDRA field may include 5 bits MSB and Y bits LSB. Thus, the UE may determine that the 30 kHz subcarrier spacing cell corresponding to the FDRA field is not subject to scheduling in case that all the bits included in the (5+Y bits) have a value of ‘0’ based on a total of (5+Y bits). For example, when all of the Y bits LSB have a value of ‘0’, there may be a corresponding value according to the expression RIV_{RB-set}. However, since all of the 5 MSB bits have a value of ‘0’, the RB set indicated by the Y LSB bits may not be used as information indicating whether scheduling occurs or not. In other words, since all of the 5 MSB bits have a value of ‘0’, it is determined that there is no interlace subject to scheduling, and thus the RB set corresponding to the Y bits LSB may be ignored.
In a second method, the UE may determine whether a cell is scheduled based on the 5 bits MSB only of the FDRA field. The UE may identify whether a cell is scheduled or not based on the 5 MSBs of the FDRA field. For example, when all of bits in the 5 bits MSB of the FDRA field have a value of ‘0’ (all bits included in the 5 MSB have a bit value of 1), the UE may determine that the cell (the cell corresponding to the FDRA field) is a non-scheduled cell. Thus, the UE may determine that the cell having 30 kHz subcarrier spacing corresponding to the FDRA field is not subject to scheduling, based on that all of 5 bits MSB have a value of ‘1’. In this case, for example, the bits in the Y bits LSB may not provide information. In other words, whether a cell is scheduled or not may be determined based on the 5 bits MSB regardless of the value of Y bits LSB. For example, the Y bits LSB may be discarded, ignored, or not included in the FDRA field (e.g., Y=0).
In a third method, the UE may determine whether a cell is scheduled based on the Y bits LSB only of the FDRA field. The UE may identify whether a cell is scheduled or not based on the Y LSB of the FDRA field. For example, when all of bits in the Y bits LSB of the FDRA field have a value of ‘1’ (all bits included in the Y LSB have a bit value of 1), the UE may determine that the cell (the cell corresponding to the FDRA field) is a non-scheduled cell. Thus, the UE may determine that the cell having 30 kHz subcarrier spacing corresponding to the FDRA field is not subject to scheduling, based on that all of the Y LSB bits have a value of ‘1’. In this case, for example, the bits in the 5 bits MSB may not provide information. In other words, whether a cell is scheduled or not may be determined based on the Y bits LSB regardless of the value of 5 bits MSB. For example, the 5 bits MSB may be discarded, ignored, or not included in the FDRA field.

According to an embodiment, the third method may be used in the case of Y>0. If Y=0, the second method may be used. In other words, based on a value of Y, the second method or the third method may be used selectively. In other words, based on a value of Y (the bit size of the Y LSB of the FDRA field), the UE may determine a method to be used.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

In the following description of the disclosure, upper layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

As used herein, the term “slot” may generally refer to a specific time unit corresponding to a transmit time interval (TTI), may specifically refer to a slot used in a 5G NR system, or may refer to a slot or a subframe used in a 4G LTE system.

### First Embodiment: Multi-User Scheduling Support Signaling

An embodiment of the disclosure describes multi-user scheduling support signaling that a UE may receive from a base station. This embodiment may operate in combination with other embodiments.

A base station may use a multi-user MIMO scheduling method (also referred to as MU-MIMO scheduling), which is a method capable of scheduling multiple UEs for the same time and frequency resource, to increase overall system throughput under limited time and frequency resources. Through this scheduling method, a predetermined UE may be scheduled for the same time and frequency resources as those of multiple other UEs during MU-MIMO scheduling from the base station, which may cause the corresponding UE to receive signals transmitted to other UEs together, thereby increasing the amount of interference. Therefore, interference control by the base station and the UE may be important in MU-MIMO scheduling. For interference control at the UE side, the UE may be equipped with a special receiver such as reduced maximum likelihood (R-ML). The UE equipped with an R-ML receiver may determine all the reception signals for other UEs that are subject to MU-MIMO scheduling with the UE to increase the accuracy of the signal that the UE should receive.

$${y}_{i} = {h}_{i} {w}_{i} {x}_{i} + {\sum }_{k \neq i , k = 1}^{N} {h}_{i} {w}_{k} {x}_{k} + {n}_{i} = {H}_{{i}^{x} i} + {\sum }_{k \neq i , k = 1}^{N} {H}_{k} {x}_{k} + {n}_{i} \qquad [ Equation 4 ]$$

The above Equation 4 expresses a reception signal yᵢ of the i-th UE when N UEs are subject to scheduling for downlink MU-MIMO from the base station. In other words, i referring to the index of the UE may be from 1 to N. Here, hᵢ may signify a channel between the base station and the i-th UE, wᵢ may signify a precoder in the base station for the i-th UE, xᵢ may signify a modulated symbol transmitted to the i-th UE, and n; may signify white noise received by the i-th UE. Further, Hₖ=hᵢwₖ may be a channel in a modified sense in which the channel of the i-th UE is multiplied by the precoder for the k-th UE and, when i and k are the same (i.e., Hᵢ=hᵢwᵢ), the UE may estimate Ha by using the assigned DMRS sequence and DMRS port information and may accordingly demodulate the reception signal. Here, if the UE may use the R-ML receiver, the UE may detect a demodulation signal \hat{x}₁*, . . . , \hat{x}_{N}* for the corresponding UE and other UEs that satisfy Equation 5 below.

$$\{ {\hat{x}}_{1}^{*} , … , {\hat{x}}_{N}^{*} \} = {arg min}_{{\hat{x}}_{1} , … , {\hat{x}}_{N}} ‖ {y}_{i} - {\sum }_{k = 1}^{N} {\hat{H}}_{k} {\hat{x}}_{k} ‖ \qquad [ Equation 5 ]$$

The above Equation 5 represents the principle of the R-ML receiver. According to principle of the R-ML receiver, the i-th UE may detect a demodulation signal \hat{x}₁*, . . . , \hat{x}_{N}* for the corresponding UE and other UEs, which minimizes a difference between the reception signal of the i-th UE and the signal transmitted by the base station to the i-th UE (for every k-th UE, a product of the demodulated signal xₖ and a modified channel Hₖ obtained by multiplying a channel between the base station and the i-th UE with the precoder for the k-th UE). In this case, since the i-th UE only knows the DMRS sequence of the corresponding UE and the modulation order of the corresponding UE, and has no information about the DMRS sequences, DMRS ports, modulation orders of the other UEs and how many UEs are subject to MU-MIMO scheduling with the i-th UE, it may be difficult to obtain information about a value of Ĥₖ\hat{x}ₖ where k differs from i in the above part of Σₖ₌₁^{N} Ĥₓ\hat{x}ₖ of Equation 5. In a state where there is no information about the DMRS sequences, DMRS ports, modulation orders of the other UEs and how many UEs are subject to MU-MIMO scheduling with the i-th UE, the i-th UE may attempt to calculate Equation 5 by generating the value of Ĥₖ\hat{x}ₖ where k is different from i, i.e., the i-th UE may attempt to calculate Equation 5 by using all possible combinations of other UEs' DMRS sequences, DMRS ports, demodulation schemes, and the total number of UEs subject to MU-MIMO scheduling, but this may result in a very large computational complexity for the UE.

As shown by the reception signal yᵢ in Equation 4 above, the i-th UE receives inter-UE interference signals such as Σ_{k≠i, k=1}^{N} Hₖxₖ, which may result in large interference reception compared to single-user MIMO scheduling (hereafter, also referred to as SU-MIMO scheduling). Since single-user MIMO scheduling is in a situation where a single UE receives multiple layers, interference control may be relatively easy because the UE knows all the information about the interlayer interference signals it receives, including information about the channels, precoders, demodulation signals, and DMRS ports between the base station and the UE. On the other hand, inter-UE interference signals generated during MU-MIMO scheduling are generated from precoders used by other UEs and demodulated signals transmitted to other UEs, and thus the i-th UE may not have the relevant information as described above.

Therefore, when the i-th UE is subject to MU-MIMO scheduling with other UEs, the UE may perform signal detection with appropriate complexity even with an R-ML receiver if the i-th UE may use an R-ML receiver and know at least the DMRS sequence and demodulation scheme of the other UEs subject to MU-MIMO scheduling.

To this end, the UE may receive additional information associated with MU-MIMO scheduling from the base station via DCI. The corresponding field may be called, for example, MU-MIMO assist signaling field, may be 3 bits, and may have 8 codepoints defined as shown in Table 32 below. The details corresponding to each codepoint in Table 32 below are only an example.

TABLE 32

| Bit field | |
|---|---|
| mapped | |
| to index | Content |
| 0 | No co-scheduled UE(s) which has same DMRS sequence as |
| | target UE exists |
| 1 | In all the PRBs allocated to the target UE, all the co-scheduled |
| | UE(s), which hasthe same DMRS sequence as the target UE, |
| | have QPSK scheduled |
| 2 | In all the PRBs allocated to the target UE, all the co-scheduled |
| | UE(s), which has the same DMRS sequence as the target UE, |
| | have 16QAM scheduled |
| 3 | In all the PRBs allocated to the target UE, all the co-scheduled |
| | UE(s), which has the same DMRS sequence as the target UE, |
| | have 64QAM scheduled |
| 4 | In all the PRBs allocated to the target UE, all the co-scheduled |
| | UE(s), which has the same DMRS sequence as the target UE, |
| | have 256QAM scheduled |
| 5 | In all the PRBs allocated to the target UE, all the co-scheduled |
| | UE(s), which has the same DMRS sequence as the target UE, |
| | have 1024QAM scheduled |
| 6 | Not covered by cases corresponding to index 0~5. In each |
| | individual PRB allocated to the target UE, the following |
| | condition is satisfied: |
| | Only single modulation order is allocated for the co-scheduled |
| | UE(s) which hasthe same DMRS sequence as the target UE, |
| | if the co-scheduled UE(s) exists |
| 7 | Others |

As described above, when a UE is to detect inter-UE interference based on the R-ML receiver during MU-MIMO scheduling to improve the detection performance for the signals that the corresponding UE is to receive, information about the DMRS sequence and demodulation scheme may be helpful, and each of the eight codepoints in Table 32 above may signify that how much information the base station needs from the R-ML receiver to be used by the UE when scheduling MU-MIMO including the UE.
An index (codepoint) of 0 in the MU-MIMO assist signaling field may signify that there is no UE having the same DMRS sequence as the corresponding UE among other UEs subject to MU-MIMO scheduling with the corresponding UE, and this may also include the case of SU-MIMO scheduling rather than the MU-MIMO scheduling. The DMRS sequence may be understood as the case where the r(n) of the above DMRS sequence is the same, but it is not limited thereto. In other words, when the UE receives an index of 0 in the MU-MIMO assist signaling field via DCI, the UE may assume that it is not in MU-MIMO scheduling (i.e., SU-MIMO scheduling, single user MIMO scheduling, or no UEs are scheduled together for the same time and frequency resource) or that no other UEs are using the same DMRS sequence as the corresponding UE even if it is in MU-MIMO scheduling.
In case that the corresponding field indicates index 0, the UE may consider to meaning that there is no need to use the R-ML receiver when receiving a signal transmitted from the base station.
Indices (codepoints) 1 to 5 of the MU-MIMO assist signaling field may signify that UEs subject to MU-MIMO scheduling with the corresponding UE use the same DMRS sequence in all RBs assigned to the corresponding UE and use QPSK, 16QAM, 64QAM, 256QAM or 1024QAM as the demodulation scheme for PDSCH. In other words, indices (codepoints) 1 to 5 of the MU-MMO assist signaling field may provide information about the DMRS sequence and demodulation scheme of the other UEs required to use the R-ML receiver. In the case of the DMRS sequence, by providing an indication that the other UE uses the same DMRS sequence as the corresponding UE, rather than providing the DMRS sequence itself of the other UEs, the corresponding UE may reduce the complexity of channel estimation by reusing the DMRS sequence used by the other UE when the UE is to estimate channel information for the other UE for ports other than the DMRS port for which the UE is scheduled. For demodulation schemes, it may be assumed that all other UEs use the same specific demodulation scheme.
In case that the UE receives indices 1 to 5, the UE may know the DMRS sequence information of other UEs that are subject to MU-MIMO scheduling with the corresponding UE, and thus in the case of the DMRS channel information required in Equation 5 above, the UE may use the DMRS sequence to estimate the channel with respect to DMRS ports that are not scheduled by the corresponding UE. In this case, the demodulation scheme of the corresponding UE may be the same as other UEs. For example, when a specific UE receives an index of 1 for the MU-MIMO assist signaling field, the demodulation scheme of the corresponding UE and other UEs that are subject to MU-MIMO scheduling with the corresponding UE may be assumed to be QPSK. In other cases, there may be no constraint on the corresponding UE's demodulation scheme being the same or different from the other UEs. For example, when a specific UE receives an index of 1 for the MU-MIMO assist signaling field, it may be assumed that the demodulation scheme of other UEs subject to MU-MIMO scheduling with the corresponding UE is QPSK, but there is no constraint that the demodulation scheme of the UE should be QPSK or non-QPSK.
Index (codepoint) 6 of the MU-MIMO assist signaling field may signify the case in which indexes 0 to 5 are not included. In case that index 6 is indicated to the UE via the corresponding field, if there is a UE subject to MU-MIMO scheduling, the corresponding UE may expect all other UEs subject to MU-MIMO scheduling to use a single and identical demodulation scheme for each RB (or RBG, or PRG) scheduled for the corresponding UE, and to use the same DMRS sequence as the corresponding UE. In this case, a specific demodulation scheme of all other UEs subject to MU-MIMO scheduling may not be indicated.
Index (codepoint) 7 of the MU-MIMO assist signaling field may signify the case in which indexes 0 to 6 are not included. In case that index 7 is indicated to the UE via the corresponding field, if there is a UE subject to MU-MIMO scheduling, there may be no restriction on whether other UEs subject to scheduling with the corresponding UE use the same DMRS sequence as the corresponding UE or whether the other UEs all use the same single demodulation scheme. Accordingly, when the corresponding UE is to use an R-ML receiver for all other UEs subject to MU-MIMO scheduling to control interference and detect the corresponding UE's desired signal, it may be possible for the UE to blindly apply to the DMRS sequences and demodulation schemes of other UEs subject to scheduling with the corresponding UE. In other words, the corresponding UE may attempt to detect the UE's desired signal under various assumptions about the DMRS sequences and demodulation schemes of the other UEs subject to scheduling with the corresponding UE.

The UE may report, to the base station, a single UE capability meaning that it is capable of using the R-ML receiver and receiving the MU-MIMO assist signaling field from the base station. The corresponding UE capability may be defined using at least one of the following criteria.
The UE may report to the base station that it is capable of supporting all indices (codepoints) of the MU-MIMO assist signaling field through a single UE capability.
The UE may indicate whether each index of the MU-MIMO assist signaling field is supported, through different UE capabilities.
For example, a UE may separately report to the base station a UE capability meaning that it supports indexes 1 to 5, a UE capability meaning that it supports up to index 6 including indexes 1 to 5, and a UE capability meaning that it supports up to index 7 including indexes 1 to 6.
Even if the UE reports a UE capability meaning that it supports indices 1 to 5, a UE capability meaning that it supports up to 6 including indices 1 to 5, or a UE capability meaning that it supports up to index 7 including indices 1 to 6, when the UE does not report a PDSCH 256QAM-supportable UE capability or a PDSCH 1024QAM-supportable UE capability, the UE does not expect to receive index 4 or 5 indicated from the base station, or even if the UE has received index 4 or 5 indicated, the UE may consider the same as a reserved codepoint or may ignore the same. Furthermore, even if the UE receives an index 6 from the base station, the UE may expect all other UEs subject to MU-MIMO scheduling to use a single and identical demodulation scheme for each scheduled RB (or may be per RBG, per PRG), which may exclude 256QAM or 1024QAM from the possible demodulation schemes. In this case, the base station may not instruct the UE to use index 4 or 5.
The UE may report whether to support the MU-MIMO assist signaling field, based on the DMRS type or PDSCH mapping type via a separate UE capability when reporting the corresponding UE capability, or in the form of different components within the same UE capability. For example, the UE may report whether to support the MU-MIMO assist signaling field in the manner described above for at least one of DMRS type 1, DMRS type 2, enhanced DMRS type 1, or enhanced DMRS type 2. Alternatively/or in an example, the UE may report whether to support the MU-MIMO assist signaling field in the manner described above for at least one of PDSCH mapping type A or B.
Alternatively, the UE may report whether to support the MU-MIMO assist signaling field via a UE capability regardless of DMRS type or PDSCH mapping type when reporting the corresponding UE capability.
The UE may report a separate UE capability to the base station for each DCI format in which the MU-MIMO assist signaling field may exist when reporting the corresponding UE capability. For example, a UE may separately report the UE capability for the presence or absence of the corresponding field in DCI format 1_1 and the UE capability for the presence or absence of the corresponding field in DCI format 1_2.
Alternatively, the UE may report, to the base station, a UE capability that is common to all DCI formats in which the MU-MIMO assist signaling field may exist when reporting the corresponding UE capability. The base station having received the UE capability may include the corresponding field with respect to all DCI formats supportable by the corresponding UE. Alternatively, the UE may report to the base station by including, in the UE capability, information about DCI formats that the corresponding field may support.

In case that the UE has reported the above UE capability to the base station, the base station may configure, in the UE, higher layer signaling indicating the presence of the MU-MIMO assist signaling field in the DCI. The corresponding higher layer signaling may be defined using at least one of the following criteria.
The UE may receive a configuration of the corresponding higher layer signaling for each cell.
The UE may receive a configuration of the corresponding higher layer signaling for each bandwidth part. Accordingly, there may be a bandwidth part in which the corresponding higher layer signaling exists and a bandwidth part in which the corresponding higher layer signaling does not exist.
In case that the UE performs a bandwidth part (BWP) switching from a bandwidth part in which the corresponding higher layer signaling is configured to a bandwidth part in which the corresponding higher layer signaling is not configured, the UE may ignore the corresponding field because the UE takes the switched bandwidth part into account when interpreting the received DCI.

In case that the UE performs a BWP switching from a bandwidth part in which the corresponding higher layer signaling is not configured to a bandwidth part in which the corresponding higher layer signaling is configured, the UE takes the switched bandwidth part into account when interpreting the received DCI and may interpret the bits in the corresponding field as all zeros or ignore them.
The UE may receive a configuration of the corresponding higher layer signaling individually according to different DMRS types or PDSCH mapping types.
In case that at least one of the entries in the TDRA field indicated by the UE through DCI includes a DMRS type or PDSCH mapping type for which the corresponding higher layer signaling is configured, the UE may assume that the corresponding field exists in the DCI. If the entry in the TDRA field indicated by the UE through the DCI indicates the DMRS type or PDSCH mapping type for which the corresponding higher layer signaling is configured (e.g., for DMRS type 1 or PDSCH mapping type A), the UE may interpret each codepoint in the MU-MIMO assist signaling field as described above. If the entry in the TDRA field indicated by the UE through DCI does not indicate the DMRS type or PDSCH mapping type for which the corresponding higher layer signaling is configured (e.g., for DMRS type 1 or PDSCH mapping type A), the UE may expect the base station to indicate the MU-MIMO assist signaling field as index 0, may ignore the field without interpretation, may consider the field to be a reserved value no matter what value it has, or may interpret by replacing the corresponding field by the number of additional bits for other fields that are missing codepoints (for example, an antenna port field, etc.).
The UE receive a configuration from the base station such that the corresponding higher layer signaling is commonly applied to different DMRS types or PDSCH mapping types. In other words, the UE may expect, through a single higher layer signaling parameter, that the above MU-MIMO assist signaling field is commonly applied to the different DMRS types or PDSCH mapping types, the configurations of which are received by the UE via higher layer signaling.
The UE may receive different higher layer signaling configurations according to different DCI formats. For example, the UE may receive a configuration of higher layer signaling, which indicates the presence of a MU-MIMO assist signaling field for DCI formats 1_1, 1_2, 1_3, 4_1, or 4_2, via individual parameters for each DCI format.
The UE may receive the corresponding higher layer signaling configured to be common for different DCI formats. In other words, the UE may receive a single higher layer signaling configured and expect the corresponding field to exist in all downlink DCI formats that the UE can support via the corresponding higher layer signaling (e.g., DCI formats 1_0, 1_1, 1_2, 1_3, 4_0, 4_1, 4_2), or may expect that the corresponding field to exist only for a specific downlink DCI format that the UE supports (e.g., DCI format 1_1 or 1_2).

The UE may consider at least one of the following criteria for the DCI format in which the MU-MIMO assist signaling field may exist.
The UE may expect that the above MU-MIMO assist signaling field exists for at least one of the DCI formats 1_1, 1_2, 1_3, 4_0, 4_1 and 4_2.
The UE may expect the above MU-MIMO assist signaling field to exist only in DCI format 1_1.
In case that the MU-MIMO assist signaling field exists in DCI format 1_2, the UE may expect that the MU-MIMO assist signaling field has the same field size as the field existing in DCI format 1_1 as expressed in Table 32 above, and each codepoint may have the same meaning as in the case of [Table 32].
In case that the MU-MIMO assist signaling field exists in DCI format 1_2, the UE may configure the MU-MIMO assist signaling field based on a part or all of the total of eight codepoints expressed in Table 32 above and the corresponding field may have a length of 0, 1, 2 or 3 bits.
In case that the corresponding field has a length of 1 bit, the UE may indicate two codepoints through the corresponding field, the first codepoint may have the same meaning as index 0 in Table 32 above and the second codepoint may differ according to the UE capability reported by the UE to the base station.
In case that the UE reports a UE capability for which indices 1 to 5 in Table 32 above are possible, the UE may consider at least one of the following.
In case that the second codepoint is considered as meaning one of indices 1 to 5, the UE may be notified of one of indices 1 to 5 as the second codepoint from the base station through a combination of at least one of higher layer signaling, MAC-CE, and L1 signaling, or may follow details fixedly defined in the specification.
In another method, the second codepoint may be defined by a combination of at least one of indices 1 to 5. For example, indices 1 and 2 may be combined to define the second codepoint, where the meaning of the codepoint may be that, from the corresponding UE's perspective, the other UEs subject to MU-MIMO scheduling all have the same demodulation scheme, either QPSK or 16QAM, or that some of the other UEs may use QPSK and the other UEs may use 16QAM. The combination of indices 1 and 2 in this manner is an example of defining a single codepoint, and a case in which specific multiple indices among indices 1 to 5 may be combined in the above manner to define a single codepoint is not excluded. In this case, when multiple indices are combined to define a single codepoint, indices 3, 4 or 5 may be excluded from the combination because the number of possible cases of demodulated symbols resulting from this demodulation scheme may be very large compared to indices 1 and 2.
In case that the UE has reported a UE capability indicating that index 6 as well as indices 1 to 5 in Table 32 is possible, the UE may consider that the second codepoint signifies index 6 in Table 32, or the second codepoint signifies one of indices 1 to 5.
In case that the second codepoint is considered to signify one of indices 1 to 5, the UE may be notified of one of indices 1 to 5 as the second codepoint from the base station through a combination of at least one of higher layer signaling, MAC-CE, and L1 signaling, or may follow details fixedly defined in the specification.
In another method, the second codepoint may be defined by a combination of at least one of indices 1 to 5. For example, indices 1 and 2 may be combined to define the second codepoint, where the meaning of the codepoint may be that, from the corresponding UE's perspective, the other UEs subject to MU-MIMO scheduling all have the same demodulation scheme, either QPSK or 16QAM, or that some of the other UEs may use QPSK and the other UEs may use 16QAM. As such, this combination of indices 1 and 2 is an example, and a case in which specific multiple indices among indices 1 to 5 may be combined in the above manner to define a single codepoint is not excluded. In this case, when multiple indices are combined to define a single codepoint, indices 3, 4 or 5 may be excluded from the combination because the number of possible cases of demodulated symbols resulting from this demodulation scheme may be very large compared to indices 1 and 2.
In case that the UE has reported a UE capability indicating that index 7 as well as indices 1 to 6 in Table 32 are possible, the UE may consider that the second codepoint signifies index 7 in Table 32.
In case that the UE has reported to the base station its UE capability meaning that it is capable of supporting the R-ML receiver and capable of supporting the MU-MIMO assist signaling field regardless of the index in Table 32 above, the UE may configure the first and second codepoints using one or more combinations of the above details on a method of configuring the codepoints when the field has a length of 1 bit.
If the corresponding field has a length of 2 bits, the UE may indicate four codepoints through the corresponding field, where the first codepoint may have the same meaning as index 0 in Table 32 above and the second to fourth codepoints may differ according to the UE capabilities reported by the UE to the base station.
In case that the UE has reported a UE capability where indices 1 to 5 in Table 32 above are possible, the UE may consider at least one of the following.
In case that the UE considers that the second to fourth codepoints refer to three of the indices 1 to 5, the UE may receive notification of three of the indices 1 to 5 as the second to fourth codepoints from the base station via a combination of at least one of higher layer signaling, MAC CE, L1 signaling or may follow details fixedly specified in the specification. In this case, when the UE is not capable of supporting PDSCH 256QAM and PDSCH 1024QAM as described above, i.e., when the UE capability for both demodulation schemes is not reported, the UE may assume that the second to fourth codepoints refer to indices 1, 2, and 3 respectively.
In another method, the second to fourth codepoints may be defined by a combination of at least one of the indices 1 to 5. For example, indices 1 and 2 may be combined to define a second codepoint, where the meaning of the codepoint may be that, from the UE's perspective, all other UEs subject to MU-MIMO scheduling have the same demodulation scheme, either QPSK or 16QAM, or that some of all other UEs may use QPSK and others may use 16QAM. The combination of indices 1 and 2 in this manner is an example of defining a single codepoint, and a case in which specific multiple indices among indices 1 to 5 may be combined in the above manner to define a single codepoint is not excluded. In this case, when multiple indices are combined to define a single codepoint, indices 3, 4 or 5 may be excluded from the combination because the number of possible cases of demodulated symbols resulting from this demodulation scheme may be very large compared to indices 1 and 2.
In case that the UE has reported a UE capability indicating that index 6 as well as indices 1 to 5 in Table 32 above is possible, the UE may consider the meaning of the second to fourth codepoints as follows.
In case that the UE considers that the second to fourth codepoints refer to three of the indices 1 to 6, the UE may receive notification of three of the indices 1 to 6 as the second to fourth codepoints from the base station via a combination of at least one of higher layer signaling, MAC CE, L1 signaling or may follow details fixedly specified in the specification. In this case, when the UE is not capable of supporting PDSCH 256QAM and PDSCH 1024QAM as described above, i.e., when the UE capability for both demodulation schemes is not reported, the UE may assume that the second to fourth codepoints refer to indices 1, 2, and 3 respectively. In another method, the second to fourth codepoints may be defined by a combination of at least one of the indices 1 to 5. For example, indices 1 and 2 may be combined to define a second codepoint, where the meaning of the codepoint may be that, from the UE's perspective, all other UEs subject to MU-MIMO scheduling have the same demodulation scheme, either QPSK or 16QAM, or that some of all other UEs may use QPSK and others may use 16QAM. The combination of indices 1 and 2 in this manner is an example, and a case in which specific multiple indices among indices 1 to 5 may be combined in the above manner to define a single codepoint is not excluded. In this case, when multiple indices are combined to define a single codepoint, indices 3, 4 or 5 may be excluded from the combination because the number of possible cases of demodulated symbols resulting from this demodulation scheme may be very large compared to indices 1 and 2.
In case that the second to fourth codepoints signify one of the indices 1 to 6 or are determined by a combination of the indices 1 to 5 and index 6, the UE may define the fourth codepoint as having index 6, and the remaining second and third codepoints may be configured using methods provided that the corresponding fields have a length of 2 bits.
In case that the UE has reported UE capability indicating that index 7 as well as indexes 1 to 6 in Table 32 above is possible, at least one of indexes 1 to 5, index 6, and index 7 may be indicated or defined as the second to fourth codepoints according to the method described above, or may be selected by the UE and multiple indexes 1 to 5 may be combined to form a single codepoint as described above. In another method, the UE may fix the fourth codepoint as index 7, and the remaining second and third codepoints may be indicated or defined by at least one of indices 1 to 5 and index 6, selected by the UE, or may be configured using the method by which the multiple indices are combined described above.
In case that the UE has reported to the base station its UE capability meaning that it is capable of supporting the R-ML receiver and capable of supporting the MU-MIMO assist signaling field regardless of the index in Table 32 above, the UE may configure the first to fourth codepoints using one or more combinations of the above details on a method of configuring the codepoints when the field has a length of 2 bits.
If the corresponding field has a length of 3 bits, the UE may expect that the MU-MIMO assist signaling field existing in DCI format 1_2 also has the same size and the same meaning of each codepoint as the corresponding field existing in DCI format 1_1, as expressed in Table 32 above.
In case that the MU-MIMO assist signaling field exists in DCI format 1_3, the UE may configure the MU-MIMO assist signaling field based on some or all of the total of eight codepoints expressed in Table 32 above, where the specific field configuration and the meaning of each codepoint may consider at least one of the following. DCI format 1_3 may be interchangeable with MC-DCI as described later.
[Field type 1 in MC-DCI] The UE may expect one MU-MIMO assist signaling field with a length of 0 to 3 bits to be included in the MC-DCI. Furthermore, the UE may consider that if one MU-MIMO assist signaling field is defined within the MC-DCI, the MU-MIMO assist signaling indicated by the corresponding one field is applied equally within a specific BWP within one or more specific cells scheduled via the MC-DCI. In case that the MU-MIMO assist signaling field has a length of 0 to 3 bits, the UE may consider the definition of each codepoint in the corresponding field in a similar manner as described above.
[Field type 2 in MC-DCI] The UE may expect one MU-MIMO assist signaling field with a length of 0 to 3 bits to be included in the MC-DCI, where each codepoint in the corresponding MU-MIMO assist signaling field may include MU-MIMO assist signaling information for each cell that may be scheduled via the MC-DCI. The information indicated by each codepoint may exist in the form of a list of MU-MIMO assist signaling indications, one or more lists configured may be received by the UE via higher layer signaling from the base station. For example, MU-MIMO assist signaling list 1, which is a list of MU-MIMO assist signaling indications corresponding to a specific codepoint, may have the form such as {index1, index1, index1, index5}, wherein the list may have a meaning to indicate index 1 in Table 32 above via the MU-MIMO assist signaling field for the first to third cells that may be scheduled via MC-DCI, and to indicate index 5 for the fourth cell. Within the above MU-MIMO assist signaling list, the information for a particular cell may be defined by a combination of at least one of the indices 1 to 5 as described above.
[Field type 3 in MC-DCI] The UE may expect one MU-MIMO assist signaling field with a length of 0 to 3 bits to be included in the MC-DCI, where the MU-MIMO assist signaling information in a BWP within a specific cell to be scheduled via the MC-DCI may be indicated via the corresponding MU-MIMO assist signaling field. The specific cell may be the first cell among all cells scheduled via the MC-DCI, the last cell, or a cell with a specific index according to the higher layer signaling, the configuration of which is received by the UE from the base station. In this case, there may be more than one cell of a specific index according to the higher layer signaling. When the MU-MIMO assist signaling field has a length of 0 to 3 bits, the UE may consider the definition of each codepoint in the corresponding field similarly to the methods described above.
The UE may expect a MU-MIMO assist signaling field of the maximum of 12 bits length to be included within the MC-DCI, and a specific bit portion of the corresponding MU-MIMO assist signaling field may indicate the MU-MIMO assist signaling for each cell that may be scheduled via the MC-DCI. For example, the MU-MIMO assist signaling field in the MC-DCI may be defined as 12 bits, cells schedulable via the MC-DCI may each be applied with 3 bits, and the meaning of codepoints each expressible by 3 bits may be considered in a similar manner as described above.
[Field type 4 in MC-DCI] The UE may expect the MC-DCI to include multiple MU-MIMO assist signaling fields, each having a length of 0 to 3 bits, where each MU-MIMO assist signaling field may indicate MU-MIMO assist signaling for each cell that may be scheduled via MC-DCI. Each MU-MIMO assist signaling field has a length of 0 to 3 bits, the UE may consider the definition of each codepoint in the corresponding field in a similar manner to the methods described above.
[Field type 5 in MC-DCI] The UE may determine the type of the MU-MIMO assist signaling field in MC-DCI by using a method of configuring, via higher layer signaling, one of some or all of [Field type1 in MC-DCI] to [Field type4 in MC-DCI] described above. For example, the UE may receive from the base station the configuration of one of [field type1 in MC-DCI] and [field type4 in MC-DCI] via higher layer signaling, and the type of the MU-MIMO assist signaling field in MC-DCI may be determined accordingly.
In case that the MU-MIMO assist signaling field exists in the DCI format 4_0, 4_1 or 4_2, the UE may configure the MU-MIMO assist signaling field based on some or all of a total of 8 codepoints expressed in Table 32 above, and the corresponding field may have a length of 0, 1, 2 or 3 bits and may be the same as the field configuration defined in DCI format 1_2 above.
In case that the MU-MIMO assist signaling field exists in the DCI format 4_0, 4_1 or 4_2, the UE may configure the MU-MIMO assist signaling field based on a total of 8 codepoints as expressed in Table 32 above, and the corresponding field may have a length of 3 bits and may be the same as the field configuration defined in the DCI format 1_1 above.

Under the conditions described above (e.g., when the UE has received, from the base station, higher layer signaling indicating the presence of the MU-MIMO assist signaling field), the UE may expect the MU-MIMO assist signaling field to exist at a specific location in the DCI format and may determine the specific location by considering at least one of the following.
According to one method, the UE may know a DMRS port assigned to the corresponding UE by interpreting the antenna port field, and may identify, by interpreting the antenna port field (if the antenna port field indicates DMRS port assignments capable of MU-MIMO scheduling), the presence or absence of a UE scheduled together by the MU-MIMO method at the same time and frequency as the corresponding UE, and thus MU-MIMO assist signaling may exist after the antenna port field.
If there are UEs that may be scheduled together, i.e., in the case of DMRS port assignments capable of MU-MIMO scheduling, the UE may estimate a modified channel to which another UE's precoder is applied, in an orthogonal DMRS port in addition to the assigned DMRS port. Therefore, in the case of DCI formats 1_1, 1_2, 1_3, 4_0, 4_1, and 4_2, the UE may expect the MU-MIMO assist signaling field to exist after the antenna port field. The specific location of the MU-MIMO assist signaling field may be possible between the antenna port field and the transmission configuration indication field, or between the transmission configuration indication field and the SRS request field.
If there are no UEs that may be scheduled together, i.e., the UE is assigned a DMRS port that is not capable of MU-MIMO scheduling (e.g., entry #11 in Table 18, Table 19, Table 20, and Table 21 above, which may indicate DMRS ports 1000 and 1002 for DMRS type 1), the UE may ignore MU-MIMO assist signaling fields that may exist after the antenna port field, or may expect to receive index #0 indicated.
According to another method, when a DMRS sequence initialization field exists in a specific DCI format, the UE may know DMRS sequence through a scrambling ID indicated through the DMRS sequence initialization field, and channel estimation for the PDSCH DMRS will be possible based on the DMRS sequence information, and thus the UE may expect that the MU-MIMO assist signaling field exists after the DMRS sequence initialization field. The specific location of the MU-MIMO assist signaling field may be immediately after the DMRS sequence initialization field, or may be after the PUCCH cell indicator field, which is the last of DCI formats 1_1 and 1_2.
The UE may determine the location of the MU-MIMO assist signaling field in a similar method as described above, even in case that the MU-MIMO assist signaling field exists in the DCI formats 1_3, 4_0, 4_1, and 4_2.

In case that the UE supports low peak-to-average power ratio (PAPR) RS for PDSCH and has received, from the base station, the higher layer signaling dmrs-Downlink-r16 configured as enabled, the UE may use different DMRS sequences for each CDM group by using different DMRS scrambling IDs for each CDM group, and the same DMRS sequence may be used for different DMRS ports within a CDM group based on the same DMRS scrambling ID. In this regard, the expression “same DMRS sequence” in the above Table 32 may be replaced by the expression “same DMRS scrambling ID”. In this case, the UE may expect to have the same value configured for the higher layer signaling dmrs-Downlink-r16 as other UEs subject to MU-MIMO scheduling. Alternatively, all UEs subject to MU-MIMO scheduling including the corresponding UE may have the higher layer signaling dmrs-Downlink-r16 configured as enabled or may not have dmrs-Downlink-r16 configured.

In case that the UE has received an indication of the MU-MIMO assist signaling field from the base station via DCI and is subject to MU-MIMO scheduling with other UEs, the UE may expect to receive the same value of the number of CDM groups without data (via the antenna port field) as all other UEs subject to MU-MIMO scheduling. In other words, the UE may receive PDSCH transmissions from the base station assuming the same value of energy or power ratio between PDSCH RE and DMRS RE as all other UEs subject to MU-MIMO scheduling. The above assumption may be implicitly applied when the UE is subject to MU-MIMO scheduling and receives signals from the base station, or may be explicitly stated in a sentence expressing the meaning of each index in Table 32 above, so that the UE may or may not receive an indication of the corresponding information.

According to another example, a UE may transfer, to a base station, a UE capability having a meaning that when the UE is subject to MU-MIMO scheduling with other UEs, the UE may allow the energy or power ratio between the PDSCH RE and DMRS RE to be different from other UEs. The UE may subject to MU-MIMO scheduling with other UEs that have reported their UE capabilities to the base station, which may be understood to mean that the same or different PDSCH RE-to-DMRS RE energy or power ratio are allowed among multiple UEs that are subject to MU-MIMO scheduling. In addition, UEs that do not report their UE capabilities may be MU-MIMO scheduled with UEs that do not report their UE capabilities, and this may be understood to mean that all UEs subject to MU-MIMO scheduling are instructed to have the same PDSCH RE-to-DMRS RE energy or power ratio. Among UEs that have not reported corresponding UE capabilities and UEs that have reported their UE capabilities, UEs that have the same PDSCH RE-to-DMRS RE energy or power ratio are capable of MU-MIMO scheduling, otherwise MU-MIMO scheduling may not be possible.

For example, in case that the first and second UEs have transferred, to the base station, their UE capabilities which signifies that they may allow different energy or power ratios between PDSCH RE and DMRS RE when MU-MIMO scheduling with other UEs and the third and fourth UEs have not transferred their UE capabilities to the base station, and that the first to fourth UEs all have DMRS type 1 configurations and the energy or power ratio of DMRS RE to PDSCH RE of the first to fourth UEs is 0 dB, 3 dB, 3 dB, 3 dB, and 3 dB, respectively, since the first and second UEs have both reported their respective UE capabilities, MU-MIMO scheduling is possible. The third and fourth UEs do not report their respective UE capabilities, and thus MU-MIMO scheduling is possible. The first UE that has reported the corresponding UE capability and the third UE that has not reported the corresponding UE capability have different energy or power ratios of DMRS RE to PDSCH RE, and thus MU-MIMO scheduling is not possible. The second UE that has reported the corresponding UE capability and the fourth UE that has not reported the corresponding UE capability have the same energy or power ratio of DMRS RE to PDSCH RE, and thus MU-MIMO scheduling may be possible.

### Second Embodiment: DMRS Sequence to Support Multi-User Scheduling and OCC Deactivation

An embodiment of the disclosure describes DMRS sequences and OCC deactivation related operations, which are additionally definable, when a UE may receive multi-user scheduling support signaling indicated from a base station. This embodiment may operate in combination with other embodiments.

When a UE has the higher layer signaling dmrs-FD-OCC-disableForRank1PDSCH configured, and the UE is assigned one DMRS port for PDSCH scheduling, the UE may not expect that a DMRS port using a different FD-OCC among other orthogonal DMRS ports belonging to the same CDM group as the assigned one DMRS port is assigned to another UE. This may be done such that for the CDM group including the DMRS port assigned to the corresponding UE, channel estimation is not to be performed by applying OCC despreading to at least two adjacent DMRS REs, and channel estimation is able to be performed without OCC despreading by not assigning other UEs to other orthogonal ports within the corresponding CDM group. With respect to the relationship between this OCC despreading operation and the operation associated with the MU-MIMO assist signaling field described in the first embodiment above, the UE may operate based on at least one of the following.
[OCC despreading related operation 1] The UE may not expect that the above higher layer signaling, which implies the presence of the MU-MIMO assist signaling field, and the higher layer signaling dmrs-FD-OCC-disableForRank1PDSCH are configured together. The UE may expect one of two parameters to be configured or may expect neither parameter to be configured, but may not expect both parameters to be configured. The base station may exclude the case of configuring both parameters for the UE, may configure only one of the two parameters, or may not configure both parameters.
[OCC despreading related operation 2] The UE may receive a configuration of the higher layer signaling indicating the presence of the MU-MIMO assist signaling field together with the higher layer signaling dmrs-FD-OCC-disableForRank1PDSCH, and if the two UE operations overlap, the UE may operate in a combination of at least one of the following.
When the UE receives an indication of a DMRS port via the antenna port field (i.e., while receiving rank-1 scheduling), the UE may expect the MU-MIMO assist signaling field to indicate index 0, or the UE may ignore the corresponding field regardless of the index that the base station indicates via the MU-MIMO assist signaling field.
According to another method, in case that a UE receives index 0 indicated via the MU-MIMO assist signaling field while receiving one DMRS port indicated via the antenna port field (i.e., while receiving rank-1 scheduling), the UE may expect that, within the CDM group that includes the indicated DMRS port, no other UE that is subject to MU-MIMO scheduling is assigned an orthogonal DMRS port other than the indicated DMRS port. In case that the UE receives an index other than index 0 indicated via the MU-MIMO assist signaling field while receiving one DMRS port indicated via the antenna port field (i.e., while receiving rank-1 scheduling), the UE may assume that there may be other UEs subject to MU-MIMO scheduling assigned orthogonal DMRS ports other than the indicated DMRS port within the CDM group including the indicated DMRS port without performing the OCC disable operation, even though it is rank-1 scheduling. In case that the UE receives two or more DMRS ports indicated via the antenna port field (i.e., receives rank-2 scheduling), the UE may expect the MU-MIMO assist signaling field to indicate one of all indices and not perform the OCC disable operation. In other words, the UE may or may not perform the OCC disable function depending on the number of DMRS ports the UE receives via the antenna port field and the index indicated via the MU-MIMO assist signaling field.
[OCC despreading related operation 3] The UE may receive both the configuration of the higher layer signaling and the higher layer signaling dmrs-FD-OCC-disableForRank1PDSCH indicating the presence of the MU-MIMO assist signaling field. In this case, the UE may perform the OCC disable operation within the CDM group including the one DMRS port indicated, regardless of the index indicated via the MU-MIMO assist signaling field when receiving rank-1 scheduling. The UE may expect that there is one DMRS port indicated via the antenna port field in the DCI, and that no UEs scheduled together in MU-MIMO scheme within the CDM group including the corresponding DMRS port. Further, the UE may assume that there may or may not be UEs scheduled together in MU-MIMO scheme within other CDM groups. In addition, when there are two or more DMRS ports indicated via the antenna port field in the DCI, the UE may assume that UEs scheduled in the MU-MIMO scheme may exist or not on other orthogonal DMRS ports in the CDM group including the indicated DMRS port, or on all DMRS ports in another CDM group that does not include the indicated DMRS port. In this case, when the UE receives an indication of a value of an index other than index 0 via the MU-MIMO assist signaling field while receiving rank-1 scheduling, the UE may assume that no other UE is scheduled to use the remaining orthogonal DMRS ports other than the DMRS port received by the corresponding UE in the CDM group including the indicated DMRS port, and thus the complexity of using the R-ML receiver can be reduced.

The UE may receive scrambling ID0 and/or scrambling ID1 configured via higher layer signaling, and if there is a DMRS sequence initialization field in DCI format, the UE may receive one of the scrambling ID0 and scrambling ID1 indicated via the one bit field. In case that the UE uses an R-ML receiver, i.e., when the UE is able to receive the indicated MU-MIMO assist signaling field, the UE may need to use the same DMRS sequence as other UEs to estimate a modified channel obtained by multiplying the corresponding UE and other UEs' precoders, and therefore an additional scrambling ID in addition to the two scrambling ID0 and scrambling ID1 may be required to control such MU-MIMO scheduling interference.

Thus, when the UE reports the UE capability to the base station via one of the various methods mentioned in the first embodiment above so that the UE receives the higher layer signaling configured from the base station and there is MU-MIMO assist signaling field in the DCI format, the UE may be configured with one or two scrambling IDs in addition to the scrambling ID0 and scrambling ID1. In this case, when receiving the DMRS sequence indicated from the base station, the UE may use a method for a combination of at least one of the following.
[DMRS sequence use method 1] In case that a MU-MIMO assist signaling field exists in DCI, i.e., the UE has received a configuration of higher layer signaling indicating the presence or absence of the MU-MIMO assist signaling field, the UE may expect the DMRS sequence initialization field to be defined as a maximum of 2 bits and accordingly, the UE may receive, in order to operate four codepoints, the DMRS scrambling ID of ID2 and/or ID3 configured via the higher layer signaling in addition to the existing ID0 and ID1, wherein the four codepoints in the DMRS sequence initialization field, which may be defined as the maximum of two bits, may signify the DMRS scrambling ID0, ID1, ID2 and ID3, respectively.
[DMRS sequence use method 2] In case that a MU-MIMO assist signaling field exists in DCI, i.e., the UE has received a configuration of higher layer signaling indicating the presence or absence of the MU-MIMO assist signaling field, the UE may expect the DMRS sequence initialization field to be defined as a maximum of one bit as before, and the meaning of the two codepoints expressible by one bit in the DMRS sequence initialization field may change depending on which index the MU-MIMO assist signaling field indicates. For example, when the MU-MIMO assist signaling field indicates an index of 0 and thus the UE is not in a MU-MIMO scheduling situation or does not need to use an R-ML receiver, the UE may consider that each codepoint indicates one of the higher layer signaling DMRS scrambling ID0 and ID1 when interpreting the 1-bit DMRS sequence initialization field.

As another example, when the MU-MIMO assist signaling field indicates a non-zero index such that specific information is indicated to allow the UE to use the R-ML receiver in a MU-MIMO scheduling situation, the UE may consider that each codepoint indicates one of ID2 and ID3 rather than the higher layer DMRS scrambling ID0 and ID1 when interpreting the 1-bit DMRS sequence initialization field. In this case, the meaning of some or all of the first and second codepoints in the DMRS sequence initialization field may change depending on whether only one or both of ID2 and ID3 are configured. For example, when the UE has configured with ID2 in addition to DMRS scrambling ID0 and ID1, the UE may interpret the meaning of the first codepoint of the DMRS sequence initialization field as either DMRS scrambling ID0 or ID2, depending on whether the MU-MIMO assist signaling field indicates index 0 or another index. However, the meaning of the second codepoint of the DMRS sequence initialization field may be the same as the DMRS scrambling ID2, regardless of which index the UE is indicated to use in the MU-MIMO assist signaling field.

### Third Embodiment: Multi-User Scheduling Support Signaling Considering Enhanced DMRS Type

In an embodiment of the disclosure, operations of a UE and a base station are described for a case in which the UE receives higher layer signaling from a base station for an enhanced DMRS type when the UE is capable of receiving multi-user scheduling support signaling indicated from the base station. This embodiment may operate in combination with other embodiments.

The advanced specifications of 5G may support enhanced DMRS type 1 and DMRS type 2, which support an increased number of orthogonal ports while maintaining the same RE usage and overhead compared to DMRS type 1 and DMRS type 2 supported in the initial specifications of 5G for both uplink and downlink. The existing DMRS type 1 may support a maximum of 4 and 8 orthogonal DMRS ports when the number of front-loaded symbols is 1 and 2, respectively, and the DMRS type 2 may support a maximum of 6 and 12 orthogonal DMRS ports when the number of front-loaded symbols is 1 and 2, respectively.

With this support, enhanced DMRS type 1 may support a maximum of 8 and 16 orthogonal DMRS ports when the number of front-loaded symbols is 1 and 2, respectively, and enhanced DMRS type 2 may support a maximum of 12 and 24 orthogonal DMRS ports when the number of front-loaded symbols is 1 and 2, respectively. The new DMRS types supporting this increased number of orthogonal ports may hereafter be referred to as one of “Enhanced DMRS Types 1 and 2”, “New DMRS Types 1 and 2”, “New DMRS Types 1 and 2”, “DMRS Types 1-1 and 2-1”, or “DMRS Types 3 and 4”, without excluding other similarly expanded names that may be used to imply that they have enhanced functionality from the existing DMRS Types 1 and 2. The following discussion focuses on downlink, but applies equally to uplink DMRS support.

In case that the UE supports enhanced DMRS types 1 and 2, the UE may report to the base station the UE capability to support enhanced DMRS types 1 and 2. In this case, the UE capability report may be transmitted to the base station on a per band basis, or more granularly on a per feature set (FS) or per feature set per component carrier (FSPC) basis. In addition, the UE capability reporting may be supported on a per FR basis or limited to FRI only.

In addition, the UE capability reporting may include the meaning that, for the enhanced DMRS type 1, the UE may support a maximum of 8 and 16 orthogonal DMRS ports when the number of front-loaded symbols is 1 and 2, respectively, and for the enhanced DMRS type 2, the UE may support a maximum of 12 and 24 orthogonal DMRS ports when the number of front-loaded symbols is 1 and 2, respectively, as described above. The UE may report whether it supports enhanced DMRS types 1 and 2 through a common UE capability, and in this case, the UE may report whether it supports enhanced DMRS type 1 only, enhanced DMRS type 2 only, or both enhanced DMRS types 1 and 2. Further, the UE may report whether it supports enhanced DMRS types 1 and 2 through individual UE capabilities.

As a method of supporting the enhanced DMRS type 1 described above, the time and frequency resource mapping of the DMRS RE and its FD-OCC and TD-OCC coefficients may be determined when using the enhanced DMRS type 1 based on Equation 6 and Table 33.

$${a}_{k , l}^{( p , u )} = {β}_{PDSCH}^{DMRS} {w}_{f} ( {k}^{′} ) {w}_{t} ( {l}^{′} ) r ( 4 n + {k}^{′} ) \qquad [ Equation 6 ]$$

$$k = 8 n + 2 {k}^{′} + Δ ( configuration type 1 )$$

$${k}^{′} = 0 , 1 , 2 , 3$$

$$l = \overline{l} + {l}^{′}$$

$$n = 0 , 1 , …$$

TABLE 33

| | CDM | | | | | | | |
|---|---|---|---|---|---|---|---|---|
| | group | | w_{f}(k′) | | | | wₜ(1′) | |
| p | λ | Δ | k′ = 0 | k′ = 1 | k′ = 2 | k′ = 3 | l′ = 0 | l′ = 1 |
| 1000 | 0 | 0 | +1 | +1 | +1 | +1 | +1 | +1 |
| 1001 | 0 | 0 | +1 | −1 | +1 | −1 | +1 | +1 |
| 1002 | 1 | 1 | +1 | +1 | +1 | +1 | +1 | +1 |
| 1003 | 1 | 1 | +1 | −1 | +1 | −1 | +1 | +1 |
| 1004 | 0 | 0 | +1 | +1 | +1 | +1 | +1 | −1 |
| 1005 | 0 | 0 | +1 | −1 | +1 | −1 | +1 | −1 |
| 1006 | 1 | 1 | +1 | +1 | +1 | +1 | +1 | −1 |
| 1007 | 1 | 1 | +1 | −1 | +1 | −1 | +1 | −1 |
| 1008 | 0 | 0 | +1 | +1 | −1 | −1 | +1 | +1 |
| 1009 | 0 | 0 | +1 | −1 | −1 | +1 | +1 | +1 |
| 1010 | 1 | 1 | +1 | +1 | −1 | −1 | +1 | +1 |
| 1011 | 1 | 1 | +1 | −1 | −1 | +1 | +1 | +1 |
| 1012 | 0 | 0 | +1 | +1 | −1 | −1 | +1 | −1 |
| 1013 | 0 | 0 | +1 | −1 | −1 | +1 | +1 | −1 |
| 1014 | 1 | 1 | +1 | +1 | −1 | −1 | +1 | −1 |
| 1015 | 1 | 1 | +1 | −1 | −1 | +1 | +1 | −1 |

In the enhanced DMRS type 1 based on Equation 6 and Table 33 above, a total of two CDM groups are used, and in the case of one front-loaded DMRS symbol, each CDM group may include four DMRS ports and thus a maximum of eight orthogonal DMRS ports may be supported. Furthermore, in the case of two front-loaded DMRS symbols, each CDM group may include eight DMRS ports and thus a total of 16 orthogonal DMRS ports may be supported. Since the number of DMRS ports in the CDM group is increased while maintaining the number of CDM groups of 2 in the existing DMRS type 1, and the OCC length therefor is increased to 4, scheduling of the PDSCH to be transmitted together with DMRS may be performed in units of 2 RBs, and the DMRS may be mapped to the same RE location as the existing DMRS type 1.

However, existing DMRS type 1 assumes that two REs (e.g., RE #0 and RE #2) located two RBs apart have the same channel and applies an OCC to the two REs to distinguish orthogonal ports, and in the case of a front-loaded DMRS symbol, three OCCs of length 2 are used because a total of 6 REs are used within one RB per port.

On the other hand, based on the enhanced DMRS type 1, for a front-loaded DMRS symbol, a total of 12 REs are used within two RBs per port, and a receiver may distinguish a total of four orthogonal antenna ports by using an OCC of length 4 applied to four adjacent REs. In this case, the OCC of length 4 is applied to four REs, and each of the four REs may exist at a location that is two REs apart from each other (i.e., the subcarrier index difference is 2). This signifies that the receiver should apply OCCs to four REs with relative RE positions of 0, 2, 4, and 6, respectively, as if they were on the same channel, which may result in poor channel estimation performance compared to the existing DMRS type 1. Therefore, the enhanced DMRS type 1 may be used for multi-user MIMO use in channels with less frequency-selective characteristics.

In Table 33 above, a value of w_{f}(k′) for ports 1000 to 1015 of a length 4 OCC may be determined such that there is orthogonality among all ports, and the values in the above table do not exclude other values as examples. In Equation 6, β_{PDSCH}^{DMRS} is a scaling factor meaning a ratio between the energy per RE (EPRE) of the PDSCH and the EPRE of the DMRS, which may be calculated as

$${β}_{PDSCH}^{DMRS} = {10}^{\frac{- {β}_{DMRS}}{20}}$$

and β_{DMRS} may have a value of 0 dB or −3 dB depending on whether the number of CDM groups is one or two.

As a method for supporting the enhanced DMRS type 2 described above, the time and frequency resource mapping of the DMRS RE and its FD-OCC and TD-OCC coefficients may be determined when using the enhanced DMRS type 2 based on Equation 7 and Table 34.

$${a}_{k , l}^{( p , u )} = {β}_{PDSCH}^{DMRS} {w}_{f} ( {k}^{′} ) {w}_{t} ( {l}^{′} ) r ( 4 n + {k}^{′} ) \qquad [ Equation 7 ]$$

$$k = \{ \begin{matrix}12 n + {k}^{′} + Δ & Configuration type 2 , {k}^{′} = 0 , 1 \\ 12 n + {k}^{′} + Δ + 4 & Configuration type 2 , {k}^{′} = 2 , 3\end{matrix}$$

$${k}^{′} = 0 , 1 , 2 , 3$$

$$l = \overline{l} + {l}^{′}$$

$$n = 0 , 1 , …$$

TABLE 34

| | CDM | | | | | | | |
|---|---|---|---|---|---|---|---|---|
| | group | | w_{f}(k′) | | | | wₜ(1′) | |
| p | λ | Δ | k′ = 0 | k′ = 1 | k′ = 2 | k′ = 3 | l′ = 0 | l′ = 1 |
| 1000 | 0 | 0 | +1 | +1 | +1 | +1 | +1 | +1 |
| 1001 | 0 | 0 | +1 | −1 | +1 | −1 | +1 | +1 |
| 1002 | 1 | 2 | +1 | +1 | +1 | +1 | +1 | +1 |
| 1003 | 1 | 2 | +1 | −1 | +1 | −1 | +1 | +1 |
| 1004 | 2 | 4 | +1 | +1 | +1 | +1 | +1 | +1 |
| 1005 | 2 | 4 | +1 | −1 | +1 | −1 | +1 | +1 |
| 1006 | 0 | 0 | +1 | +1 | +1 | +1 | +1 | −1 |
| 1007 | 0 | 0 | +1 | −1 | +1 | −1 | +1 | −1 |
| 1008 | 1 | 2 | +1 | +1 | +1 | +1 | +1 | −1 |
| 1009 | 1 | 2 | +1 | −1 | +1 | −1 | +1 | −1 |
| 1010 | 2 | 4 | +1 | +1 | +1 | +1 | +1 | −1 |
| 1011 | 2 | 4 | +1 | −1 | +1 | −1 | +1 | −1 |
| 1012 | 0 | 0 | +1 | +1 | −1 | −1 | +1 | +1 |
| 1013 | 0 | 0 | +1 | −1 | −1 | +1 | +1 | +1 |
| 1014 | 1 | 2 | +1 | +1 | −1 | −1 | +1 | +1 |
| 1015 | 1 | 2 | +1 | −1 | −1 | +1 | +1 | +1 |
| 1016 | 2 | 4 | +1 | +1 | −1 | −1 | +1 | +1 |
| 1017 | 2 | 4 | +1 | −1 | −1 | +1 | +1 | +1 |
| 1018 | 0 | 0 | +1 | +1 | −1 | −1 | +1 | −1 |
| 1019 | 0 | 0 | +1 | −1 | −1 | +1 | +1 | −1 |
| 1020 | 1 | 2 | +1 | +1 | −1 | −1 | +1 | −1 |
| 1021 | 1 | 2 | +1 | −1 | −1 | +1 | +1 | −1 |
| 1022 | 2 | 4 | +1 | +1 | −1 | −1 | +1 | −1 |
| 1023 | 2 | 4 | +1 | −1 | −1 | +1 | +1 | −1 |

In the enhanced DMRS type 2 based on Equation 7 and Table 34 above, a total of three CDM groups are used, and in the case of one front-loaded DMRS symbol, each CDM group may include four DMRS ports and thus a total of 12 orthogonal DMRS ports may be supported. Furthermore, in the case of two front-loaded DMRS symbols, each CDM group may include eight DMRS ports, and thus a total of 24 orthogonal DMRS ports may be supported. Because the number of DMRS ports within a CDM group has been increased while maintaining the number of CDM groups, the scheduling of PDSCHs to be transmitted together with DMRS may remain the same as before, in units of one RB, and DMRS may be mapped to the same RE locations as DMRS type 2.

However, existing DMRS type 2 assumes that the channels of two consecutive REs are the same and applies an OCC to both REs to distinguish orthogonal ports, and in the case of a front-loaded DMRS symbol, two OCCs of length 2 are used because a total of four REs are used within one RB per port.

On the other hand, based on the enhanced DMRS type 2, in the case of a front-loaded DMRS symbol, a total of four REs are used within one RB per port, and the receiver may use one OCC of length 4 to distinguish between the four orthogonal ports. In this case, an OCC of length 4 is applied to two consecutive sets of REs separated by 6 REs (i.e., a subcarrier index difference is 6). In other words, the receiver should apply the OCC to four REs with relative RE positions of 0, 1, 6, and 7, respectively, as if they were on the same channel, which may result in worse channel estimation performance compared to the existing DMRS type 2. Therefore, this enhanced DMRS type 2 may be used for multi-user MIMO use in channels with less frequency-selective characteristics. In Equation 8, β_{PDSCH}^{DMRS} is the scaling factor, which is a ratio between the energy per RE (EPRE) of PDSCH and the EPRE of DMRS, and may be calculated as

$${β}_{PDSCH}^{DMRS} = {10}^{\frac{- {β}_{DMRS}}{20}}$$

and β_{DMRS} may have a value of 0 dB, −3 dB, and −4.77 dB depending on the number of CDM groups, 1, 2, and 3.

As described above, when the UE reports, to the base station through UE capability meaning that it is capable of supporting enhanced DMRS type 1 or enhanced DMRS type 2, and the base station has configured higher layer signaling to indicate that enhanced DMRS type 1 or enhanced DMRS type 2 is supported, the UE may have twice as many orthogonal DMRS ports for a front-loaded symbol of the same length as DMRS type 1 or DMRS type 2. Therefore, when the UE estimates demodulation signals of other UEs and a modified channel in the form of multiplying the precoder of other UE subject to MU-MIMO scheduling and the channel of the corresponding UE, via the R-ML receiver described above, the UE may need to involve more than twice the complexity when operating based on an enhanced DMRS type 1 over than DMRS type 1.

Therefore, when a UE has reported, to the base station, a UE capability of supporting enhanced DMRS type 1 or 2, and the UE is to report to the base station a UE capability meaning that the UE is capable of receiving the MU-MIMO assist signaling field to support the R-ML receiver described above, the UE may need to transfer to the base station a separate UE capability report signifying that the UE is capable of handling more complexity than DMRS type 1 or 2. In other words, in order to simultaneously support both the R-ML receiver and enhanced DMRS type 1 or 2, the UE may define and report to the base station a separate UE capability which is similar in a meaning of the UE capability mentioned in the first embodiment, but which is capable of supporting both enhanced DMRS type 1 or 2. In this case, the corresponding UE capability may also be defined as having three levels, such as support for indices 1 to 5 as described above, support for index 6 in addition to indices 1 to 5, and support for index 7 in addition to indices 1 to 6. In addition, the maximum number of UEs or the maximum number of layers capable of MU-MIMO scheduling with the corresponding UE may be included in the corresponding individual UE capability and reported to the base station, and similar information may be included within the UE capability in the first embodiment described above.

### Fourth Embodiment: PDSCH Capable of Applying Multi-User Scheduling Support Signaling

An embodiment of the disclosure describes a PDSCH capable of applying multi-user scheduling support signaling, which a UE may receive an indication from a base station. This embodiment may operate in combination with other embodiments.

The UE may receive an indication from the base station to enable SPS PDSCH reception via DCI. In this case, when the MU-MIMO assist signaling field exists in the DCI received by the UE, i.e., when the UE has received a configuration of the higher layer signaling indicating the presence of the MU-MIMO assist signaling field, the UE may perform an operation using a combination of at least one of the following.
When the UE receives DCI indicating SPS PDSCH activation, if a MU-MIMO assist signaling field exists in the corresponding DCI, the UE may expect the MU-MIMO assist signaling field to indicate an index of 0. In other words, the UE may expect SU-MIMO scheduling without using the R-ML receiver when receiving periodic SPS PDSCHs.
When the UE receives DCI indicating SPS PDSCH activation, if the MU-MIMO assist signaling field exists in the corresponding DCI, the UE may ignore the corresponding value regardless of which index the MU-MIMO assist signaling field indicates. In other words, the UE may expect SU-MIMO scheduling without using the R-ML receiver when receiving periodic SPS PDSCHs.
When the UE receives DCI indicating SPS PDSCH activation, if MU-MIMO assist signaling field exists in the corresponding DCI, the UE may expect that if the MU-MIMO assist signaling field indicates a non-zero index value, the corresponding value may only be applied for reception of the first SPS PDSCH after activation with the DCI, and from the second SPS PDSCH received, the UE may ignore the information in the MU-MIMO assist signaling field, i.e., may expect SU-MIMO scheduling without using the R-ML receiver. Furthermore, the application of MU-MIMO scheduling to the first SPS PDSCH is only an example, and the SPS PDSCH to which MU-MIMO scheduling is applied may be determined in other methods as described below. For example, the UE may determine that an SPS PDSCH at a specific period after activation, fixedly defined in the specification, is the PDSCH subject to MU-MIMO scheduling (e.g., the 5th SPS PDSCH after activation), an SPS PDSCH at every specific period may be assumed to be subject to MU-MIMO scheduling (e.g., MU-MIMO scheduling is applied to SPS PDSCHs at every 10th period after activation), or MU-MIMO scheduling may be assumed to be applied to SPS PDSCHs at a specific location configured by the base station or at a specific period.
When the UE receives DCI indicating SPS PDSCH activation, if a MU-MIMO assist signaling field exists in the corresponding DCI, the UE may apply the value indicated by the MU-MIMO assist signaling field with respect to all cycles of SPS PDSCH reception if the MU-MIMO assist signaling field indicates a value with a non-zero index. In other words, the UE may assume that for such an SPS PDSCH activation, MU-MIMO scheduling is performed at all SPS PDSCH reception locations. For example, when quasi-static scheduled traffic is delivered to multiple UEs in similar cycles and the channels of these UEs do not change and are favorable for MU-MIMO scheduling, i.e., if the channels between the two UEs and the base station have low spatial correlation, these UEs may be scheduled in MU-MIMO even in the case of SPS PDSCH.

If MU-MIMO scheduling is to be stopped from a specific time point, the base station may instruct additional DCI to the corresponding UEs to update information about the corresponding SPS PDSCH. In this case, if the base station determines that MU-MIMO scheduling is no longer possible for UEs that were previously scheduled in MU-MIMO, the base station may configure the MU-MIMO assist signaling field in the additional DCI as index 0 and instruct the same to the UE.

If the higher layer signaling corresponding to one codepoint indicated by a TDRA field in the DCI includes multiple TDRA entries, the UE may receive different PDSCHs at different time resource locations indicated by each TDRA entry, and this may be referred to as multi-PDSCH scheduling. In this case, when the MU-MIMO assist signaling field exists in the DCI received by the UE, i.e., the UE receives a configuration of the higher layer signaling indicating the presence of the MU-MIMO assist signaling field, the UE may perform operations using a combination of at least one of the following.
When the UE receives DCI indicating multi-PDSCH scheduling, if a MU-MIMO assist signaling field exists in the corresponding DCI, the UE may expect the MU-MIMO assist signaling field to indicate index 0. In other words, the UE may expect SU-MIMO scheduling without using R-ML receivers for each different PDSCH when receiving multi-PDSCH scheduling.
When the UE receives DCI indicating multi-PDSCH scheduling, if a MU-MIMO assist signaling field exists in the corresponding DCI, the UE may ignore the corresponding value regardless of which index the MU-MIMO assist signaling field indicates. In other words, the UE may expect SU-MIMO scheduling without using R-ML receivers for each of the different PDSCHs when receiving multi-PDSCH scheduling.
When the UE receives DCI indicating multi-PDSCH scheduling, if the MU-MIMO assist signaling field exists in the corresponding DCI, the UE may expect that if the MU-MIMO assist signaling field indicates a non-zero index value, the corresponding value may only be applied for the reception of the first PDSCH indicated by the DCI among multiple different PDSCHs, and for the reception of the second to the last PDSCH, the UE may ignore the information in the MU-MIMO assist signaling field, i.e., may expect SU-MIMO scheduling without using the R-ML receiver. It should also be noted that the application of MU-MIMO scheduling for the first PDSCH is only an example and that other methods, such as the following, may be possible to determine the PDSCH to which MU-MIMO scheduling is applied. The UE may assume MU-MIMO scheduling to a PDSCH at a specific location that is fixedly defined in the specification during multi-PDSCH scheduling (e.g., the last PDSCH in a multi-PDSCH), or the UE may assume MU-MIMO scheduling for a PDSCH at a specific location that is notified of by the base station through a combination of higher layer signaling, MAC CE, and L1 signaling.
When the UE receives DCI indicating multi-PDSCH scheduling, if the MU-MIMO assist signaling field exists in the corresponding DCI, the UE may apply the value indicated by the MU-MIMO assist signaling field for all time resource locations for multi-PDSCH reception if the MU-MIMO assist signaling field indicates a non-zero index value. In other words, the UE may assume that for such multi-PDSCH scheduling, MU-MIMO scheduling is performed at all different PDSCH reception locations.

In case that the UE has received different CORESETPoolIndex values configured in its CORESET, i.e., when operating as a multi-DCI-based multi-TRP, and if the MU-MIMO assist signaling field exists in the DCI received by the UE, i.e., when the UE has received a configuration of the higher layer signaling indicating the presence of the MU-MIMO assist signaling field, the UE may perform operations using a combination of at least one of the following.
The UE may expect that the MU-MIMO assist signaling field does not exist in DCI.
In case that the MU-MIMO assist signaling field exists in the DCI, the UE may expect the field to indicate index 0 only. In other words, the UE may receive PDSCHs subject to single-TRP-based SU-MIMO scheduling or NCJT scheduling as described above, and may not receive PDSCHs subject to MU-MIMO scheduling.
In case that the MU-MIMO assist signaling field exists in the DCI, the UE may ignore a value indicated by the corresponding field regardless of which index the MU-MIMO assist signaling field indicates. In other words, the UE may receive PDSCHs subject to single-TRP-based SU-MIMO scheduling or NCJT scheduling as described above and may not receive PDSCHs subject to MU-MIMO scheduling.
In case that the MU-MIMO assist signaling field exists in the DCI, if the corresponding field indicates an index of 0, the UE may expect to receive either single-TRP scheduled or NCJT scheduled PDSCHs as described above. In case that the UE receives an indication of a non-zero index value for the MU-MIMO assist signaling field, the UE may expect MU-MIMO scheduling by which PDSCH is transmitted from a single TRP. In other words, the UE may expect that two PDSCHs, which may be indicated by different DCIs transmitted by CORESETs configured with different CORESETPoolIndexes, will not overlap in time and frequency resources if the MU-MIMO assist signaling index is non-zero. This may signify that the UE expects the PDSCHs to be scheduled from a single TRP rather than an NCJT. This is because the UE does not expect NCJT scheduling if it may expect MU-MIMO scheduling.

Single-DCI-based multi-TRP operation (i.e., when two TCI states are activated in at least one codepoint of the TCI state field within the DCI) may also be performed similarly to the multi-DCI-based multi-TRP operation described above when combined with the MU-MIMO assist signaling field. That is, the UE may expect the MU-MIMO assist signaling field to be absent from the DCI, may expect the MU-MIMO assist signaling field to exist but to indicate only index 0, or may ignore the field even if the MU-MIMO assist signaling field indicates a predetermined index. In addition, the UE may not expect that the MU-MIMO assist signaling field indicates a non-zero index when two TCI states are indicated by the TCI state field. In other words, the UE may not expect MU-MIMO scheduling to be performed when multi-TRP scheduling is enabled (when two TCI states are indicated), and may expect SU-MIMO scheduling to be enabled, i.e. may expect an index of 0 to be indicated. In addition, when the UE receives a TCI state of 1 via the TCI state field, the UE may expect a predetermined index to be indicated via the MU-MIMO assist signaling field, and this may mean that there is no scheduling constraint.

The UE may receive coherent joint transmission (C-JT) PDSCH scheduling from the base station, and may receive higher layer signaling configuration and L1 signaling for the C-JT PDSCH scheduling. C-JT PDSCH is a method in which a base station uses multiple TRPs to transmit PDSCH to a UE by operating the multiple TRPs as if they were a single TRP, wherein the multiple TRPs may be fully or partially time and frequency synchronized. When the base station schedules C-JT PDSCHs to the UE, the UE may secure more ranks than if the UE receives PDSCHs from the existing single TRP and may obtain additional power gains by receiving signals from multiple TRPs, while the base station may obtain additional power gains by using multiple TRPs and may maximize the benefit of supporting multi-user MIMO by increasing the likelihood of generating independent channels between multiple UEs as compared to using a single TRP.

The UE may report to the base station a UE capability indicating that it is capable of C-JT PDSCH scheduling. The corresponding UE capability may include a combination of at least one of the following.
Number of TCI states required for C-JT PDSCH scheduling: A combination of at least one of one or two may be reported.
When only one TCI state is required for C-JT PDSCH scheduling, the QCL type of the first TCI state is QCL-TypeA, and the UE may refer to the four channel parameters of average delay, delay spread, Doppler shift, and Doppler spread derived from the reference RS of the corresponding TCI state.
When there are two TCI states required for C-JT PDSCH scheduling, the UE may report the channel parameter information and QCL type included in the first TCI state and the second TCI state, and the channel parameter information and QCL type included in the first TCI state and the second TCI state may be a combination of at least one of the following.
[Two-TCI state indication method 1] The QCL type of both the first and second TCI states is QCL-TypeA, and the UE may refer to the four channel parameters of average delay, delay spread, Doppler shift, and Doppler spread derived from the reference RS of both TCI states.
[Two-TCI state indication method 2] The QCL type of the first TCI state is QCL-TypeA, and the UE may refer to the four channel parameters of average delay, delay spread, Doppler shift, and Doppler spread derived from the reference RS of the first TCI state, and the QCL type of the second TCI state may signify a state in which some channel parameters of QCL-TypeA are excluded, and the UE may refer to the two channel parameters of average delay and delay spread derived from the reference RS of the second TCI state.

After receiving the UE capability report, the base station may configure higher layer signaling for the UE by using a combination of at least one of the following higher layer signaling configuration methods.
The UE may receive the TCI indication method for C-JT PDSCH scheduling from the base station via higher layer signaling. The corresponding higher layer signaling may be configured for each bandwidth part or for each cell.
In case that the UE reports to the base station that the number of TCI states that can be received during C-JT PDSCH scheduling as one through a UE capability report, the base station may configure, for the UE, higher layer signaling meaning that the number of TCI states to be used during C-JT PDSCH scheduling is 1.
In case that the UE reports the number of TCI states that can be received during C-JT PDSCH scheduling to the base station as two through a UE capability report and reports at least one of the above [Two-TCI state indication method 1] and [Two-TCI state indication method 2], the base station may configure, in the UE, the higher layer signaling meaning that the number of TCI states available during C-JT PDSCH scheduling is two and that either [Two-TCI state indication method 1] or [Two-TCI state indication method 2] is used.
In case that the UE reports the number of TCI states that can be received during C-JT PDSCH scheduling to the base station as one or two through a UE capability report and reports that at least one of the above [Two-TCI state indication method 1] and [Two-TCI state indication method 2] can be supported when the number of TCI states is two, the base station may configure, in the UE, the higher layer signaling meaning that the number of TCI states available during C-JT PDSCH scheduling is one or two and that either [Two-TCI state indication method 1] or [Two-TCI state indication method 2] is used.

In case that the UE has received a configuration of the higher layer signaling related to C-JT PDSCH scheduling as described above (e.g., one of the higher layer signals indicating that C-JT PDSCH scheduling is possible, the number of TCI states to be used for C-JT PDSCH scheduling, and relevant information such as the QCL type of the TCI state if two TCI states are used), if the MU-MIMO assist signaling field exists in the DCI received by the UE, i.e., the UE has received a configuration of the higher layer signaling indicating the presence of the MU-MIMO assist signaling field, the UE may perform an operation using a combination of at least one of the following.
In case that the UE receives an indication of C-JT PDSCH scheduling described above through a single TCI state, the UE may expect that the MU-MIMO assist signaling field does not exist in the DCI, may expect that the MU-MIMO assist signaling field exists but only indicates index 0, or may ignore the MU-MIMO assist signaling field even if it indicates a predetermined index. In other words, even if C-JT PDSCH scheduling is indicated through one TCI state, the UE treats the C-JT PDSCH scheduling the same as the multi-TRP scheduling and may not expect to receive MU-MIMO scheduling.
According to another method, if the UE receives the C-JT PDSCH scheduling described above through a single TCI state, the UE may expect the MU-MIMO assist signaling field to indicate a predetermined index, and this may signify that there is no scheduling constraint. Therefore, from the UE's point of view, C-JT PDSCH scheduling may be treated as a single TRP technique, even though it is multi-TRP scheduling, and thus the UE may be allowed to schedule MU-MIMO.
In case that the UE receives an indication of the C-JT PDSCH scheduling described above via two TCI states, the UE may expect the MU-MIMO assist signaling field to be absent in the DCI, may expect the MU-MIMO assist signaling field to exist but to indicate only index 0, or may ignore the MU-MIMO assist signaling field even if it indicates a predetermined index.

According to another method, when a UE receives a C-JT PDSCH scheduled based on two TCI states, the UE may report its individual UE capabilities to the base station and indicate to the base station that MU-MIMO scheduling is possible in the corresponding situation. With respect to the UE, the base station may transfer MU-MIMO related information to the UE via the MU-MIMO assist signaling field. When receiving a C-JT PDSCH scheduled based on the two TCI states described above, MU-MIMO scheduling may be possible if at least one of [Two-TCI state indication method 1] and [Two-TCI state indication method 2] described above is supported, and the UE may report the individual UE capability for each method or report the common UE capability to inform the base station that MU-MIMO scheduling is possible.

### Fifth Embodiment: Conditions for Enabling Multi-User Scheduling Support Signaling

An embodiment of the disclosure describes conditions under which a UE may receive multi-user scheduling support signaling from a base station. This embodiment may operate in combination with other embodiments.

The UE may receive, from a base station, a configuration of the higher layer signaling for a specific multi-TRP-based PDSCH transport scheme. This higher layer signaling may require the UE to prepare the reception scheme for the multi-TRP-based PDSCH transport scheme in addition to the reception scheme for the single-TRP based PDSCH transport scheme, and this may require the implementation of additional reception algorithms of the UE, thereby introducing additional complexity.

Further, the UE may receive, from the base station, a configuration of the higher layer signaling to determine the presence of the MU-MIMO assist signaling field so as to receive additional information on multi-user MIMO scheduling, to thereby receive the MU-MIMO assist signaling field via DCI format 1_1. When receiving a configuration of the corresponding higher layer signaling, the UE may identify inter-user interference in multi-user MIMO scheduling based on the above R-ML receiver and may operate a reception algorithm corresponding thereto so as to introduce additional UE complexity.

Therefore, when the UE simultaneously receives, from the base station, configurations of the higher layer signaling corresponding to the multi-TRP-based PDSCH transmission method and the higher layer signaling determining the presence of the MU-MIMO assist signaling field, the UE receiver structure becomes more complex and the number of algorithms that need to be implemented increases, the complexity according thereto may increase significantly. Both the multi-TRP-based PDSCH transmission method and the multi-user MIMO scheduling method may improve the downlink data reception performance of the UE, but their simultaneous implementation would be very burdensome for the corresponding UE. Therefore, the constraints between the higher layer signaling corresponding to the multiple TRP-based PDSCH transmission scheme and the higher layer signaling that determine the presence of MU-MIMO assist signaling field are described below. The higher layer signaling corresponding to the multi-TRP-based PDSCH transmission scheme that may be considered below may be one of the following: coresetPoolIndex, TCI selection field-relevant higher layer signaling, repetitionSchemeConfig-r16, repetitionSchemeConfig-v1630, SSB-MTC-AdditionalPCI, sfnSchemePDCCH, sfnSchemePDSCH, searchSpaceLinkingId, and/or cjtSchemePDSCH.

The following describes the higher layer signaling that determines whether the MU-MIMO assist signaling for field DCI format 1_1 exists or not and a configuration of one or more CORESETs having different coresetPoolIndex values.

In case that the UE receives, from the base station, a configuration of one or more CORESETs having different coresetPoolIndex values, the UE may not receive, from the base station, a configuration of the higher layer signaling that determines whether the MU-MIMO assist signaling field for DCI format 1_1 exists or not.

If the base station configures, for the UE, one or more CORESETs having different coresetPoolIndex values, the base station may not configure, for the UE, higher layer signaling to determine the presence of the MU-MIMO assist signaling field for DCI format 1_1.

In case that the UE has been configured with, from the base station, higher layer signaling to determine the presence of the MU-MIMO assist signaling field for DCI format 1_1, the UE may not expect to receive (or not receive) a configuration of one or more CORESETs having different coresetPoolIndex values from the base station.

In case that the base station configures, for the UE, higher layer signaling that determines whether the MU-MIMO assist signaling field for DCI format 1_1 exists or not, the base station may not configure, for the UE, one or more CORESET having different coresetPoolIndex values.

In the above, the fact that the UE does not receive a configuration of one or more CORESETs having different coresetPoolIndex values from the base station may signify that all coresetPoolIndexes are not configured for all of one or more CORESETs with which the UE is configured, all coresetPoolIndexes are configured as 0 for all of one or more CORESETs with which the UE is configured, or all coresetPoolIndexes are configured as 1 for all of one or more CORESETs with which the UE is configured. Alternatively, the fact that the base station does not configure one or more CORESETs having different coresetPoolIndex values for the UE may signify that all coresetPoolIndexes are not configured for all of one or more CORESETs configured by the base station, all coresetPoolIndexes are configured as 0 for all of one or more CORESETs configured by the base station, or all coresetPoolIndexes are configured as 1 for all of one or more CORESETs configured by the base station.

In the above, the receiving of a configuration of one or more CORESETs having different coresetPoolIndex values by the UE from the base station may signify that some of the one or more CORESETs received by the UE have no coresetPoolIndex configured or have coresetPoolIndex configured as 0, and the remaining other CORESETs have coresetPoolIndex configured as 1. For example, this may refer to the case in which the UE has received two CORESETs from the base station, the first CORESET has no coresetPoolIndex configured or has coresetPoolIndex configured as 0, and the second CORESET has coresetPoolIndex configured as 1. The base station configuring, for the UE, one or more CORESETs having different coresetPoolIndex values may signify that some of the one or more CORESETs of the base station have no coresetPoolIndex configured or have coresetPoolIndex configured as 0, and the remaining other CORESETs have coresetPoolIndex configured as 1.

The following describes the higher layer signaling that determines whether the MU-MIMO assist signaling field for DCI format 1_1 exists or not and the TCI state field within DCI format 1_1 or 1_2.

In case that the UE has received, from the base station, a configuration of the higher layer signaling to determine whether the MU-MIMO assist signaling field for DCI format 1_1 exists or not, the UE may expect all codepoints in the TCI state field in DCI format 1_1 or 1_2 received from the base station to indicate one TCI state. In other words, the UE may not expect that one codepoint in the TCI state field in DCI format 1_1 or 1_2 received from the base station indicates two TCI states.

In case that the base station has configured, for the UE, the higher layer signaling to determine whether the MU-MIMO assist signaling field for DCI format 1_1 exists or not, the base station may be configured to instruct or activate all codepoints of the TCI state field in the DCI format 1_1 or 1_2 to be transmitted to the UE to indicate one TCI state. In other words, the base station may be configured not to instruct or activate even one codepoint of the TCI state field in the DCI format 1_1 or 1_2 to be transmitted to the UE to indicate two TCI states.

The following describes the higher layer signaling that determines the presence or absence of the TCI selection field, which may exist in DCI formats 1_1 and 1_2, and the higher layer signaling that determines the presence or absence of the MU-MIMO assist signaling field for DCI format 1_1. The TCI selection field may include information indicating to the UE which of the two TCI states the UE should use to receive PDSCHs, when two TCI states are indicated to the UE. For example, the UE may receive, through the TCI selection field, an indication to receive PDSCHs using either the first TCI state or the second TCI state, or the UE may receive an indication to receive PDSCHs using both the first and second TCI states.

In case that the UE has been configured with, from the base station, the higher layer signaling to determine the presence or absence of TCI selection fields, which may exist in DCI formats 1_1 and 1_2, the UE may not be configured by the base station for higher layer signaling to determine the presence or absence of MU-MIMO assist signaling fields for DCI format 1_1.

In case that the base station has configured, for the UE, the higher layer signaling to determine the presence or absence of TCI selection fields that may exist in DCI formats 1_1 and 1_2, the base station may not configure, for the UE, the higher layer signaling to determine the presence or absence of MU-MIMO assist signaling fields for DCI format 1_1.

In case that the UE has received, from the base station, a configuration of the higher layer signaling to determine the presence or absence of the MU-MIMO assist signaling field for DCI format 1_1, the UE may not receive, from the base station, a configuration of the higher layer signaling to determine the presence or absence of the TCI selection fields that may exist in DCI formats 1_1 and 1_2.

In case that the base station has configured, for the UE, the higher layer signaling to determine the presence or absence of the MU-MIMO assist signaling field for DCI format 1_1, the base station may not configure, for the UE, the higher layer signaling to determine the presence or absence of TCI selection fields that may exist in DCI formats 1_1 and 1_2.

The following describes the higher layer signaling repetitionSchemeConfig-r16 or repetitionSchemeConfig-v1630 and the higher layer signaling that determines whether the MU-MIMO assist signaling field for DCI format 1_1 exists or not. The repetitionSchemeConfig is information indicating the repetition transmission scheme of single-DCI-based multi-TRP PDSCH. The repetitionSchemeConfig-r16 or repetitionSchemeConfig-v1630, which is higher layer signaling, is a condition for the UE to perform multi-TRP-based PDSCH repetition transmission from the base station, and in case that the UE receives the corresponding higher layer signaling, the UE may receive multi-TRP-based PDSCH repetition transmission assuming one of the above ‘tdmSchemeA’, ‘fdmSchemeA’, and ‘fdmSchemeB’.

In case that the UE has received, from the base station, a configuration of the higher layer signaling repetitionSchemeConfig-r16 or repetitionSchemeConfig-v1630, the UE may not receive, from the base station, a configuration of the higher layer signaling that determines whether the MU-MIMO assist signaling field for DCI format 1_1 exists or not.

In case that the base station has configured, for the UE, the higher layer signaling repetitionSchemeConfig-r16 or repetitionSchemeConfig-v1630, the base station may not configure the higher layer signaling that determines whether the MU-MIMO assist signaling field for DCI format 1_1 exists or not on the UE.

In case that the UE has received, from the base station, a configuration of the higher layer signaling that determines whether the MU-MIMO assist signaling field for DCI format 1_1 exists or not, the UE may not receive, from the base station, a configuration of the higher layer signaling repetitionSchemeConfig-r16 or repetitionSchemeConfig-v1630.

In case that the base station has configured, for the UE, the higher layer signaling that determines whether the MU-MIMO assist signaling field for DCI format 1_1 exists or not, the base station may not configure, for the UE, the higher layer signaling repetitionSchemeConfig-r16 or repetitionSchemeConfig-v1630.

The following describes the higher layer signaling SSB-MTC-AdditionalPCI and the higher layer signaling that determines whether the MU-MIMO assist signaling field for DCI format 1_1 exists or not. SSB-MTC-AdditionalPCI may be higher layer signaling that may be used when the UE receives SSB, PDCCH, or PDSCH from a TRP having a physical cell ID (PCID) that is different from a PCID of the serving cell.

In case that the UE has received, from the base station, a configuration of the higher layer signaling SSB-MTC-AdditionalPCI, the UE may not receive, from the base station, a configuration of the higher layer signaling that determines whether the MU-MIMO assist signaling field for DCI format 1_1 exists or not.

In case that the base station has configured, for the UE, the higher layer signaling SSB-MTC-AdditionalPCI, the base station may not configure, for the UE, the higher layer signaling that determines whether the MU-MIMO assist signaling field for DCI format 1_1 exists or not.

In case that the UE has received, from the base station, a configuration of the higher layer signaling that determines whether the MU-MIMO assist signaling field for DCI format 1_1 exists or not, the UE may not receive configuration of the higher layer signaling SSB-MTC-AdditionalPCI from the base station.

In case that the base station has configured, for the UE, the higher layer signaling to determine the presence or absence of the MU-MIMO assist signaling field for DCI format 1_1, the base station may not configure, for the UE, the higher layer signaling SSB-MTC-AdditionalPCI.

The following describes the higher layer signaling sfnSchemePDCCH and/or sfnSchemePDSCH and the higher layer signaling that determines whether the MU-MIMO assist signaling field for DCI format 1_1 exists or not. The sfnSchemePDCCH or sfnSchemePDSCH is information that configures a single frequency network (SFN) scheme applied to the PDCCH or PDSCH. The sfnSchemePDCCH and sfnSchemePDSCH may be higher layer signaling associated with the reception of PDCCHs and PDSCHs transmitted in a single frequency network (SFN) scheme from multiple TRPs.

In case that the UE has received, from the base station, a configuration of the higher layer signaling sfnSchemePDCCH and/or sfnSchemePDSCH, the UE may not receive, from the base station, a configuration of the higher layer signaling that determines whether the MU-MIMO assist signaling field for DCI format 1_1 exists or not.

In case that the base station has configured, for the UE, the higher layer signaling sfnSchemePDCCH and/or sfnSchemePDSCH, the base station may not configure, for the UE, the higher layer signaling that determines whether the MU-MIMO assist signaling field for DCI format 1_1 exists or not.

In case that the UE has received, from the base station, a configuration of the higher layer signaling that determines whether the MU-MIMO assist signaling field for DCI format 1_1 exists or not, the UE may not receive configuration of the higher layer signaling sfnSchemePDCCH and/or sfnSchemePDSCH from the base station.

In case that the base station has configured, for the UE, the higher layer signaling that determines whether the MU-MIMO assist signaling field for DCI format 1_1 exists or not, the base station may not configure, for the UE, the higher layer signaling sfnSchemePDCCH and/or sfnSchemePDSCH.

The following describes the higher layer signaling searchSpaceLinkingId and the higher layer signaling that determines whether the MU-MIMO assist signaling field for DCI format 1_1 exists or not. The searchSpaceLinkingId is higher layer signaling that is configured for PDCCH repeated transmission and is configured within the higher layer signaling searchSpace and, if two searchSpaces have the same searchSpaceLinkingId, the UE may consider that PDCCHs are repeatedly transmitted to each other based on the configurations of the two searchSpaces.

In case that the UE has received a configuration of higher layer signaling searchSpaceLinkingId from the base station, the UE may not receive, from the base station, a configuration of the higher layer signaling that determines whether the MU-MIMO assist signaling field for DCI format 1_1 exists or not.

In case that the base station has configured, for the UE, the higher layer signaling searchSpaceLinkingId, the base station may not configure, for the UE, the higher layer signaling that determines whether the MU-MIMO assist signaling field for DCI format 1_1 exists or not.

In case that the UE has received, from the base station, a configuration of the higher layer signaling that determines whether the MU-MIMO assist signaling field for DCI format 1_1 exists or not, the UE may not receive a configuration of the higher layer signaling searchSpaceLinkingId from the base station.

In case that the base station has configured, for the UE, the higher layer signaling to determine the presence or absence of the MU-MIMO assist signaling field for DCI format 1_1, the base station may not configure the higher layer signaling searchSpaceLinkingId, for the UE.

The following describes the higher layer signaling cjtSchemePDSCH related to whether CJT transmission is possible or not and the higher layer signaling that determines whether the MU-MIMO assist signaling field for DCI format 1_1 exists or not.

In case that the UE has received, from the base station, the configuration of cjtSchemePDSCH, which is higher layer signaling related to whether CJT transmission is possible or not, the UE may not receive, from the base station, the configuration of the higher layer signaling that determines whether the MU-MIMO assist signaling field for DCI format 1_1 exists or not.

If the base station has configured, for the UE, cjtSchemePDSCH, which is higher layer signaling related to whether CJT transmission is possible, the base station may not configure, for the UE, the higher layer signaling that determines whether the MU-MIMO assist signaling field for DCI format 1_1 exists or not.

In case that the UE has received, from the base station, a configuration of the higher layer signaling that determines whether the MU-MIMO assist signaling field for DCI format 1_1 exists or not, the UE may not receive, from the base station, the configuration of cjtSchemePDSCH, which is higher layer signaling related to whether CJT transmission is possible or not.

In case that the base station has configured, for the UE, the higher layer signaling to determine the presence or absence of the MU-MIMO assist signaling field for DCI format 1_1, the base station may not configure, for the UE, cjtSchemePDSCH which is higher layer signaling related to whether CJT transmission is possible or not.

The following describes the higher layer signaling dl-OrJointTCI-StateList and the higher layer signaling that determines the presence or absence of the MU-MIMO assist signaling field for DCI format 1_1. If the unified TCI state that may be indicated by the higher layer signaling is a separate type of TCI state, dl-OrJointTCI-StateList indicates a DL TCI state; and if the unified TCI state is a joint type of TCI state, dl-OrJointTCI-StateList may indicate a joint TCI state for DL and UL operations.

In case that the UE has received a configuration of the higher layer signaling dl-OrJointTCI-StateList, from the base station, and has been instructed one joint TCI state via the TCI state field in the DCI format 1_1 or 1_2, the UE may apply the indicated one joint TCI state to receive a downlink signal and transmit an uplink signal starting from the first slot that appears after a beam application time, which may be defined as a specific number of OFDM symbols, after the HARQ-ACK transmission indicating reception of the corresponding DCI.

In case that the UE has received a configuration of the higher layer signaling dl-OrJointTCI-StateList from the base station and has been instructed one DL TCI state and one UL TCI state via the TCI state field in the DCI format 1_1 or 1_2, the UE may apply the indicated one DL TCI state to receive a downlink signal and the indicated one UL TCI state to transmit an uplink signal, starting from the first slot that appears after a beam application time, which may be defined as a specific number of OFDM symbols, after the HARQ-ACK transmission indicating reception of the corresponding DCI.

In case that the UE has received a configuration of the higher layer signaling dl-OrJointTCI-StateList from the base station and has been instructed two joint TCI states via the TCI state field in the DCI format 1_1 or 1_2, the UE may apply these two instructed joint TCI states to receive downlink signals and transmit uplink signals starting from the first slot that appears after a beam application time, which may be defined as a specific number of OFDM symbols, after the HARQ-ACK transmission indicating reception of the corresponding DCI.

In case that the UE has received a configuration of higher layer signaling dl-OrJointTCI-StateList from the base station and has been instructed two DL TCI states and/or two UL TCI states via the TCI state field in the DCI format 1_1 or 1_2, the UE may apply the two indicated DL TCI states to receive downlink signals and the two UL TCI states to transmit uplink signals, starting from the first slot that appears after a beam application time, which may be defined as a specific number of OFDM symbols, after the HARQ-ACK transmission indicating reception of the corresponding DCI.

The one joint TCI state, the one DL TCI state, and the one UL TCI state, or the two joint TCI states, the two DL TCI states, and two UL TCI states may be applied to downlink reception and uplink transmission from a single TRP or multiple TRPs, respectively.

In case that the UE has received a configuration of the higher layer signaling dl-OrJointTCI-StateList from the base station and has received, from the base station, a configuration of the higher layer signaling that determines whether the MU-MIMO assist signaling field for DCI format 1_1 exists or not, the UE may not expect two joint TCI states to be indicated by the base station via the TCI state field in DCI format 1_1 or 1_2, or may not expect two DL TCI states and/or two UL TCI states to be indicated (That is, the UE may expect one joint TCI state to be indicated, or may expect one DL TCI state and/or one UL TCI state to be indicated).

In case that the base station has configured, for the UE, the higher layer signaling dl-OrJointTCI-StateList and has configured the higher layer signaling that determines whether the MU-MIMO assist signaling field for DCI format 1_1 exists or not, the base station may not indicate, to the UE, two joint TCI states or two DL TCI states and/or two UL TCI states via the TCI state field in DCI format 1_1 or 1_2 (That is, one joint TCI state or one DL TCI state and/or one UL TCI state may be indicated).

In case that the UE has received a configuration of the higher layer signaling dl-OrJointTCI-StateList from the base station and has not received, from the base station, a configuration of the higher layer signaling determining the presence or absence of the MU-MIMO assist signaling field for DCI format 1_1, the UE may expect the base station to indicate two joint TCI states via the TCI state field in DCI format 1_1 or 1_2, or two DL TCI states and/or two UL TCI states. In case that the base station has configured, for the UE, the higher layer signaling dl-OrJointTCI-StateList and has configured the higher layer signaling that determines whether the MU-MIMO assist signaling field for DCI format 1_1 exists or not, the base station may indicate, to the UE, two joint TCI states via the TCI state field in DCI format 1_1 or 1_2, or indicate two DL TCI states and/or two UL TCI states.

In case that the UE does not receive a configuration of specific higher layer signaling from the base station, the UE may assume that the corresponding UE and other UEs subject to scheduling with the corresponding UE all have the same DMRS power boosting value. In case that the UE does not receive a configuration of specific higher layer signaling from the base station, the UE may assume that the corresponding UE and other UEs subject to scheduling with the corresponding UE have the same value for the number of CDM group(s) without data as indicated via the antenna port field in the DCI. In case that the UE has received a configuration of specific higher layer signaling from the base station, the UE may not assume that the corresponding UE and other UEs subject to scheduling with the corresponding UE all have the same DMRS power boosting value. In case that the UE has received a configuration of specific higher layer signaling from the base station, the UE may not assume that the corresponding UE and other UEs subject to scheduling with the corresponding UE each have the same value for number of CDM group(s) without data as indicated via the antenna port field in the DCI. In the above, specific higher layer signaling may be referred to as, for example, but not limited to, dmrsPowerBoosting.

Depending on whether the higher layer signaling dmrsPowerBoosting is configured by the base station, the UE may identify whether other UEs subject to scheduling with the corresponding UE in multi-user MIMO scheme are boosting DMRS power.

In case that the UE has received the dmrsPowerBoosting configured by the base station (e.g., configured as true), the UE may assume that the corresponding UE and other UEs subject to scheduling with the corresponding UE each have the same DMRS power boosting value. In other words, the UE may assume that the corresponding UE and other UEs subject to scheduling with the corresponding UE each have the same value for the number of CDM group(s) without data indicated via the antenna port field in the DCI.

In case that the UE does not receive a configuration of dmrsPowerBoosting from the base station or if it is configured as false, the UE may not assume that the corresponding UE and other UEs subject to scheduling with the corresponding UE all have the same DMRS power boosting value. The UE may not assume that the corresponding UE and other UEs subject to scheduling with the corresponding UE each have the same value for the number of CDM group(s) without data indicated via the antenna port field in the DCI. That is, the UE may assume that the corresponding UE and other UEs subject to scheduling with the corresponding UE each have the same or different values for the number of CDM group(s) without data indicated via the antenna port field in the DCI.

As another example, a higher layer signaling such as dmrsPowerBoosting described above may not be defined. In such a case, when the UE has received the higher layer signaling configured to determine the presence or absence of the MU-MIMO assist signaling field, the UE may assume that the corresponding UE and other UEs subject to scheduling with the corresponding UE have the same DMRS power boosting value. In other words, the UE may assume that the corresponding UE and other UEs subject to scheduling with the corresponding UE each have the same value for the number of CDM group(s) without data indicated via the antenna port field in the DCI. As another example, when no higher layer signaling such as dmrsPowerBoosting described above is defined, the UE may not assume that, when the UE has received the higher layer signaling configured to determine the presence or absence of the MU-MIMO assist signaling field described above, the corresponding UE and other UEs subject to scheduling with the corresponding UE each have the same value for DMRS power boosting. In other words, the UE may not assume that the corresponding UE and other UEs subject to scheduling with the corresponding UE each have the same value for the number of CDM group(s) without data indicated via the antenna port field in the DCI. In other words, the UE may assume that the corresponding UE and other UEs subject to scheduling with the corresponding UE each have the same or different values for the number of CDM group(s) without data indicated via the antenna port field in the DCI.

In case that the UE does not receive a configuration of specific higher layer signaling from the base station, the UE may assume that the corresponding UE and other UEs subject to scheduling with the corresponding UE receive an indication of time domain resource assignment information that assigns the same time resources to receive downlink data (i.e., the UE may assume that the corresponding UE and other UEs subject to scheduling with the corresponding UE have the same start symbol position and symbol length for the resources assigned for downlink data). In case that the UE has received a configuration of specific higher layer signaling from the base station, the UE may not assume that the corresponding UE and other UEs subject to scheduling with the corresponding UE are instructed with time domain resource assignment information that assigns the same time resources (i.e., the UE may not assume that the corresponding UE and other UEs subject to scheduling with the corresponding UE have the same start symbol position and/or symbol length for the resources assigned for downlink data). In the above, the specific higher layer signaling may be referred to as, for example, but not limited to, timeDomainResourceAllocationPDSCH or pdsch-timeDomainAllocation.

In case that the UE does not receive a configuration of specific higher layer signaling from the base station, the UE may assume that the corresponding UE and other UEs subject to scheduling with the corresponding UE receive an indication of frequency domain resource assignment information that assigns the same frequency resources to receive downlink data (i.e., the UE may assume that the corresponding UE and other UEs subject to scheduling with the corresponding UE have the same location of RBs assigned for downlink data). In case that the UE has received a configuration of specific higher layer signaling from the base station, the UE may not assume that the corresponding UE and other UEs subject to scheduling with the corresponding UE are instructed with frequency domain resource assignment information that assigns the same frequency resources to receive downlink data (i.e., the UE may not assume that the corresponding UE and other UEs subject to scheduling with the corresponding UE have the same location of RBs assigned for downlink data). In this case, the UE may assume that PDSCH DMRSs of other UEs subject to scheduling with the corresponding UE are included in the same CDM group as each other. Alternatively, the UE may assume that the PDSCH DMRSs of other UEs subject to scheduling with the corresponding UE are included in different CDM groups. In the above, specific higher layer signaling may be referred to as, for example, but not limited to frequencyDomainResourceAllocation.

In case that the UE has not received a configuration of specific higher layer signaling from the base station, the UE may assume that the corresponding UE and other UEs subject to scheduling with the corresponding UE all have the same precoding resource block group (PRG) size (RB group to be precoded, and here, DMRS within the PRG may be assumed to have been precoded with the same precoder). In case that the UE does not receive a configuration of specific higher layer signaling from the base station, the UE may assume that the corresponding UE and other UEs subject to scheduling with the corresponding UE all have the same PRG size. In this case, the UE may assume that the PDSCH DMRSs of other UEs subject to scheduling with the corresponding UE are in the same CDM group as each other. As another scheme, the UE may assume that the PDSCH DMRSs of other UEs subject to scheduling with the corresponding UE are included in different CDM groups. In the above, a specific higher layer signaling may be referred to as, for example, but not limited to precodingRBGroup.

In case that the UE receives a PRG size of 2 or 4 configured from the base station and does not receive a configuration of specific higher layer signaling from the base station, the UE may assume that the corresponding UE and other UEs subject to scheduling with the corresponding UE receive an indication of the frequency resource assignment information to indicate the same RBs within the same PRG. In other words, the RBs configuring the same PRG may be the same for the corresponding UE and other UEs subject to scheduling with the corresponding UE. In case that the UE receives a PRG size of 2 or 4 configured from the base station and has received a configuration of specific higher layer signaling from the base station, the UE may not assume that the corresponding UE and other UEs subject to scheduling with the corresponding UE receive a configuration of the frequency resource assignment information to indicate the same RBs within the same PRG. In other words, the RBs configuring the same PRG may be different for the corresponding UE and other UEs subject to scheduling with the corresponding UE. In this case, the UE may assume that the PDSCH DMRSs of other UEs subject to scheduling with the corresponding UE are included in the same CDM group as each other. As another scheme, the UE may assume that the PDSCH DMRSs of other UEs subject to scheduling with the corresponding UE are included in different CDM groups. In the above, specific higher layer signaling may be referred to as, but is not limited to, precoding AndFreqResourceAllocation.

The UE may receive, via specific higher layer signaling, a configuration of information about the highest modulation order in the MCS table, configured by the corresponding UE and other UEs subject to scheduling with the corresponding UE. The specific higher layer signaling may indicate at least one of 64-QAM, 256-QAM, 1024-QAM, or 4096-QAM. In case that the UE does not receive a configuration of specific higher layer signaling, the UE may not assume information about the highest modulation order in the MCS table, configured by the corresponding UE and other UEs subject to scheduling with the corresponding UE. In case that the UE does not receive a configuration of the specific higher layer signaling, the UE may consider, as the specific modulation order, the highest modulation order in the MCS table, configured by the corresponding UE and other UEs subject to scheduling with the corresponding UE, where the specific modulation order may be at least one of 64-QAM, 256-QAM, 1024-QAM, or 4096-QAM. The specific modulation order may be predetermined. The specific higher layer signaling may be referred to as, for example, but not limited to, maxMCS or mcs table.

The UE may receive, via specific higher layer signaling, a configuration of information about whether the MU-MIMO assist signaling field is also applied for the enhanced DMRS type 1 or 2. In case that the UE has not received a configuration of enhanced DMRS type 1 or 2 from the base station and does not receive a configuration of the specific higher layer signaling, the UE may assume that the corresponding UE and other UEs subject to scheduling with the corresponding UE all operate as DMRS type 1 or 2. In case that the UE has not received a configuration of enhanced DMRS type 1 or 2, but receives a configuration of the specific higher layer signaling, the UE may assume that the corresponding UE and other UEs subject to scheduling with the corresponding UE operate as DMRS type 1 or 2 or enhanced DMRS type 1 or 2. In other words, the UE may assume that some of UEs subject to scheduling with the corresponding UE operate as DMRS type 1 or 2, while the others operate as enhanced DMRS type 1 or 2.

When the UE receives a configuration of enhanced DMRS type 1 or 2 from the base station, the UE may or may not receive the higher layer signaling corresponding to the MU-MIMO assist signaling field and the corresponding specific higher layer signaling from the base station. That is, for the UE that has received a configuration of the enhanced DMRS type 1 or 2, both the MU-MIMO assist signaling field-related configuration and the corresponding specific higher layer signaling may be configured, or neither may be configured. Therefore, when both the MU-MIMO assist signaling field-related configuration and the corresponding specific higher layer signaling are configured for the UE, the UE may assume that the corresponding UE and other UEs subject to scheduling with the corresponding UE operate as DMRS type 1 or 2 or enhanced DMRS type 1 or 2. In the above, the specific higher layer signaling may be referred to as, for example, but not limited to, enhDmrsType.

The UE may receive the PDSCH by considering the above-described details depending on whether or not the UE has received a configuration of at least one of the above described higher layer signalings (e.g., dmrsPowerBoosting, timeDomainResourceAllocationPDSCH, frequencyDomainResourceAllocation, precodingRBGroup, precodingAndFreqResourceAllocation, maxMCS, enhDmrsType) from the base station. For example, when a UE does not receive dmrsPowerBoosting and timeDomainResourceAllocationPDSCH configured, the UE may assume that UEs subject to scheduling with the corresponding UE have all been instructed the same value for the number of CDM group without data value, may assume that they have all been instructed the same time resource assignment for receiving downlink data, and may receive the downlink data by using at least one of the MU-MIMO methods described above.

The UE may receive, from the base station, a configuration of the above-described higher layer signalings (e.g., dmrsPowerBoosting, timeDomainResourceAllocationPDSCH, frequencyDomainResourceAllocation, precodingRBGroup, precodingAndFreqResourceAllocation, maxMCS, enhDmrsType) and the higher layer signaling for the MU-MIMO assist signaling field differently for each bandwidth part. For example, the higher layer signalings and the higher layer signaling for the MU-MIMO assist signaling field may each be configured in the PDSCH-Config for each bandwidth part. In another example, the above-described higher layer signalings and the higher layer signaling for the MU-MIMO assist signaling field may all be included within an higher layer signaling, such as MU-MIMO-AdvReceiver-Config (the name of the parameter may be exemplary and not limited thereto), and the MU-MIMO-AdvReceiver-Config may be configured within the PDSCH-Config. In another example, the above-described higher layer signalings and the higher layer signaling for the MU-MIMO assist signaling field may be configured for each cell. In an example, the above-described higher layer signalings and the higher layer signaling for the MU-MIMO assist signaling field may each be configured within the ServingCellConfig. Alternatively, both may be included within an higher layer signaling such as the MU-MIMO-AdvReceiver-Config (the name of the parameter may be exemplary and may not be limited to), and the MU-MIMO-AdvReceiver-Config may be configured within the ServingCellConfig, similarly as described above.

The UE may receive a configuration of the above-described higher layer signalings (e.g., dmrsPowerBoosting, timeDomainResourceAllocationPDSCH, frequencyDomainResourceAllocation, precodingRBGroup, precodingAndFreqResourceAllocation, maxMCS, enhDmrs Type) from the base station only in the case of receiving a configuration of the higher layer signaling for the MU-MIMO assist signaling field from the base station.

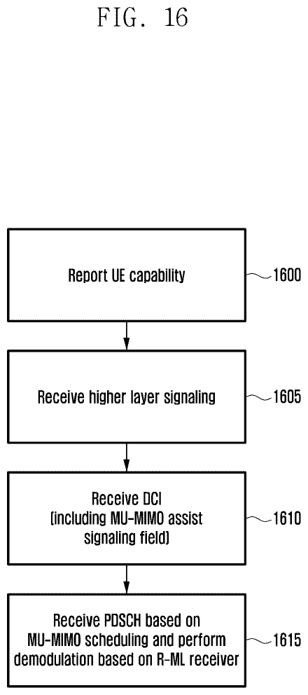

FIG. 16 illustrates the operation of a UE according to an embodiment of the disclosure.

In operation 1600, the UE may transmit UE capabilities to a base station. UE capabilities that are reportable may include a combination of at least one of the R-ML receiver-based interference control method during MU-MIMO scheduling, PDSCH 256QAM, PDSCH 1024QAM, DMRS type, PDSCH mapping type, DCI formats 1_2, 1_3, 4_0, 4_1, 4_2, DMRS sequence, OCC deactivation, maximum number of co-schedulable UEs or maximum number of co-schedulable layers during MU-MIMO scheduling, SPS PDSCH, and UE capabilities associated with multi-PDSCH, multi-DCI-based multi-TRP, single-DCI-based multi-TRP, and C-JT PDSCH scheduling, which are defined in the first to fourth embodiments above. Operation 1600 may be omitted.

In operation 1605, the UE may receive higher layer signaling from a base station based on the reported UE capabilities. The higher layer signaling that the UE receives from the base station may include a combination of at least one of the R-ML receiver-based interference control method, PDSCH 256QAM, PDSCH 1024QAM, DMRS type, PDSCH mapping type, DCI formats 1_2, 1_3, 4_0, 4_1, 4_2, DMRS sequence, OCC deactivation, maximum number of co-schedulable UEs or maximum number of co-schedulable layers during MU-MIMO scheduling, and higher layer signaling associated with SPS PDSCH, multi-PDSCH, multi-DCI-based multi-TRP, single-DCI-based multi-TRP, and C-JT PDSCH scheduling, which are defined in the first to fourth embodiments above.

In operation 1610, the UE may receive DCI from the base station, wherein the DCI may include a MU-MIMO assist signaling field, and the DCI may correspond to a combination of at least one of DCI formats 1_0, 1_1, 1_2, 1_3, 4_0, 4_1, and 4_2. The UE may, while receiving PDSCH scheduling via the corresponding DCI, obtain additional information required when using the R-ML receiver if the PDSCH scheduling corresponds to MU-MIMO scheduling via the MU-MIMO assist signaling field. In this case, a method in which the UE interprets the corresponding MU-MIMO assist signaling field may vary depending on how the obtaining of additional information is combined with the other UE operation considered in the first to fourth embodiments above.

In operation 1615, the UE may receive a PDSCH subject to MU-MIMO scheduling from the base station, and based on the additional information obtained via the MU-MIMO assist signaling field included in the DCI, the UE may detect a signal of the corresponding UE by minimizing interference from other UEs subject to scheduling using the R-ML receiver.

The flowcharts described above illustrate exemplary methods that may be implemented in accordance with the principles of the disclosure, and various modifications may be made to the methods illustrated in the flowcharts herein. For example, although shown as a series of operations, the various operations in each of the drawings may overlap, occur in parallel, occur in a different order, or occur multiple times. In other examples, operations may be omitted or replaced by other operations.

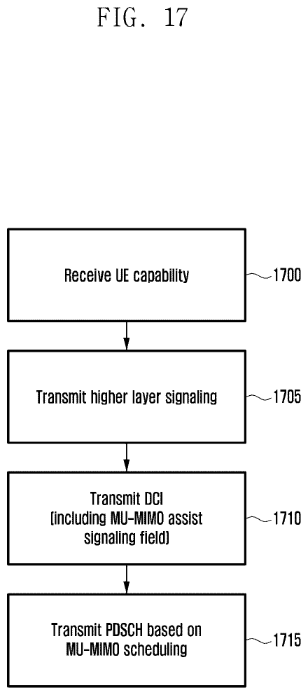

FIG. 17 illustrates the operation of a base station according to an embodiment of the disclosure.

In operation 1700, a base station may receive UE capabilities from a UE. UE capabilities that are reportable may include a combination of at least one of the R-ML receiver-based interference control method during MU-MIMO scheduling, PDSCH 256QAM, PDSCH 1024QAM, DMRS type, PDSCH mapping type, DCI formats 1_2, 1_3, 4_0, 4_1, 4_2, DMRS sequence, OCC deactivation, maximum number of co-schedulable UEs or maximum number of co-schedulable layers during MU-MIMO scheduling, SPS PDSCH, and UE capabilities associated with multi-PDSCH, multi-DCI-based multi-TRP, single-DCI-based multi-TRP, and C-JT PDSCH scheduling, which are defined in the first to fourth embodiments above. Operation 1700 may be omitted.

In operation 1705, the base station may transmit higher layer signaling to a UE based on the UE capabilities reported by the UE. The base station may define and configure, in the UE, higher layer signaling relating to a combination of at least one of the R-ML receiver-based interference control method, PDSCH 256QAM, PDSCH 1024QAM, DMRS type, PDSCH mapping type, DCI formats 1_2, 1_3, 4_0, 4_1, 4_2, DMRS sequence, OCC deactivation, maximum number of co-schedulable UEs or maximum number of co-schedulable layers during MU-MIMO scheduling, and higher layer signaling associated with SPS PDSCH, multi-PDSCH, multi-DCI-based multi-TRP, single-DCI-based multi-TRP, and C-JT PDSCH scheduling, which are defined in the first to fourth embodiments above.

In operation 1710, the base station may transmit DCI to the UE, wherein the DCI may include a MU-MIMO assist signaling field, and the DCI may correspond to a combination of at least one of DCI formats 1_0, 1_1, 1_2, 1_3, 4_0, 4_1, and 4_2. The base station may, while transmitting PDSCH scheduling via the corresponding DCI, transfer additional information required when using the R-ML receiver by the UE if the PDSCH scheduling corresponds to MU-MIMO scheduling via the MU-MIMO assist signaling field. In this case, a method in which the UE interprets the corresponding MU-MIMO assist signaling field may vary depending on how the obtaining of additional information is combined with the other UE operation considered in the first to fourth embodiments above.

In operation 1715, the base station may transmit a PDSCH subject to MU-MIMO scheduling to the UE, and based on the additional information obtained via the MU-MIMO assist signaling field included in the DCI, the UE may detect a signal of the corresponding UE by minimizing interference from other UEs subject to scheduling using the R-ML receiver.

The flowcharts described above illustrate exemplary methods that may be implemented in accordance with the principles of the disclosure, and various modifications may be made to the methods illustrated in the flowcharts herein. For example, although shown as a series of operations, the various operations in each of the drawings may overlap, occur in parallel, occur in a different order, or occur multiple times. In other examples, operations may be omitted or replaced by other operations.

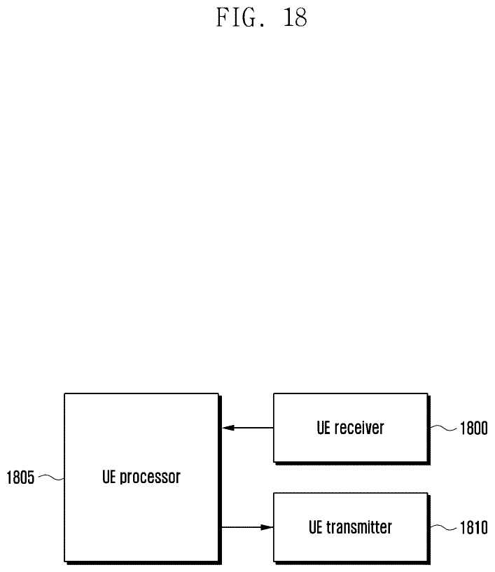

FIG. 18 illustrates a structure of a UE in a wireless communication system according to an embodiment of the disclosure.

Referring to FIG. 18, the UE may include a transceiver, which refers to a UE receiver 1800 and a UE transmitter 1810 as a whole, a memory (not illustrated), and a UE processor 1805 (or UE controller or processor). The UE transceiver 1800 and 1810, the memory, and the UE processor 1805 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

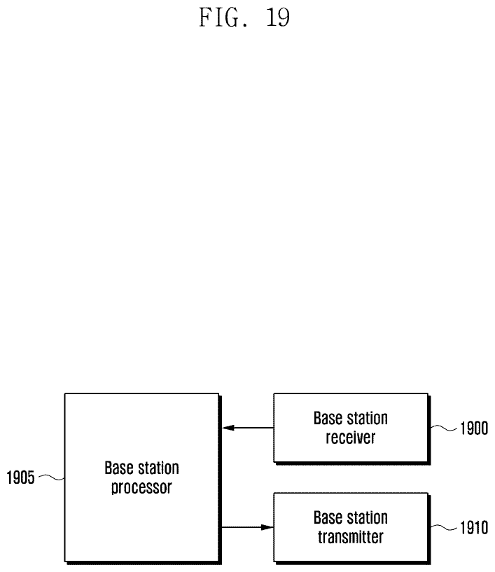

FIG. 19 illustrates a structure of a base station in a wireless communication system according to an embodiment of the disclosure.

Referring to FIG. 19, the base station may include a transceiver, which refers to a base station receiver 1900 and a base station transmitter 1910 as a whole, a memory (not illustrated), and a base station processor 1905 (or base station controller or processor). The base station transceiver 1900 and 1910, the memory, and the base station processor 1905 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, configuration information indicating information on multi-user multi-input and multi-output (MU-MIMO) that is included in downlink control information (DCI) via higher layer signaling;
receiving, from the base station, the DCI that schedules downlink data, wherein the DCI includes the information on the MU-MIMO; and
receiving, from the base station, the downlink data based on the information on the MU-MIMO,
wherein a value 0 of the information on the MU-MIMO indicates that no other terminal that is scheduled with the terminal exists or another terminal that is scheduled with the terminal using a different demodulation reference signal (DMRS) sequence exists.

2. The method of claim 1,
wherein the higher layer signaling is configured for a bandwidth part (BWP).

3. The method of claim 1,
wherein the DCI corresponds to a DCI format 1_1.

4. The method of claim 1,
wherein antenna port information included in the DCI is not associated with a two codewords (CWs) scheduling.

5. The method of claim 1,
transmitting, to the base station, capability information supporting a reduced complexity maximum likelihood (R-ML) receiver for the MU-MIMO.

6. A method performed by a base station in a communication system, the method comprising:
transmitting, to a terminal, configuration information indicating information on multi-user multi-input and multi-output (MU-MIMO) that is included in downlink control information (DCI) via higher layer signaling;
transmitting, to the terminal, the DCI that schedules downlink data, wherein the DCI includes the information on the MU-MIMO; and
transmitting, to the terminal, the downlink data,
wherein a value 0 of the information on the MU-MIMO indicates that no other terminal that is scheduled with the terminal exists or another terminal that is scheduled with the terminal using a different demodulation reference signal (DMRS) sequence exists.

7. The method of claim 6,
wherein the higher layer signaling is configured for a bandwidth part (BWP).

8. The method of claim 6,
wherein the DCI corresponds to a DCI format 1_1.

9. The method of claim 6,
wherein antenna port information included in the DCI is not associated with a two codewords (CWs) scheduling.

10. The method of claim 6,
receiving, from the terminal, capability information supporting a reduced complexity maximum likelihood (R-ML) receiver for the MU-MIMO.

11. A terminal in a communication system, the terminal comprising:
a transceiver; and
a controller configured to:
receive, from a base station, configuration information indicating information on multi-user multi-input and multi-output (MU-MIMO) that is included in downlink control information (DCI) via higher layer signaling,
receive, from the base station, the DCI that schedules downlink data, wherein the DCI includes the information on the MU-MIMO, and
receive, from the base station, the downlink data based on the information on the MU-MIMO,
wherein a value 0 of the information on the MU-MIMO indicates that no other terminal that is scheduled with the terminal exists or another terminal that is scheduled with the terminal using a different demodulation reference signal (DMRS) sequence exists.

12. The terminal of claim 11,
wherein the higher layer signaling is configured for a bandwidth part (BWP).

13. The terminal of claim 11,
wherein the DCI corresponds to a DCI format 1_1.

14. The terminal of claim 11,
wherein antenna port information included in the DCI is not associated with a two codewords (CWs) scheduling.

15. The terminal of claim 11, wherein the controller is further configured to transmit, to the base station, capability information supporting a reduced complexity maximum likelihood (R-ML) receiver for the MU-MIMO.

16. A base station in a communication system, the base station comprising:
a transceiver; and
a controller configured to:
transmit, to a terminal, configuration information indicating information on multi-user multi-input and multi-output (MU-MIMO) that is included in downlink control information (DCI) via higher layer signaling,
transmit, to the terminal, the DCI that schedules downlink data, wherein the DCI includes the information on the MU-MIMO, and
transmit, to the terminal, the downlink data,
wherein a value 0 of the information on the MU-MIMO indicates that no other terminal that is scheduled with the terminal exists or another terminal that is scheduled with the terminal using a different demodulation reference signal (DMRS) sequence exists.

17. The base station of claim 16,
wherein the higher layer signaling is configured for a bandwidth part (BWP).

18. The base station of claim 16,
wherein the DCI corresponds to a DCI format 1_1.

19. The base station of claim 16,
wherein antenna port information included in the DCI is not associated with a two codewords (CWs) scheduling.

20. The base station of claim 16, wherein the controller is further configured to receive, from the terminal, capability information supporting a reduced complexity maximum likelihood (R-ML) receiver for the MU-MIMO.
